(19) United States
(12) Patent Application Publication
(10) Pub. No.: US 2018/0139476 A1
(43) Pub. Date: May 17, 2018

(54) DYNAMIC EVENT SIGNALING

(71) Applicant: Sharp Kabushiki Kaisha, Sakai City, Osaka (JP)

(72) Inventor: SACHIN G. DESHPANDE, Camas, WA (US)

(21) Appl. No.: 15/571,495

(22) PCT Filed: Apr. 28, 2016
(86) PCT No.: PCT/JP2016/002227

§ 371 Date: Nov. 2, 2017

Related U.S. Application Data
(60) Provisional application No. 62/157,910, filed on May 6, 2015.
(60) Provisional application No. 62/182,608, filed on Jun. 21, 2015.
(60) Provisional application No. 62/187,390, filed on Jul. 1, 2015.
(60) Provisional application No. 62/251,051, filed on Nov. 4, 2015.

(51) Int. Cl. H04N 21/2362; H04N 21/434; H04N 21/435; H04N 21/482

(52) U.S. Cl. CPC H04N 21/2362; H04N 21/4345; H04L 67/16; H04N 21/482; H04N 21/435

(57) ABSTRACT

A system for generating, transmitting, providing and/or receiving application and event signaling.

### TECHNICAL FIELD

The present disclosure relates generally to application signaling.

### BACKGROUND ART

A broadcast service is capable of being received by all users having broadcast receivers. Broadcast services can be roughly divided into two categories, namely, a radio broadcast service carrying only audio and a multimedia broadcast service carrying audio, video and data. Such broadcast services have developed from analog services to digital services. More recently, various types of broadcasting systems (such as a cable broadcasting system, a satellite broadcasting system, an Internet based broadcasting system, and a hybrid broadcasting system using both a cable network, Internet, and/or a satellite) provide high quality audio and video broadcast services along with a high-speed data service. Also, broadcast services include sending and/or receiving audio, video, and/or data directed to an individual computer and/or group of computers and/or one or more mobile communication devices.

In addition to more traditional stationary receiving devices, mobile communication devices are likewise configured to support such services. Such configured mobile devices have facilitated users to use such services while on the move, such as mobile phones. An increasing need for multimedia services has resulted in various wireless/broadcast services for both mobile communications and general wire communications. Further, this convergence has merged the environment for different wire and wireless broadcast services.

Open Mobile Alliance (OMA), is a standard for interworking between individual mobile solutions, serves to define various application standards for mobile software and Internet services. OMA Mobile Broadcast Services Enabler Suite (OMA BCAST) is a specification designed to support mobile broadcast technologies. The OMA BCAST defines technologies that provide IP-based mobile content delivery, which includes a variety of functions such as a service guide, downloading and streaming, service and content protection, service subscription, and roaming.

The foregoing and other objectives, features, and advantages of the invention will be more readily understood upon consideration of the following detailed description of the invention, taken in conjunction with the accompanying drawings.

### SUMMARY OF INVENTION

According to the present invention, there is provided a terminal device, the device comprising: a receiver configured to receive content service guide and by channels and/or an interactive channel, wherein the channels include at least one of a Multimedia Broadcast Multicast Service (MBMS) by 3rd Generation Project Partnership (3GPP), a Broadcast Multicast Service (BCMCS) by 3rd Generation Project Partnership 2 (3GPP2), a DVB-Handheld (DVB-H) by Digital Video Broadcasting (DVB) and an Internet Protocol (IP) based broadcasting communication network, and the service guide includes notification about availability of at least one of application table, event table and service list table.

### BRIEF DESCRIPTION OF DRAWINGS

FIG. 1 is a block diagram illustrating logical architecture of a BCAST system specified by OMA BCAST working group in an application layer and a transport layer.

FIG. 2 is a diagram illustrating a structure of a service guide for use in the OMA BCAST system.

FIG. 2A is a diagram showing cardinalities and reference direction between service guide fragments.

FIG. 3 is a block diagram illustrating a principle of the conventional service guide delivery method.

FIG. 4 illustrates description scheme.

FIG. 5 illustrates a ServiceMediaExtension with MajorChannelNum and MinorChannelNum.

FIG. 6 illustrates a ServiceMediaExtension with an Icon.

FIG. 7 illustrates a ServiceMediaExtension with a url.

FIG. 8 illustrates a ServiceMediaExtension with MajorChannelNum, MinorChannelNum, Icon, and url.

FIG. 9A illustrate AudioLanguage elements and TextLanguage elements.

FIG. 9B illustrate AudioLanguage elements and TextLanguage elements.

FIG. C illustrate AudioLanguage elements and TextLanguage elements.

FIG. 10A illustrate AudioLanguage elements and TextLanguage elements.

FIG. 10B illustrate AudioLanguage elements and TextLanguage elements.

FIG. 10C illustrate AudioLanguage elements and TextLanguage elements.

FIG. 11 illustrates component information description signaling.

FIG. 12 illustrates channel information description signaling.

FIG. 13A illustrate a binary syntax for a component information descriptor.

FIG. 13B illustrate a binary syntax for a component information descriptor.

FIG. 14A illustrate a binary syntax for a channel information descriptor.

FIG. 14B illustrate a binary syntax for a channel information descriptor.

FIG. 15 illustrates a XML syntax and semantics for a component information descriptor.

FIG. 16 illustrates a XML syntax and semantics for a channel information descriptor.

FIG. 17 illustrates a XML schema for a component information descriptor.

FIG. 18 illustrates a XML schema for a channel information descriptor.

FIG. 19 illustrates bitstream syntax for a service list table.

FIG. 20 illustrates service category information table.

FIG. 21 illustrates protocol information table.

FIG. 22 illustrate Internet signaling location descriptor.

FIG. 22A illustrate Internet signaling location descriptor.

FIG. 23 illustrates service language descriptor.

FIG. 24A illustrate XML format service list table.

FIG. 24B illustrate XML format service list table.

FIG. 25 illustrates XML format InetSigLocation.

FIG. 26 illustrates part of another service list table.

FIG. 27 illustrates part of another service list table.

FIG. 28 illustrate part of another Internet signaling location descriptor.

FIG. 28A illustrate part of another Internet signaling location descriptor.

FIG. 29 illustrates a block diagram illustrating an example of a system that may implement one or more techniques of this disclosure.

FIG. 30 illustrates a block diagram illustrating an example of a receiver device that may implement one or more techniques of this disclosure.

FIG. 31 illustrates a block diagram illustrating an example of another receiver device that may implement one or more techniques of this disclosure.

FIG. 32 illustrates bitstream syntax for Internet signaling location descriptor.

FIG. 33A illustrate code values for URL_type.

FIG. 33B illustrate code values for URL_type.

FIG. 34A illustrates table notification URL signaling in service list table.

FIG. 34B illustrates table notification URL signaling in service list table XML format.

FIG. 35A illustrate query term URL_bytes of Internet signaling location descriptor.

FIG. 35B illustrate query term URL_bytes of Internet signaling location descriptor.

FIG. 36A illustrates code values for table_type_indicator for descriptor at service list table level.

FIG. 36B illustrates code values for table_type_indicator for descriptor at service level.

FIG. 37A illustrates ATSCNotify subprotocol WebSocket request handshake from client to server.

FIG. 37B illustrates ATSCNotify subprotocol WebSocket response handshake from server to client.

FIG. 38 illustrates ATSCNotify subprotocol framing structure.

FIG. 39 illustrates ATSCNotify subprotocol framing elements.

FIG. 40 illustrates ATSCNotify XML format.

FIG. 41A illustrates ATSCNotify subprotocol WebSocket request handshake from client to server.

FIG. 41B illustrates ATSCNotify subprotocol WebSocket response handshake from server to client.

FIG. 42 illustrates ATSCNotify subprotocol framing structure.

FIG. 43 illustrates ATSCNotify subprotocol framing elements.

FIG. 44 illustrates ATSCNotify XML format.

FIG. 45 illustrates ATSCNotify subprotocol framing structure.

FIG. 46 illustrates ATSCNotify subprotocol framing elements.

FIG. 47 illustrates ATSCNotify XML format.

FIG. 48 illustrates ATSCNotify subprotocol framing structure.

FIG. 49 illustrates ATSCNotify subprotocol framing elements.

FIG. 50 illustrates ATSCNotify XML format.

FIG. 51 illustrates EventNotify subprotocol framing structure.

FIG. 52A illustrates EventNotify subprotocol framing elements.

FIG. 52B illustrates EventNotify subprotocol framing elements.

FIG. 53 illustrates EventNotify XML format.

FIG. 54 illustrates EventNotify subprotocol framing structure.

FIG. 55 illustrates EventNotify subprotocol framing elements.

FIG. 56 illustrates EventNotify XML format.

FIG. 57 illustrates EventNotify subprotocol framing structure.

FIG. 58 illustrates EventNotify subprotocol framing elements.

FIG. 59 illustrates EventNotify XML format.

FIG. 60 illustrates event related syntax.

### DESCRIPTION OF EMBODIMENTS

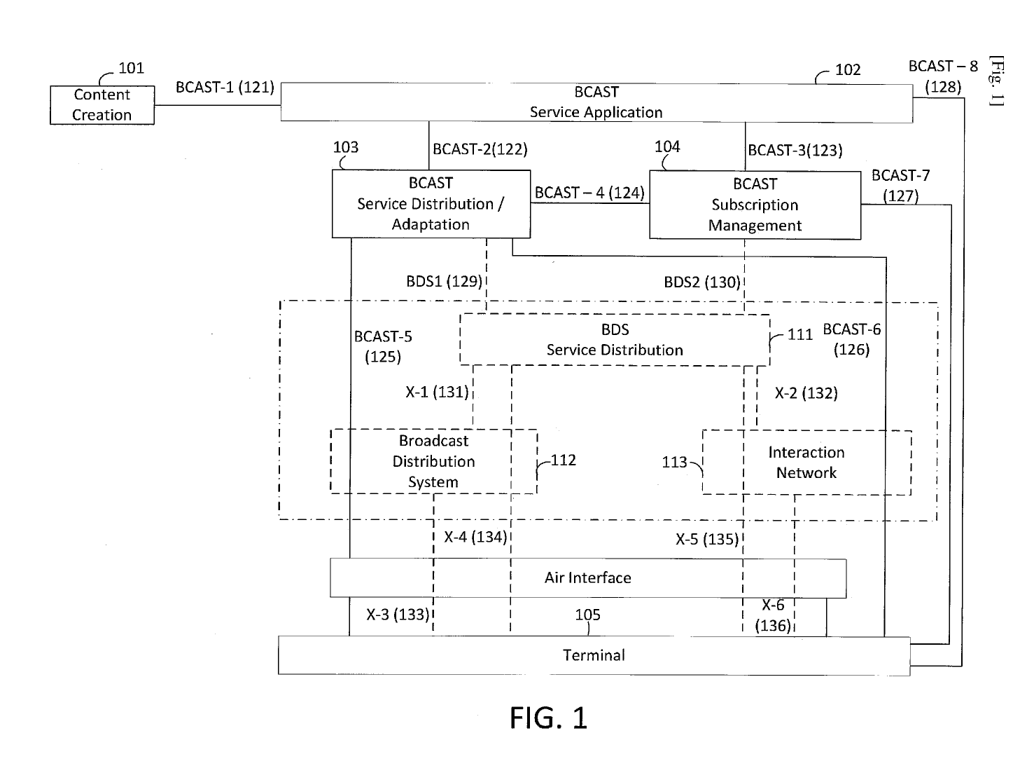

Referring to FIG. 1, a logical architecture of a broadcast system specified by OMA (Open Mobile Alliance) BCAST may include an application layer and a transport layer. The logical architecture of the BCAST system may include a Content Creation (CC) 101, a BCAST Service Application 102, a BCAST Service Distribution/Adaptation (BSDA) 103, a BCAST Subscription Management (BSM) 104, a Terminal 105, a Broadcast Distribution System (BDS) Service Distribution 111, a BDS 112, and an Interaction Network 113. It is to be understood that the broadcast system and/or receiver system may be reconfigured, as desired. It is to be understood that the broadcast system and/or receiver system may include additional elements and/or fewer elements, as desired.

In general, the Content Creation (CC) 101 may provide content that is the basis of BCAST services. The content may include files for common broadcast services, e.g., data for a movie including audio and video. The Content Creation 101 provides a BCAST Service Application 102 with attributes for the content, which are used to create a service guide and to determine a transmission bearer over which the services will be delivered.

In general, the BCAST Service Application 102 may receive data for BCAST services provided from the Content Creation 101, and converts the received data into a form suitable for providing media encoding, content protection, interactive services, etc. The BCAST Service Application 102 provides the attributes for the content, which is received from the Content Creation 101, to the BSDA 103 and the BSM 104.

In general, the BSDA 103 may perform operations, such as file/streaming delivery, service gathering, service protection, service guide creation/delivery and service notification, using the BCAST service data provided from the BCAST Service Application 102. The BSDA 103 adapts the services to the BDS 112.

In general, the BSM 104 may manage, via hardware or software, service provisioning, such as subscription and charging-related functions for BCAST service users, information provisioning used for BCAST services, and mobile terminals that receive the BCAST services.

In general, the Terminal 105 may receive content/service guide and program support information, such as content protection, and provides a broadcast service to a user. The BDS Service Distribution 111 delivers mobile broadcast services to a plurality of terminals through mutual communication with the BDS 112 and the Interaction Network 113.

In general, the BDS 112 may deliver mobile broadcast services over a broadcast channel, and may include, for example, a Multimedia Broadcast Multicast Service (MBMS) by 3rd Generation Project Partnership (3GPP), a Broadcast Multicast Service (BCMCS) by 3rd Generation Project Partnership 2 (3GPP2), a DVB-Handheld (DVB-H) by Digital Video Broadcasting (DVB), or an Internet Protocol (IP) based broadcasting communication network. The Interaction Network 113 provides an interaction channel, and may include, for example, a cellular network.

The reference points, or connection paths between the logical entities of FIG. 1, may have a plurality of interfaces, as desired. The interfaces are used for communication between two or more logical entities for their specific purposes. A message format, a protocol and the like are applied for the interfaces. In some embodiments, there are no logical interfaces between one or more different functions.

BCAST-1 121 is a transmission path for content and content attributes, and BCAST-2 122 is a transmission path for a content-protected or content-unprotected BCAST service, attributes of the BCAST service, and content attributes.

BCAST-3 123 is a transmission path for attributes of a BCAST service, attributes of content, user preference/subscription information, a user request, and a response to the request. BCAST-4 124 is a transmission path for a notification message, attributes used for a service guide, and a key used for content protection and service protection.

BCAST-5 125 is a transmission path for a protected BCAST service, an unprotected

BCAST service, a content-protected BCAST service, a content-unprotected BCAST service, BCAST service attributes, content attributes, a notification, a service guide, security materials such as a Digital Right Management (DRM) Right Object (RO) and key values used for BCAST service protection, and all data and signaling transmitted through a broadcast channel.

BCAST-6 126 is a transmission path for a protected BCAST service, an unprotected

BCAST service, a content-protected BCAST service, a content-unprotected BCAST service, BCAST service attributes, content attributes, a notification, a service guide, security materials such as a DRM RO and key values used for BCAST service protection, and all data and signaling transmitted through an interaction channel.

BCAST-7 127 is a transmission path for service provisioning, subscription information, device management, and user preference information transmitted through an interaction channel for control information related to receipt of security materials, such as a DRM RO and key values used for BCAST service protection.

BCAST-8 128 is a transmission path through which user data for a BCAST service is provided. BDS-1 129 is a transmission path for a protected BCAST service, an unprotected BCAST service, BCAST service attributes, content attributes, a notification, a service guide, and security materials, such as a DRM RO and key values used for BCAST service protection.

BDS-2 130 is a transmission path for service provisioning, subscription information, device management, and security materials, such as a DRM RO and key values used for BCAST service protection.

X-1 131 is a reference point between the BDS Service Distribution 111 and the BDS 112. X-2 132 is a reference point between the BDS Service Distribution 111 and the Interaction Network 113. X-3 133 is a reference point between the BDS 112 and the Terminal 105. X-4 134 is a reference point between the BDS Service Distribution 111 and the Terminal 105 over a broadcast channel. X-5 135 is a reference point between the BDS Service Distribution 111 and the Terminal 105 over an interaction channel. X-6 136 is a reference point between the Interaction Network 113 and the Terminal 105.

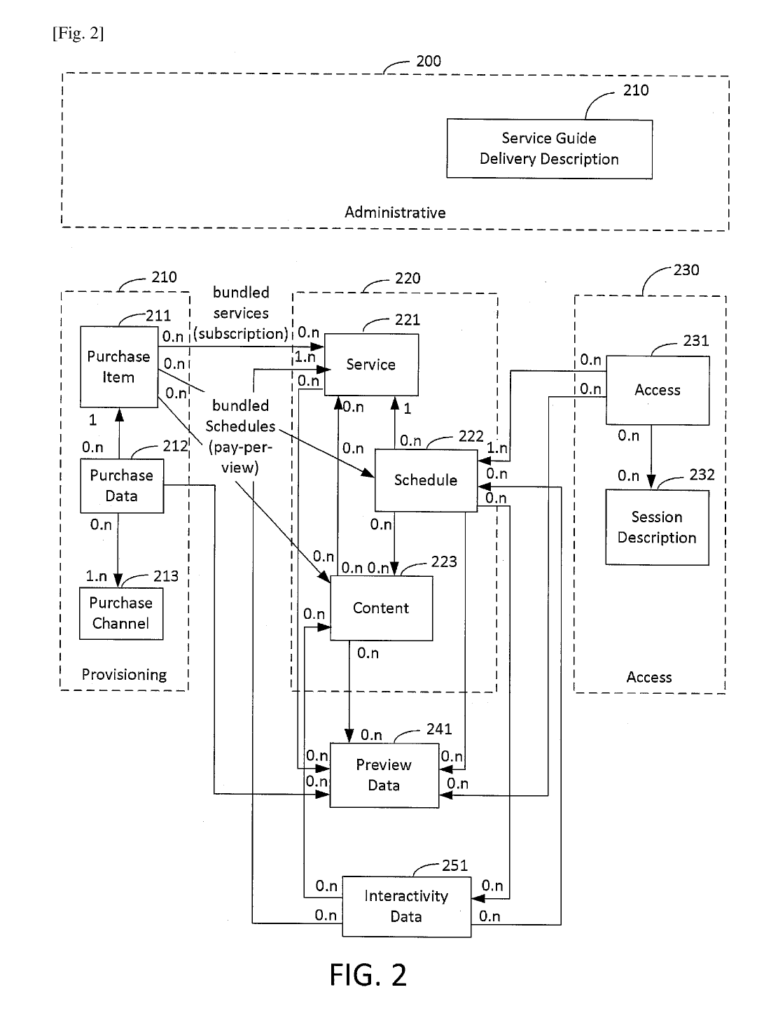

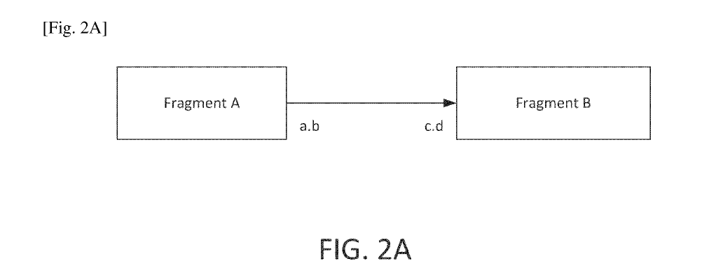

Referring to FIG. 2, an exemplary service guide for the OMA BCAST system is illustrated. For purposes of illustration, the solid arrows between fragments indicate the reference directions between the fragments. It is to be understood that the service guide system may be reconfigured, as desired. It is to be understood that the service guide system may include additional elements and/or fewer elements, as desired. It is to be understood that functionality of the elements may be modified and/or combined, as desired.

FIG. 2A is a diagram showing cardinalities and reference direction between service guide fragments. The meaning of the cardinalities shown in the FIG. 2 is the following: One instantiation of Fragment A as in FIG. 2A references c to d instantiations of Fragment B. If c=d, d is omitted. Thus, if c>0 and Fragment A exists, at least c instantiation of Fragment B must also exist, but at most d instantiations of Fragment B may exist. Vice versa, one instantiation of Fragment B is referenced by a to b instantiations of Fragment A. If a=b, b is omitted. The arrow connection from Fragment A pointing to Fragment B indicates that Fragment A contains the reference to Fragment B.

With respect to FIG. 2, in general, the service guide may include an Administrative Group 200 for providing basic information about the entire service guide, a Provisioning Group 210 for providing subscription and purchase information, a Core Group 220 that acts as a core part of the service guide, and an Access Group 230 for providing access information that control access to services and content.

The Administrative Group 200 may include a Service Guide Delivery Descriptor (SGDD) block 201. The Provision Group 210 may include a Purchase Item block 211, a Purchase Data block 212, and a Purchase Channel block 213. The Core Group 220 may include a Service block 221, a Schedule block 222, and a Content block 223. The Access Group 230 may include an Access block 231 and a Session Description block 232.

The service guide may further include Preview Data 241 and Interactivity Data 251 in addition to the four information groups 200, 210, 220, and 230.

The aforementioned components may be referred to as basic units or fragments constituting aspects of the service guide, for purposes of identification.

The SGDD fragment 201 may provide information about a delivery session where a Service Guide Delivery Unit (SGDU) is located. The SGDU is a container that contains service guide fragments 211, 212, 213, 221, 222, 223, 231, 232, 241, and 251, which constitute the service guide. The SGDD may also provide the information on the entry points for receiving the grouping information and notification messages.

The Service fragment 221, which is an upper aggregate of the content included in the broadcast service, may include information on service content, genre, service location, etc. In general, the ‘Service’ fragment describes at an aggregate level the content items which comprise a broadcast service. The service may be delivered to the user using multiple means of access, for example, the broadcast channel and the interactive channel. The service may be targeted at a certain user group or geographical area. Depending on the type of the service it may have interactive part(s), broadcast-only part(s), or both. Further, the service may include components not directly related to the content but to the functionality of the service such as purchasing or subscription information. As the part of the Service Guide, the ‘Service’ fragment forms a central hub referenced by the other fragments including ‘Access’, ‘Schedule’, ‘Content’ and ‘PurchaseItem’ fragments. In addition to that, the ‘Service’ fragment may reference ‘PreviewData’ fragment. It may be referenced by none or several of each of these fragments. Together with the associated fragments the terminal may determine the details associated with the service at any point of time. These details may be summarized into a user-friendly display, for example, of what, how and when the associated content may be consumed and at what cost.

The Access fragment 231 may provide access-related information for allowing the user to view the service and delivery method, and session information associated with the corresponding access session. As such, the ‘Access’ fragment describes how the service may be accessed during the lifespan of the service. This fragment contains or references Session Description information and indicates the delivery method. One or more ‘Access’ fragments may reference a ‘Service’ fragment, offering alternative ways for accessing or interacting with the associated service. For the Terminal, the ‘Access’ fragment provides information on what capabilities are required from the terminal to receive and render the service. The ‘Access’ fragment provides Session Description parameters either in the form of inline text, or through a pointer in the form of a URI to a separate Session Description. Session Description information may be delivered over either the broadcast channel or the interaction channel.

The Session Description fragment 232 may be included in the Access fragment 231, and may provide location information in a Uniform Resource Identifier (URI) form so that the terminal may detect information on the Session Description fragment 232. The Session Description fragment 232 may provide address information, codec information, etc., about multimedia content existing in the session. As such, the ‘SessionDescription’ is a Service Guide fragment which provides the session information for access to a service or content item. Further, the Session Description may provide auxiliary description information, used for associated delivery procedures. The Session Description information is provided using either syntax of SDP in text format, or through a 3GPP MBMS User Service Bundle Description [3GPP TS 26.346] (USBD). Auxiliary description information is provided in XML format and contains an Associated Delivery Description as specified in [BCAST10-Distribution]. Note that in case SDP syntax is used, an alternative way to deliver the Session Description is by encapsulating the SDP in text format in ‘Access’ fragment. Note that Session Description may be used both for Service Guide delivery itself as well as for the content sessions.

The Purchase Item fragment 211 may provide a bundle of service, content, time, etc., to help the user subscribe to or purchase the Purchase Item fragment 211. As such, the ‘PurchaseItem’ fragment represents a group of one or more services (i.e. a service bundle) or one or more content items, offered to the end user for free, for subscription and/or purchase. This fragment can be referenced by ‘PurchaseData’ fragment(s) offering more information on different service bundles. The ‘PurchaseItem’ fragment may be also associated with: (1) a ‘Service’ fragment to enable bundled services subscription and/or, (2) a ‘Schedule’ fragment to enable consuming a certain service or content in a certain timeframe (pay-per-view functionality) and/or, (3) a ‘Content’ fragment to enable purchasing a single content file related to a service, (4) other ‘PurchaseItem’ fragments to enable bundling of purchase items.

The Purchase Data fragment 212 may include detailed purchase and subscription information, such as price information and promotion information, for the service or content bundle. The Purchase Channel fragment 213 may provide access information for subscription or purchase. As such, the main function of the ‘PurchaseData’ fragment is to express all the available pricing information about the associated purchase item. The ‘PurchaseData’ fragment collects the information about one or several purchase channels and may be associated with PreviewData specific to a certain service or service bundle. It carries information about pricing of a service, a service bundle, or, a content item. Also, information about promotional activities may be included in this fragment. The SGDD may also provide information regarding entry points for receiving the service guide and grouping information about the SGDU as the container.

The Preview Data fragment 241 may be used to provide preview information for a service, schedule, and content. As such, ‘PreviewData’ fragment contains information that is used by the terminal to present the service or content outline to users, so that the users can have a general idea of what the service or content is about. ‘PreviewData’ fragment can include simple texts, static images (for example, logo), short video clips, or even reference to another service which could be a low bit rate version for the main service. ‘Service’, ‘Content’, ‘PurchaseData’, ‘Access’ and ‘Schedule’ fragments may reference ‘PreviewData’ fragment.

The Interactivity Data fragment 251 may be used to provide an interactive service according to the service, schedule, and content during broadcasting. More detailed information about the service guide can be defined by one or more elements and attributes of the system. As such, the InteractivityData contains information that is used by the terminal to offer interactive services to the user, which is associated with the broadcast content. These interactive services enable users to e.g. vote during TV shows or to obtain content related to the broadcast content. ‘InteractivityData’ fragment points to one or many ‘InteractivityMedia’ documents that include xhtml files, static images, email template, SMS template, MMS template documents, etc. The ‘InteractivityData’ fragment may reference the ‘Service’, ‘Content’ and ‘Schedule’ fragments, and may be referenced by the ‘Schedule’ fragment.

The ‘Schedule’ fragment defines the timeframes in which associated content items are available for streaming, downloading and/or rendering. This fragment references the ‘Service’ fragment. If it also references one or more ‘Content’ fragments or ‘InterativityData’ fragments, then it defines the valid distribution and/or presentation timeframe of those content items belonging to the service, or the valid distribution timeframe and the automatic activation time of the InteractivityMediaDocuments associated with the service. On the other hand, if the ‘Schedule’ fragment does not reference any ‘Content’ fragment(s) or InteractivityDat'a fragment(s), then it defines the timeframe of the service availability which is unbounded.

The ‘Content’ fragment gives a detailed description of a specific content item. In addition to defining a type, description and language of the content, it may provide information about the targeted user group or geographical area, as well as genre and parental rating. The ‘Content’ fragment may be referenced by Schedule, PurchaseItem or ‘InteractivityData’ fragment. It may reference ‘PreviewData’ fragment or ‘Service’ fragment.

The ‘PurchaseChannel’ fragment carries the information about the entity from which purchase of access and/or content rights for a certain service, service bundle or content item may be obtained, as defined in the ‘PurchaseData’ fragment. The purchase channel is associated with one or more Broadcast Subscription Managements (BSMs). The terminal is only permitted to access a particular purchase channel if it is affiliated with a BSM that is also associated with that purchase channel. Multiple purchase channels may be associated to one ‘PurchaseData’ fragment. A certain end-user can have a “preferred” purchase channel (e.g. his/her mobile operator) to which all purchase requests should be directed. The preferred purchase channel may even be the only channel that an end-user is allowed to use.

The ServiceGuideDeliveryDescriptor is transported on the Service Guide Announcement Channel, and informs the terminal the availability, metadata and grouping of the fragments of the Service Guide in the Service Guide discovery process. A SGDD allows quick identification of the Service Guide fragments that are either cached in the terminal or being transmitted. For that reason, the SGDD is preferably repeated if distributed over broadcast channel. The SGDD also provides the grouping of related Service Guide fragments and thus a means to determine completeness of such group. The ServiceGuideDeliveryDescriptor is especially useful if the terminal moves from one service coverage area to another. In this case, the ServiceGuideDeliveryDescriptor can be used to quickly check which of the Service Guide fragments that have been received in the previous service coverage area are still valid in the current service coverage area, and therefore don't have to be re-parsed and re-processed.

Although not expressly depicted, the fragments that constitute the service guide may include element and attribute values for fulfilling their purposes. In addition, one or more of the fragments of the service guide may be omitted, as desired. Also, one or more fragments of the service guide may be combined, as desired. Also, different aspects of one or more fragments of the service guide may be combined together, re-organized, and otherwise modified, or constrained as desired.

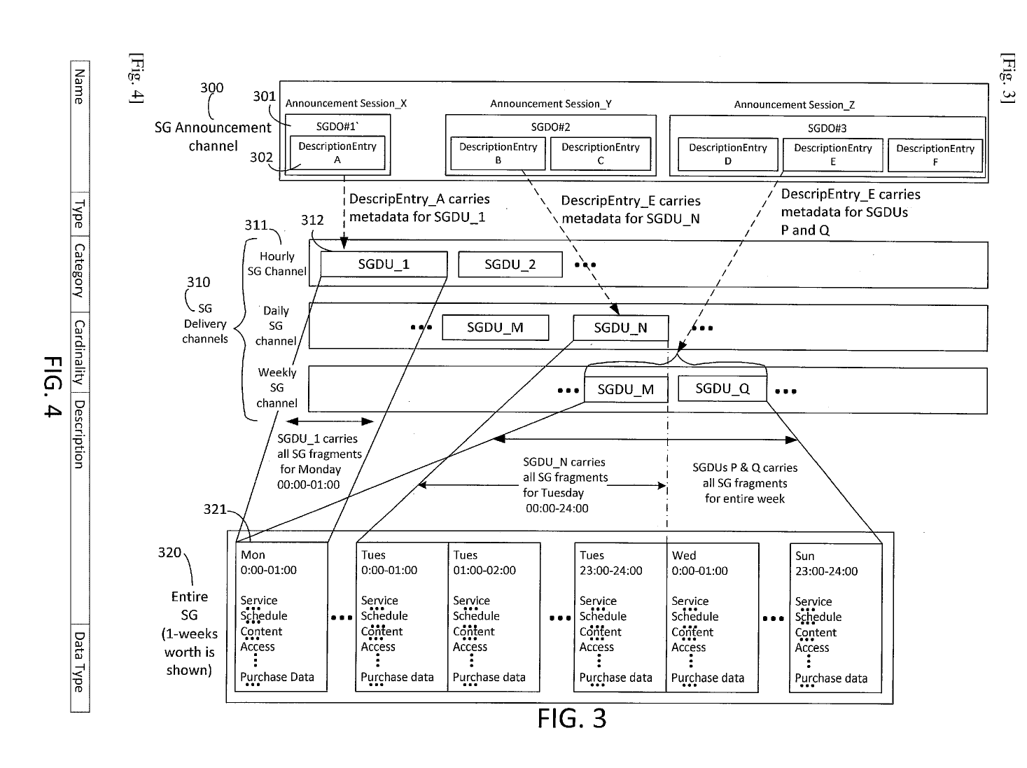

Referring to FIG. 3, an exemplary block diagram illustrates aspects of a service guide delivery technique. The Service Guide Deliver Descriptor fragment 201 may include the session information, grouping information, and notification message access information related to all fragments containing service information. When the mobile broadcast service-enabled terminal 105 turns on or begins to receive the service guide, it may access a Service Guide Announcement Channel (SG Announcement Channel) 300.

The SG Announcement Channel 300 may include at least one of SGDD 200 (e.g., SGDD #1, . . . , SGDD #2, SGDD #3), which may be formatted in any suitable format, such as that illustrated in Service Guide for Mobile Broadcast Services, Open Mobile Alliance, Version 1.0.1, Jan. 9, 2013 and/or Service Guide for Mobile Broadcast Services, open Mobile Alliance, Version 1.1, Oct. 29, 2013; both of which are incorporated by reference in their entirety. The descriptions of elements and attributes constituting the Service Guide Delivery Descriptor fragment 201 may be reflected in any suitable format, such as for example, a table format and/or in an eXtensible Markup Language (XML) schema.

The actual data is preferably provided in XML format according to the SGDD fragment 201. The information related to the service guide may be provided in various data formats, such as binary, where the elements and attributes are set to corresponding values, depending on the broadcast system.

The terminal 105 may acquire transport information about a Service Guide Delivery Unit (SGDU) 312 containing fragment information from a DescriptorEntry of the SGDD fragment received on the SG Announcement Channel 300.

The DescriptorEntry 302, which may provide the grouping information of a Service Guide includes the “GroupingCriteria”, “ServiceGuideDeliveryUnit”, “Transport”, and AlternativeAccessURI“. The transport-related channel information may be provided by the “Transport” or “AlternativeAccessURI”, and the actual value of the corresponding channel is provided by “ServiceGuideDeliveryUnit”. Also, upper layer group information about the SGDU 312, such as “Service” and “Genre”, may be provided by “GroupingCriteria”. The terminal 105 may receive and present all of the SGDUs 312 to the user according to the corresponding group information.

Once the transport information is acquired, the terminal 105 may access all of the Delivery Channels acquired from a DescriptorEntry 302 in an SGDD 301 on an SG Delivery Channel 310 to receive the actual SGDU 312. The SG Delivery Channels can be identified using the “GroupingCriteria”. In the case of time grouping, the SGDU can be transported with a time-based transport channel such as an Hourly SG Channel 311 and a Daily SG Channel. Accordingly, the terminal 105 can selectively access the channels and receive all the SGDUs existing on the corresponding channels. Once the entire SGDU is completely received on the SG Delivery Channels 310, the terminal 105 checks all the fragments contained in the SGDUs received on the SG Delivery Channels 310 and assembles the fragments to display an actual full service guide 320 on the screen which can be subdivided on an hourly basis 321.

In the conventional mobile broadcast system, the service guide is formatted and transmitted such that only configured terminals receive the broadcast signals of the corresponding broadcast system. For example, the service guide information transmitted by a DVB-H system can only be received by terminals configured to receive the DVB-H broadcast.

The service providers provide bundled and integrated services using various transmission systems as well as various broadcast systems in accordance with service convergence, which may be referred to as multiplay services. The broadcast service providers may also provide broadcast services on IP networks. Integrated service guide transmission/reception systems may be described using terms of entities defined in the 3GPP standards and OMA BCAST standards (e.g., a scheme). However, the service guide/reception systems may be used with any suitable communication and/or broadcast system.

Referring to FIG. 4, the scheme may include, for example, (1) Name; (2) Type; (3) Category; (4) Cardinality; (5) Description; and (6) Data type. The scheme may be arranged in any manner, such as a table format of an XML format.

The “name” column indicates the name of an element or an attribute. The “type” column indicates an index representing an element or an attribute. An element can be one of E1, E2, E3, E4, . . . , E[n]. E1 indicates an upper element of an entire message, E2 indicates an element below the E1, E3 indicates an element below E2, E4 indicates an element below the E3, and so forth. An attribute is indicated by A. For example, an “A” below E1 means an attribute of element E1. In some cases the notation may mean the following E=Element, A=Attribute, E1=sub-element, E2=sub-element's sub-element, E[n]=sub-element of element[n-1]. The “category” column is used to indicate whether the element or attribute is mandatory. If an element is mandatory, the category of the element is flagged with an “M”. If an element is optional, the category of the element is flagged with an “O”. If the element is optional for network to support it the element is flagged with a “NO”. If the element is mandatory for terminal to support it is flagged with a TM. If the element is mandatory for network to support it the element is flagged with “NM”. If the element is optional for terminal to support it the element is flagged with “TO”. If an element or attribute has cardinality greater than zero, it is classified as M or NM to maintain consistency. The “cardinality” column indicates a relationship between elements and is set to a value of 0, 0 . . . 1, 1, 0 . . . n, and 1 . . . n. 0 indicates an option, 1 indicates a necessary relationship, and n indicates multiple values. For example, 0 . . . n means that a corresponding element can have no or n values. The “description” column describes the meaning of the corresponding element or attribute, and the “data type” column indicates the data type of the corresponding element or attribute.

A service may represent a bundle of content items, which forms a logical group to the end-user. An example would be a TV channel, composed of several TV shows. A ‘Service’ fragment contains the metadata describing the Mobile Broadcast service. It is possible that the same metadata (i.e., attributes and elements) exist in the ‘Content’ fragment(s) associated with that ‘Service’ fragment. In that situation, for the following elements: ‘ParentalRating’, ‘TargetUserProfile, ‘Genre’ and ‘BroadcastArea’, the values defined in ‘Content’ fragment take precedence over those in ‘Service’ fragment.

The program guide elements of this fragment may be grouped between the Start of program guide and end of program guide cells in a fragment. This localization of the elements of the program guide reduces the computational complexity of the receiving device in arranging a programming guide. The program guide elements are generally used for user interpretation. This enables the content creator to provide user readable information about the service. The terminal should use all declared program guide elements in this fragment for presentation to the end-user. The terminal may offer search, sort, etc. functionalities. The Program Guide may consist of the following service elements: (1) Name; (2) Description; (3) AudioLanguage; (4) TextLanguage; (5) ParentalRating; (6) TargetUserProfile; and (7) Genre.

The “Name” element may refer to Name of the Service, possibly in multiple languages. The language may be expressed using built-in XML attribute ‘xml:lang’.

The “Description” element may be in multiple languages and may be expressed using built-in XML attribute ‘xml:lang’.

The “AudioLanguage” element may declare for the end users that this service is available with an audio track corresponding to the language represented by the value of this element. The textual value of this element can be made available for the end users in different languages. In such a case the language used to represent the value of this element may be signaled using the built-in XML attribute ‘xml:lang’, and may include multi-language support. The AudioLanguage may contain an attribute languageSDPTag.

The “languageSDPTag” attribute is an identifier of the audio language described by the parent ‘AudioLanguage’ element as used in the media sections describing the audio track in a Session Description. Each ‘AudioLanguage’ element declaring the same audio stream may have the same value of the ‘languageSDPTag’.

The “TextLanguage” element may declare for the end user that the textual components of this service are available in the language represented by the value of this element. The textual components can be, for instance, a caption or a sub-title track. The textual value of this element can be made available for the end users in different languages. In such a case the language used to represent the value of this element may be signaled using the built-in XML attribute ‘xml:lang’, and may include multi-language support. The same rules and constraints as specified for the element ‘AudioLanguage’ of assigning and interpreting the attributes ‘languageSDPTag’ and ‘xml:lang’ may be applied for this element.

The “languageSDPTag” attribute is an identifier of the text language described by the parent ‘TextLanguage’ element as used in the media sections describing the textual track in a Session Description.

The “ParentalRating” element may declare criteria parents and might be used to determine whether the associated item is suitable for access by children, defined according to the regulatory requirements of the service area. The terminal may support ‘ParentalRating’ being a free string, and the terminal may support the structured way to express the parental rating level by using the ‘ratingSystem’ and ‘ratingValueName’ attributes.

The “ratingSystem” attribute may specify the parental rating system in use, in which context the value of the ‘ParentalRating’ element is semantically defined. This allows terminals to identify the rating system in use in a non-ambiguous manner and act appropriately. This attribute may be instantiated when a rating system is used. Absence of this attribute means that no rating system is used (i.e. the value of the ‘ParentalRating’ element is to be interpreted as a free string).

The “ratingValueName” attribute may specify the human-readable name of the rating value given by this ParentalRating element.

The “TargetUserProfile” may specify elements of the users whom the service is targeting at. The detailed personal attribute names and the corresponding values are specified by attributes of ‘attributeName’ an ‘attributeValue’. Amongst the possible profile attribute names are age, gender, occupation, etc. (subject to national/local rules & regulations, if present and as applicable regarding use of personal profiling information and personal data privacy). The extensible list of ‘attributeName’ and ‘attributeValue’ pairs for a particular service enables end user profile filtering and end user preference filtering of broadcast services. The terminal may be able to support ‘TargetUserProfile’ element. The use of ‘TargetUserProfile’ element may be an “opt-in” capability for users. Terminal settings may allow users to configure whether to input their personal profile or preference and whether to allow broadcast service to be automatically filtered based on the users' personal attributes without users' request. This element may contain the following attributes: attributeName and attributeValue.

The “attributeName” attribute may be a profile attribute name.

The “attributeValue” attribute may be a profile attribute value.

The “Genre” element may specify classification of service associated with characteristic form (e.g. comedy, drama). The OMA BCAST Service Guide may allow describing the format of the Genre element in the Service Guide in two ways. The first way is to use a free string. The second way is to use the “href” attributes of the Genre element to convey the information in the form of a controlled vocabulary (classification scheme as defined in [TVA-Metadata] or classification list as defined in [MIGFG]). The built-in XML attribute xml:lang may be used with this element to express the language. The network may instantiate several different sets of ‘Genre’ element, using it as a free string or with a ‘href attribute. The network may ensure the different sets have equivalent and nonconflicting meaning, and the terminal may select one of the sets to interpret for the end-user. The ‘Genre’ element may contain the following attributes: type and href.

The “type” attribute may signal the level of the ‘Genre’ element, such as with the values of “main”, “second”, and “other”.

The “href” attribute may signal the controlled vocabulary used in the ‘Genre’ element.

After reviewing the set of programming guide elements and attributes; (1) Name; (2) Description; (3) AudioLanguage; (4) TextLanguage; (5) ParentalRating; (6) TargetUserProfile; and (7) Genre it was determined that the receiving device still may have insufficient information defined within the programming guide to appropriately render the information in a manner suitable for the viewer. In particular, the traditional NTSC television stations typically have numbers such as, 2, 4, 6, 8, 12, and 49. For digital services, program and system information protocol includes a virtual channel table that, for terrestrial broadcasting defines each digital television service with a two-part number consisting of a major channel followed by a minor channel. The major channel number is usually the same as the NTSC channel for the station, and the minor channels have numbers depending on how many digital television services are present in the digital television multiples, typically starting at 1. For example, the analog television channel 9, WUSA-TV in Washington, D.C., may identify its two over-the-air digital services as follows: channel 9-1 WUSA-DT and channel 9-2 9-Radar. This notation for television channels is readily understandable by a viewer, and the programming guide elements may include this capability as an extension to the programming guide so that the information may be computationally efficiently processed by the receiving device and rendered to the viewer.

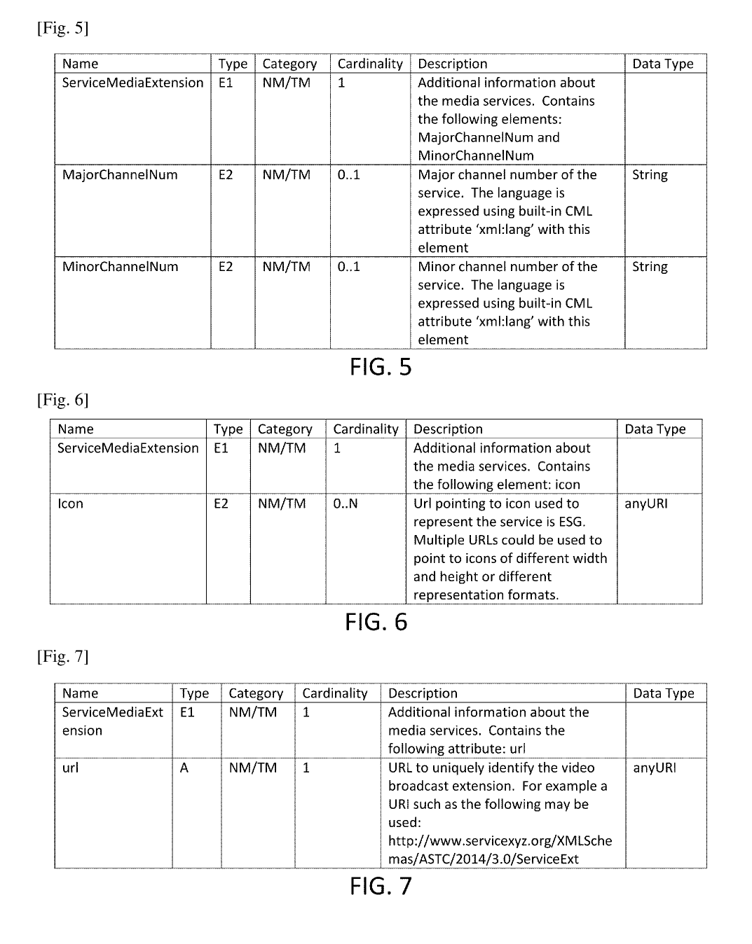

Referring to FIG. 5, to facilitate this flexibility an extension, such as ServiceMediaExtension, may be included with the programming guide elements which may specify further services. In particular, the ServiceMediaExtension may have a type element E1, a category NM/TM, with a cardinality of 1. The major channel may be referred to as MajorChannelNum, with a type element E2, a category NM/TM, a cardinality of 0 . . . 1, and a data type of string. By including the data type of string, rather than an unsignedByte, permits the support of other languages which may not necessarily be a number. The program guide information, including the ServiceMediaExtension may be included in any suitable broadcasting system, such as for example, ATSC.

After further reviewing the set of programming guide elements and attributes; (1) Name; (2) Description; (3) AudioLanguage; (4) TextLanguage; (5) ParentalRating; (6) TargetUserProfile; and (7) Genre it was determined that the receiving device still may have insufficient information suitable to appropriately rendering the information in a manner suitable for the viewer. In many cases, the viewer associates a graphical icon with a particular program and/or channel and/or service. In this manner, the graphical icon should be selectable by the system, rather than being non-selectable.

Referring to FIG. 6, to facilitate this flexibility an extension may be included with the programming guide elements which may specify an icon.

After yet further reviewing the set of programming guide elements and attributes; (1) Name; (2) Description; (3) AudioLanguage; (4) TextLanguage; (5) ParentalRating; (6) TargetUserProfile; and (7) Genre it was determined that the receiving device still may have insufficient information suitable to appropriately rendering the information in a manner suitable for the viewer. In many cases, the viewer may seek to identify the particular extension being identified using the same extension elements. In this manner, a url may be used to specifically identify the particular description of the elements of the extension. In this manner, the elements of the extension may be modified in a suitable manner without having to expressly describe multiple different extensions.

Referring to FIG. 7, to facilitate this flexibility an extension may be included with the programming guide elements which may specify a url.

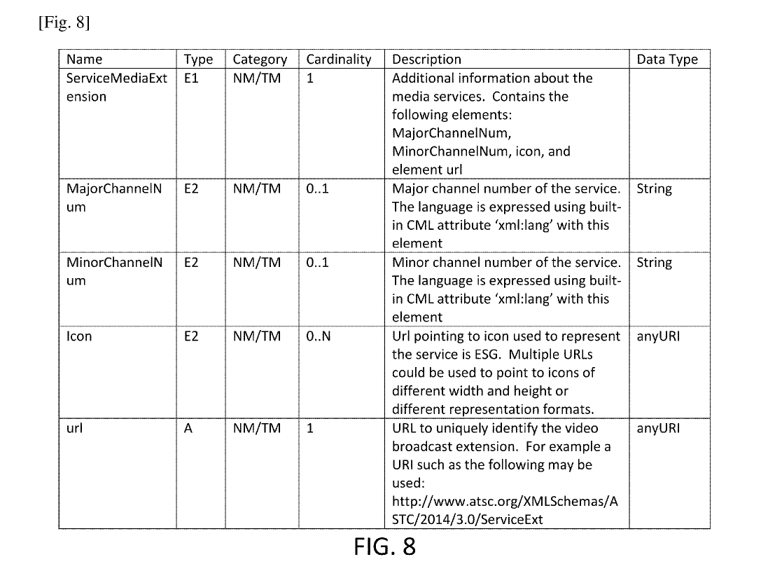

Referring to FIG. 8, to facilitate this overall extension flexibility an extension may be included with the programming guide elements which may specify an icon, major channel number, minor channel number, and/or url.

In other embodiments, instead of using Data Type “string” for MajorChannelNum and MinorChannelNum elements, other data types may be used. For example, the data type unisgnedInt may be used. In another example, a string of limited length may be used, e.g. string of 10 digits. An exemplary XML schema syntax for the above extensions is illustrated below.

```
<xs:element name=“ServiceMediaExtension ” type=“SerExtensionType”
minOccurs=“0” maxOccurs=“unbounded”/>
<xs:complexType name=“SerExtensionType”>
    <xs:sequence>
<xs:element name=“Icon” type=“xs:anyURI” minOccurs=“0”
maxOccurs=“unbounded”/>
<xs:element name=“MajorChannelNum” type=“LanguageString”
minOccurs=“0” maxOccurs=“1”/>
<xs:element name=“MinorChannelNum” type=“LanguageString”
minOccurs=“0” maxOccurs=“1”/>
    </xs:sequence>
    <xs:attribute name=“url” type=“xs:anyURI” use=“required”/>
</xs:complexType>
```

In some embodiments the ServiceMediaExtension may be included inside a OMA “extension” element or may in general use OMA extension mechanism for defining the ServiceMediaExtension.

In some embodiments the MajorChannelNum and MinorChannelNum may be combined into one common channel number and represented. For example a ChannelNum string may be created by concatenating MajorChannelNum followed by a period (‘.’) followed by MinorChannelNum. Other such combinations are also possible with period replaced by other characters. Similar concept can be applied when using unsignedInt or other data types to represent channel numbers in terms of combining MajorChannelNum and MinorChannelNum into one number representation.

In yet another embodiment a MajorChannelNum.MinorChannelNum could be represented as “ServiceId” element (Service Id) for the service.

In another embodiment, the ServiceMediaExtension may only be used inside a PrivateExt element within a Service fragment. An exemplary XML schema syntax for such an extension is illustrated below.

```
        <element name=“ ServiceMediaExtension ” type=
        “ SerExtensionType ”>
            <annotation>
                <documentation>
      This element is a wrapper for extensions to OMA BCAST SG
Service fragments. It may only be used inside a PrivateExt element
within a Service fragment.
            </documentation>
            </annotation>
</element>
<xs:complexType name=“SerExtensionType”>
    <xs:sequence>
<xs:element name=“Icon” type=“xs:anyURI” minOccurs=“0”
maxOccurs=“unbounded”/>
<xs:element name=“MajorChannelNum” type=“LanguageString”
minOccurs=“0” maxOccurs=“1”/>
<xs:element name=“MinorChannelNum” type=“LanguageString”
minOccurs=“0” maxOccurs=“1”/>
    </xs:sequence>
    <xs:attribute name=“url” type=“xs:anyURI” use=“required”/>
</xs:complexType>
```

In other embodiments some of the elements above may be changed from E2 to E1. In other embodiments the cardinality of some of the elements may be changed. In addition, if desired, the category may be omitted since it is generally duplicative of the information included with the cardinality.

It is desirable to map selected components of the ATSC service elements and attributes to the OMA service guide service fragment program guide. For example, the “Description” attribute of the OMA service guide fragment program guide may be mapped to “Description” of the ATSC service elements and attributes, such as for example ATSC-Mobile DTV Standard, Part 4—Announcement, other similar broadcast or mobile standards for similar elements and attributes. For example, the “Genre” attribute of the OMA service guide fragment program guide may be mapped to “Genre” of the ATSC service elements and attributes, such as for example ATSC-Mobile DTV Standard, Part 4—Announcement, other similar standards for similar elements and attributes. In one embodiment Genre scheme as defined in Section 6.10.2 of ATSC A153/ Part 4 may be utilized For example, the “Name” attribute of the OMA service guide fragment program guide may be mapped to “Name” of the ATSC service elements and attributes, such as for example ATSC-Mobile DTV Standard, Part 4—Announcement, other similar standards for similar elements and attributes. Preferably, the cardinality of the name is selected to be 0 . . . N, which permits the omission of the name which reduces the overall bit rate of the system and increase flexibility. For example, the “ParentalRating” attribute of the OMA service guide fragment program guide may be mapped to a new “ContentAdvisory” of the ATSC service element and attributes, such as for example ATSC-Mobile DTV Standard, Part 4—Announcement, or similar standards for similar elements and attributes. For example, the “TargetUserProfile” attribute of the OMA service guide fragment program guide may be mapped to a new “Personalization” of the ATSC service element and attributes, such as for example ATSC-Mobile DTV Standard, Part 4—Announcement, or similar standards for similar elements and attributes.

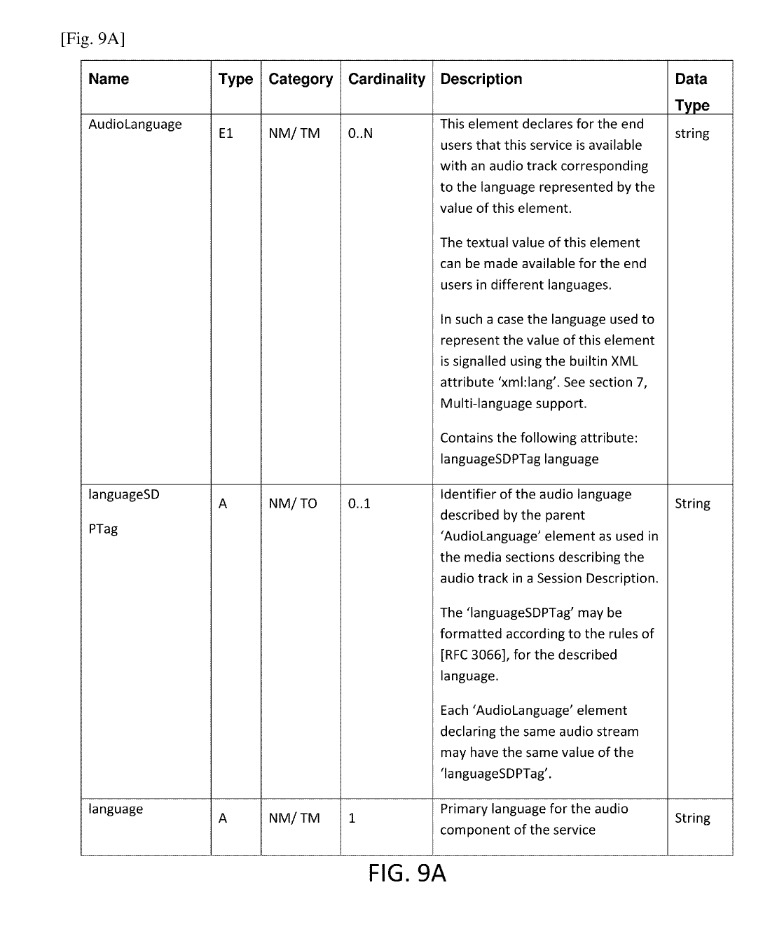

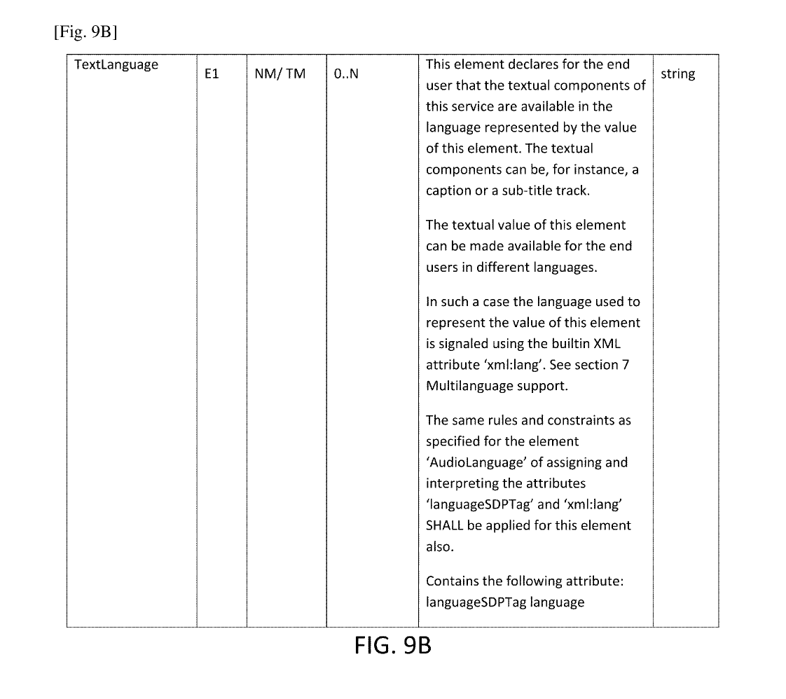

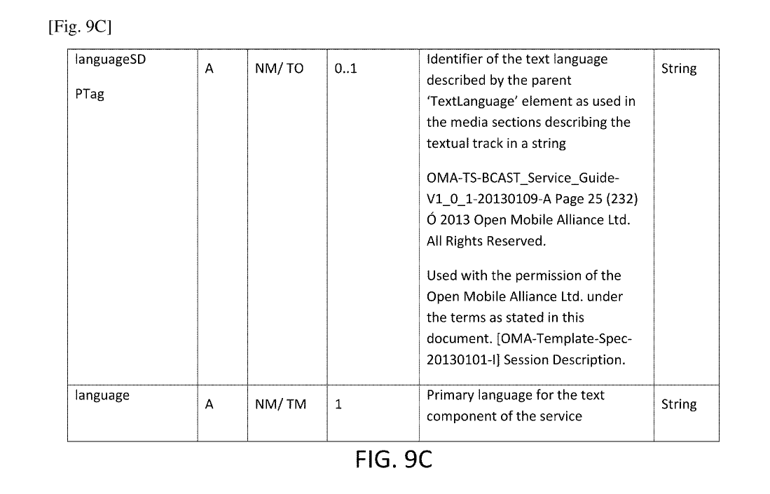

Referring to FIGS. 9A, 9B, 9C, the elements AudioLanguage (with attribute languageSDPTag) and TextLanguage (with attribute languageSDPTag) could be included if Session Description Fragment is included in the service announcement, such as for example ATSC-Mobile DTV Standard, Part 4—Announcement, or similar standards for similar elements and attributes. This is because the attribute languageSDPTag for the elements AudioLanguage and TextLanguage are preferably mandatory. This attribute provides identifier for audio/ text language described by the parent element as used in the media sections describing audio/ text track in a session description. In another embodiment the attribute languageSDPTag could be made optional and the elements AudioLanguage and TextLanguage could be included with an attribute “Language” with data type “string” which can provide language name.

An example XML schema syntax for this is shown below.

```
<xs:complexType name=“AudioOrTextLanguageType”>
    <xs:simpleContent>
            <xs:extension base=“LanguageString”>
                <xs:attribute name=“languageSDPTag”
                type=“xs:string” use= “optional”/>
    <xs:attribute name=“language” type=“xs:string” use=“required”/>
    </xs:extension>
    </xs:simpleContent>
</xs:complexType>
```

In another embodiment the attributes languageSDPTag for the elements AudioLanguage and TextLanguage could be removed. An example XML schema syntax for this is shown below.

```
<xs:complexType name=“AudioOrTextLanguageType”>
    <xs:simpleContent>
            <xs:extension base=“LanguageString”>
    <xs:attribute name=“language” type=“xs:string” use=“required”/>
    </xs:extension>
    </xs:simpleContent>
</xs:complexType>
```

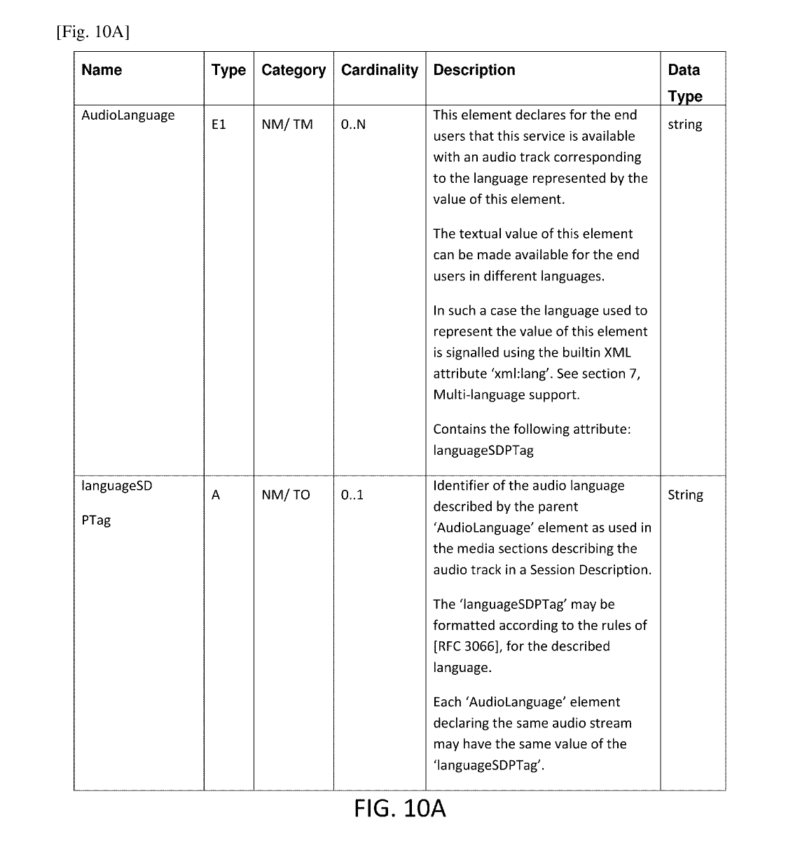

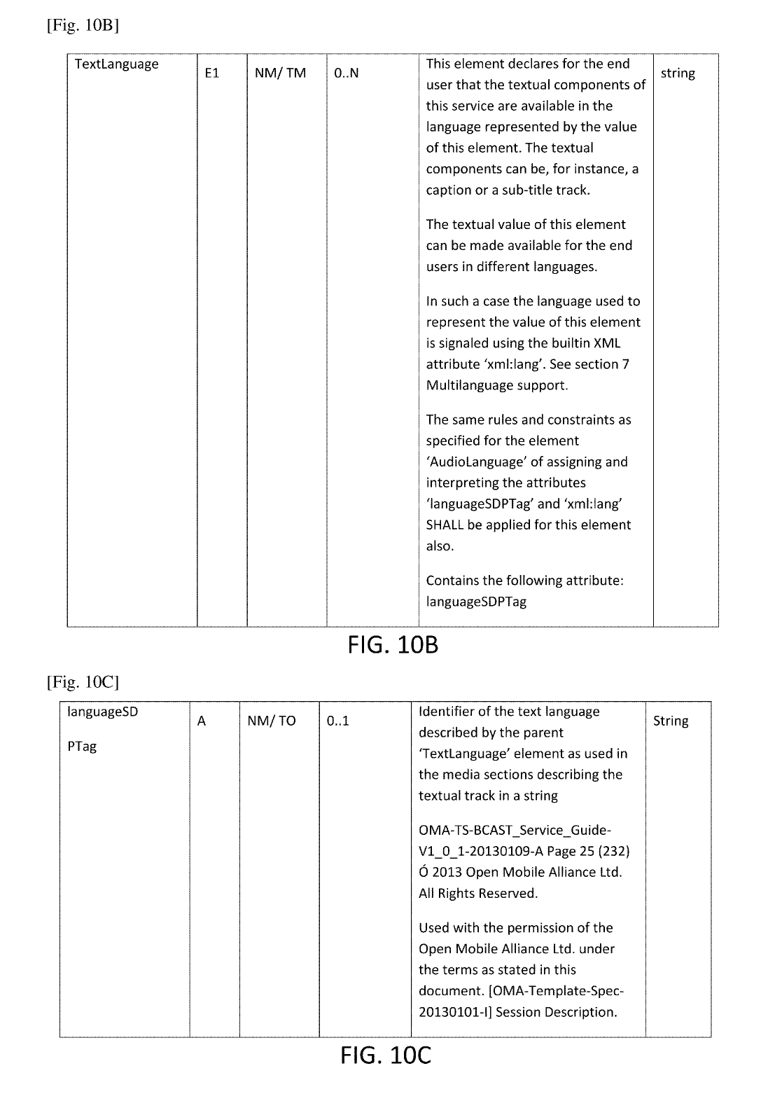

Referring to FIGS. 10A, 10B, 10C, the elements AudioLanguage (with attribute languageSDPTag) and TextLanguage (with attribute languageSDPTag) could be included if Session Description Fragment is included in the service announcement, such as for example ATSC-Mobile DTV Standard, Part 4—Announcement, or similar standards for similar elements and attributes. This is because the attribute languageSDPTag for the elements AudioLanguage and TextLanguage are preferably mandatory. This attribute provides identifier for audio/ text language described by the parent element as used in the media sections describing audio/ text track in a session description. In another embodiment the attribute languageSDPTag could be made optional.

An example XML schema syntax for this is shown below.

```
<xs:complexType name=“AudioOrTextLanguageType”>
    <xs:simpleContent>
            <xs:extension base=“LanguageString”>
                <xs:attribute name=“languageSDPTag”
                type=“xs:string” use= “optional”/>
    </xs:extension>
    </xs:simpleContent>
</xs:complexType>
```

In another embodiment the attributes languageSDPTag for the elements AudioLanguage and TextLanguage could be removed. An example XML schema syntax for this is shown below.

```
<xs:complexType name=“AudioOrTextLanguageType”>
    <xs:simpleContent>
            <xs:extension base=“LanguageString”>
    </xs:extension>
    </xs:simpleContent>
</xs:complexType>
```

In another embodiment the attribute “language” could be mapped to ATSC service “language” element and could refer to the primary language of the service.

In another embodiment the value of element “AudioLanguage” could be mapped to

ATSC service “language” element and could refer to the primary language of the audio service in ATSC.

In another embodiment the value of element “TextLanguage” could be mapped to ATSC service “language” element and could refer to the primary language of the text service in ATSC. In some cases the text service may be a service such as closed caption service. In another embodiment the elements AudioLanguage and TextLanguage and their attributes could be removed.

For the service guide, traditionally the consideration has been to reference the linear stream of the audio-visual content, generally referred to as a “linear service”. With the proliferation of applications also referred to as “apps” it is desirable to reference app-based (i.e. application based) services which are other programs that are executed and provide a service to the user, generally referred to as “app-based service”. It is desirable to map notification stream of the “linear service” or the “app-based service” using the Notification ServiceType element 7 of the OMA service guide fragment program guide.

It is also desirable to enable the notification of other services using the ServiceType element of the OMA service guide fragment program guide. The ServiceType may use the range “reserved for proprietary use” to include additional service types. For example, ServiceType element value 224 may be used to identify an “App-Based Service” that includes an application component to be used. For example, ServiceType element value 225 may be used to identify an “App-Based Service” that includes non-real time content to be used. For example, ServiceType element value 226 may be used for to identify an “App-Based Service” that includes an on-demand component to be used. In this manner, these app-based services are mapped to the Notification ServiceType element 7, and thus are readily omitted when the Notification ServiceType element 7 does not indicate their existence, thereby reducing the complexity of the bitstream.

In another embodiment, rather than mapping the notification to the value of 7 for OMA ServiceType, an additional ServiceType value may be defined. A Notification ServiceType element 227 of the OMA service guide fragment program guide may be used to identify an “App-Based Service” that includes an application component to be used including a notification stream component.

It is to be understood that other values may likewise be used for the described services. For example instead of service type values 224, 225, 226, and 227 above the service type values 240, 241, 242, 243 may be used. In yet another case the service type values 129, 130, 131, 132 may instead be used.

In yet another embodiment instead if using ServiceType values from the range (128-255) reserved for proprietary use, the values from the range (11-127) reserved for future use may be used.

In yet another embodiment when using OMA BCAST Guide 1.1 from instead if using ServiceType values from the range (128-255) reserved for proprietary use, the values from the range (14-127) reserved for future use may be used.

In yet another embodiment when using OMA BCAST Guide 1.1 from [instead if using ServiceType values from the range (128-255) reserved for proprietary use, the values from the range (128-223) reserved for other OMA enablers may be used.

In yet another embodiment when using OMA BCAST Guide 1.1 from instead if using ServiceType values from the range (128-255) reserved for proprietary use, the values may be restricted in the range (224-255) reserved for other OMA enablers may be used

In another embodiment, for example, an additional ServiceType element value 228 may be used to identify a “Linear Service”. For example, an additional ServiceType element value 229 may be used to identify an “App-Based Service” that includes a generalized application based enhancement. In this manner, the service labeling is simplified by not expressly including services type for application component, non-real time content, nor on-demand component.

In another embodiment, for example, an additional or alternative ServiceType element value 230 may be used for to identify an “App-Based Service” that includes an application based enhancement. In this manner, the notification is further simplified by not expressly including services type for linear service, application component, non-real time content, nor on-demand component.

In another embodiment, for example, the ServiceType element value 1 also may be used for to identify a “Linear Service”. In this manner, the Linear Element is incorporated within the existing syntax structure. In this case the “Linear service” is mapped to Basic TV service.

In another embodiment, for example, the ServiceType element value 11 may be used for to identify a streaming on demand component, which may be an app-based service with app-based enhancement including an on demand component. For example, ServiceType element value 12 may be used to identify a file download on demand component, which may be an app-based enhancement including a non-real time content item component.

In another embodiment, any one of the above service type values may be indicated by a value within another element. For example, an AvailableContent element or attribute and its values could take one of the values from application component, non-real time content, on-demand component, and/or notification.

In another embodiment, the ServiceType value allocation may be done hierarchically. For example, the main service types may be a linear service and an app-based service, and each of these two types of services could include zero or more app-based enhancements components which can include application component, non-real time content, on demand component, and/or notification, a hierarchical allocation of ServiceType values may be done. In this case for “ServiceType” one of the bits of “unsigned Byte” (date type of ServiceType) could be used to signal a linear service (bit with value set to 1) or an app-based service (bit with value set to 0). Then the rest of the bits can signal the service types.

An example is illustrated as follows:

224 (11100000 binary) Linear Service with App-Based Enhancement including application component
240 (11110000 binary) App-Based Service with App-Based Enhancement including application component
225 (11100001 binary) Linear Service with App-Based Enhancement including non-real time content
241 (111100001 binary) App-Based Service with App-Based Enhancement including non-real time content
226 (11100010 binary) Linear Service with App-Based Enhancement including on demand component
242 (11110010 binary) App-Based Service with App-Based Enhancement including on demand component
227 (11100011 binary) Linear Service with App-Based Enhancement including notification stream component
243 (11110011 binary) App-Based Service with App-Based Enhancement including notification stream component
228 (11100100 binary) Linear Service with generic service type
243 (11110100 binary) App-Based Service with generic service type
The generic service type may refer to the service different than a service which has application component or non-real-time content or on demand component. In some case the generic service type may be an “unknown” service type.

In yet another embodiment, the values may use contiguous ServiceType values. For example the service type values could be assigned as follows:

224 Linear Service with App-Based Enhancement including application component
225 App-Based Service with App-Based Enhancement including application component
226 Linear Service with App-Based Enhancement including non-real time content
227 App-Based Service with App-Based Enhancement including non-real time content
228 Linear Service with App-Based Enhancement including on demand component
229 App-Based Service with App-Based Enhancement including on demand component
230 Linear Service with App-Based Enhancement including notification stream component
231 App-Based Service with App-Based Enhancement including notification stream component

In yet another embodiment the Linear/App-based service: App may be further split into two service types (and thus four total service types as) follows:
Linear service: primary App (e.g. ServiceType value 224)
Linear service: non primary app. (e.g. ServiceType value 225)
App-based service: primary App (e.g. ServiceType value 234)
App based service: non primary app. (e.g. ServiceType value 235)

Where a Primary App, may be an app which is activated as soon as the underlying service is selected. Also non-primary apps may be started later in the service..

In some embodiments, the service of the type Linear Service: On-Demand component may be forbidden. In that case, no ServiceType value may be assigned for that type of service.

Additional embodiments related to service signaling are described as follows. In general service announcement and service signaling may be as follows. Service Announcement may include information about programming and services that is designed to allow the viewer or user to make an informed selection about service or content. Service Signaling may include information that enables the receiver to locate and acquire services and to perform basic navigation of the service.

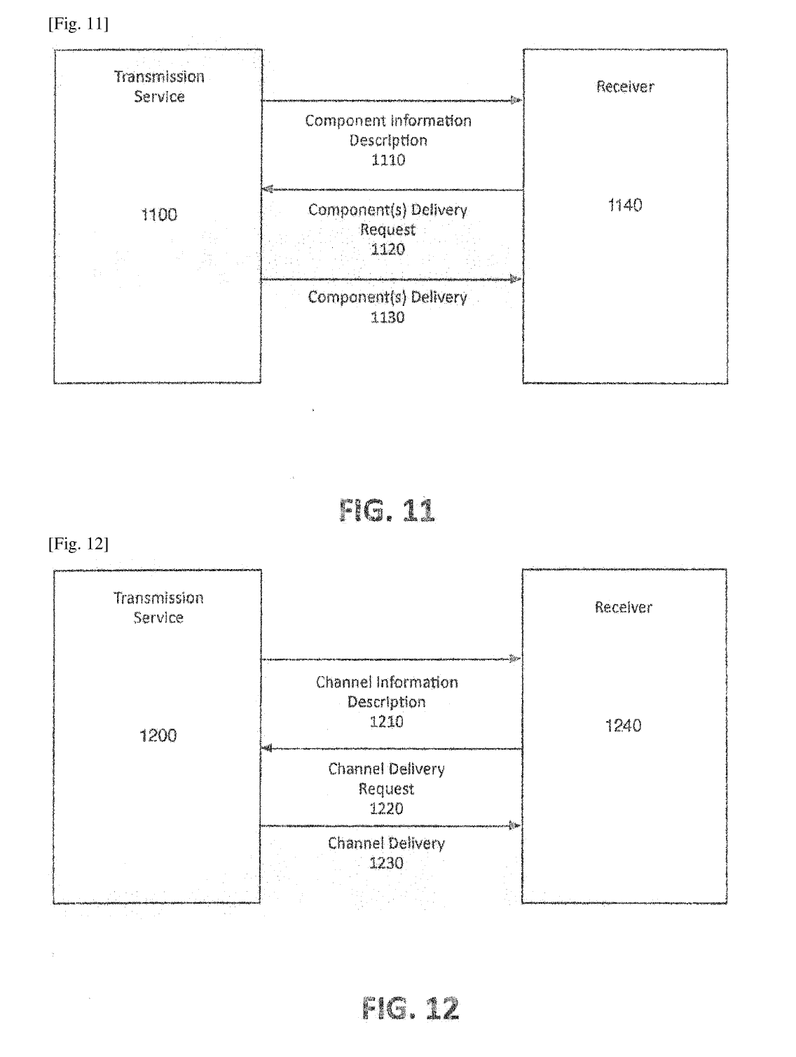

Referring to FIG. 11 component information description signaling is described. The transmission service provider 1100 is an example of a provider of service configured to enable television services to be provided. For example, transmission service provider 1100 may include public over-the-air television networks, public or subscription-based satellite television service provider networks, over-the-top service networks, broadcast service networks, and public or subscription-based cable television provider networks. It should be noted that although in some examples transmission service provider 1100 may primarily be used to enable television services to be provided, transmission service 1100 provider may also enable other types of data and services to be provided according to any combination of the telecommunication protocols and messages described herein. Transmission service provider 1100 may comprise any combination of wireless and/or wired communication media. Transmission service provider 1100 may include coaxial cables, fiber optic cables, twisted pair cables, wireless transmitters and receivers, routers, switches, repeaters, base stations, or any other equipment that may be useful to facilitate communications between various devices and sites.

With respect to FIG. 11, receiver 1140 may include any device configured to receive a service from transmission service provider 1100. For example, a receiver 1140 may be equipped for wired and/or wireless communications and may include televisions, including so-called smart televisions, set top boxes, and digital video recorders. Further, the receiver 1140 may include desktop, laptop, or tablet computers, gaming consoles, mobile devices, including, for example, smartphones, cellular telephones, and personal gaming devices configured to receive service from transmission service provider 1100.

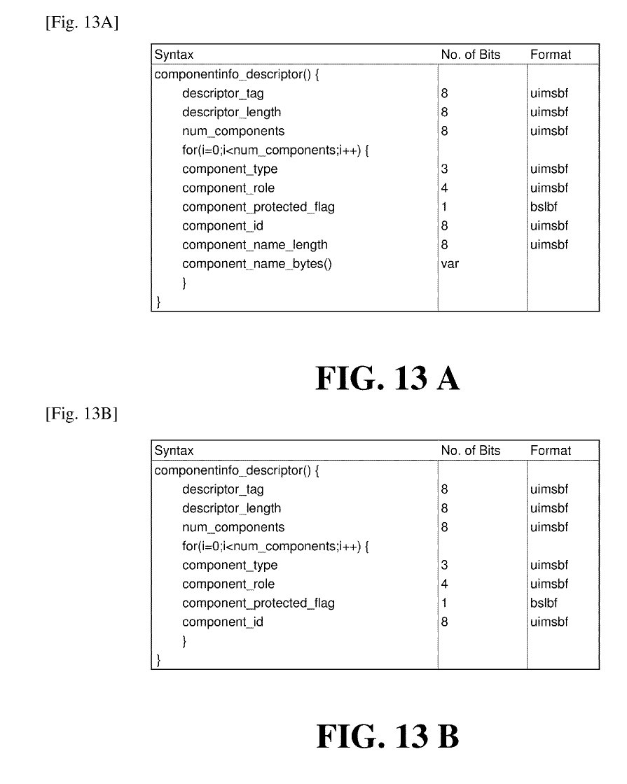

As a part of receiving service from transmission service 1100, the receiver 1140 may receive signaling information which may provide information about various media streams and data that may be received via delivery mechanism. In one embodiment the signaling information from transmissions service provider 1100 may include component information description 1110. An example of component information description is provided later with respect to FIGS. 13A, 13B, 15, and 17. After receiving this component information description 1110, the receiver 1140 may parse it or decode it. In one example the receiver 1140 may not be able to parse further signaling information until it parses the component information description 1110. In one example the receiver 1140 may display some or all of component information description 1110 to the viewer after decoding, parsing and rendering it. In some cases it may display this information on screen of the receiver device which can be viewed by the viewer. In an example case the viewer may make a decision based on this information that is received, parsed and displayed. In one example the decision may be to receive one or more components of the service. In this case the receiver 1140 may send a components delivery request 1120 for one or more components of the service to the transmission service provider 1100. In one example the receiver 1140 may receive delivery of requested components from transmission service 1110.

Referring to FIG. 12, channel information description signaling is described. The transmission service provider 1200 is an example of a provider of service configured to enable television services to be provided. For example, transmission service provider 1200 may include public over-the-air television networks, public or subscription-based satellite television service provider networks, over-the-top service networks, broadcast service networks, and public or subscription-based cable television provider networks. It should be noted that although in some examples transmission service provider 1200 may primarily be used to enable television services to be provided, transmission service provider 1200 may also enable other types of data and services to be provided according to any combination of the telecommunication protocols and messages described herein. Transmission service provider 1200 may comprise any combination of wireless and/or wired communication media. Transmission service provider 1200 may include coaxial cables, fiber optic cables, twisted pair cables, wireless transmitters and receivers, routers, switches, repeaters, base stations, or any other equipment that may be useful to facilitate communications between various devices and sites.

Referring to FIG. 12, the receiver 1240 may include any device configured to receive a service from transmission service provider 1200. For example, the receiver 1240 may be equipped for wired and/or wireless communications and may include televisions, including so-called smart televisions, set top boxes, and digital video recorders. Further, the receiver 1240 may include desktop, laptop, or tablet computers, gaming consoles, mobile devices, including, for example, smartphones, cellular telephones, and personal gaming devices configured to receive service from transmission service provider 1200.

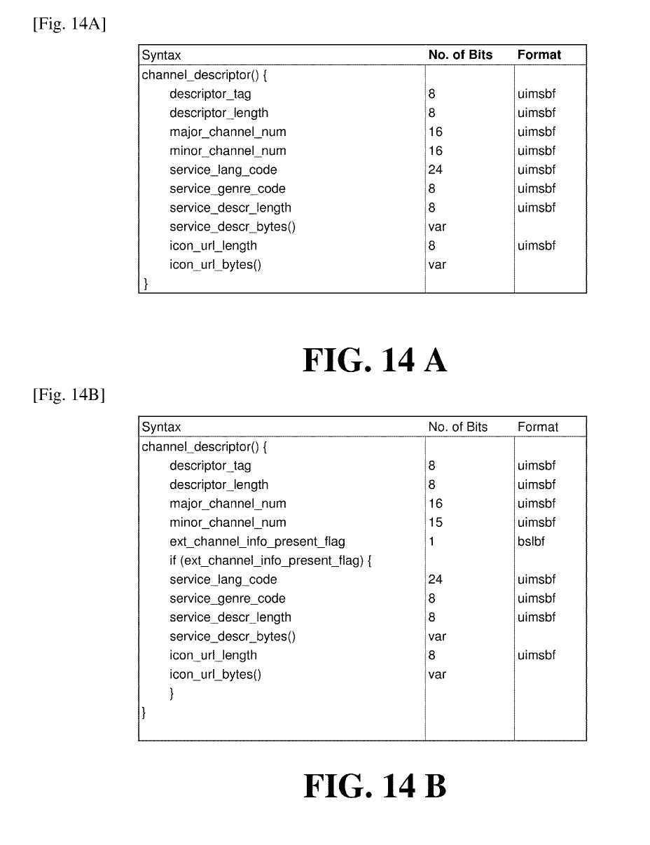

As a part of receiving service from transmission service provider 1200, the receiver 1240 may receive signaling information which may provide information about various media streams and data that may be received via delivery mechanism. In one embodiment the signaling information from transmissions service provider 1200 may include channel information description 1210. An example of channel information description is provided later with respect to FIGS. 14A, 14B, 16, and 18. After receiving this channel information description 1210, the receiver 1240 may parse it or decode it. In one example the receiver 1240 may not be able to parse further signaling information until it parses the channel information description 1210. In one example the receiver 1240 may display some or all of channel information description 1210 to the viewer after decoding, parsing and rendering it. In some cases it may display this information on screen of the receiver device 1240 which can be viewed by the viewer. In an example case the viewer may make a decision based on this information that is received, parsed and displayed. In one example the decision may be to receive channel of the service. In this case the receiver 1240 may send a channel delivery request 1220 for the service to the transmission service provider 1200. In one example the receiver 1240 may receive delivery of channel from transmission service 1200.

FIGS. 13A-13B illustrate a binary syntax for a component information descriptor.

FIG. 13B includes fewer syntax elements compared to FIG. 13A and thus may be easier to transmit by the transmission service provider 1100 and may be easier to parse and decode by the receiver 1140.

The Component Information Descriptor of FIG. 13A and FIG. 13B provides information about the components available in the service. This includes information about number of components available in the service. For each available component following information is signaled: component type, component role, component name, component identifier, component protection flag. Audio, video, closed caption and application components can be signaled. Component role values are defined for audio, video and closed caption components.

The syntax for the Component Information Descriptor may conform to the syntax shown in FIG. 13A or FIG. 13B. In another embodiment instead of all of the component information descriptor only some of the elements in it maybe signaled in the component information descriptor or inside some other descriptor or some other data structure.

Semantic meaning of the syntax elements in the component information descriptor of FIG. 13A and FIG. 13B may be as follows.

descriptor_tag—This is 8-bit unsigned integer for identifying this descriptor. Any suitable value between 0-255 which uniquely identifies this descriptor can be signaled. In one embodiment the format of this field may be uimsbf. In another embodiment some other format may be used which allows identifying the descriptor uniquely compared to other descriptors based on this descriptor_tag value.

descriptor_length—This 8-bit unsigned integer may specify the length (in bytes) immediately following the field num_components up to the end of this descriptor. In some embodiments instead of 8-bit, this field may be 16-bit.

num_components—This 8-bit unsigned integer field may specify the number of components available for this service. The value of this field may be in the range of 1 to 127 inclusive. Values 128-255 are reserved. In an alternative embodiment this field may be split into two separate fields: a 7-bit unsigned integer field num_components and a 1 bit reserved field.

component_type—This 3-bit unsigned integer may specify the component type of this component available in the service. Value of 0 indicates an audio component. Value of 1 indicates a video component. Value of 2 indicated a closed caption component. Value of 3 indicates an application component. Values 4 to 7 are reserved.

component_role—This 4-bit unsigned integer may specify the role or kind of this component. The defined values include one or more:

For audio component (when component_type field above is equal to 0) values of component_role are as follows:

0=Complete main,

### 1=Music and Effects,

### 2=Dialog,

### 3=Commentary,

### 4=Visually Impaired,

### 5=Hearing Impaired,

### 6=Voice-Over,

7-14=reserved,
15=unknown

In another embodiment additionally component_role values for audio may be defined as follows: 7=Emergency, 8=Karaoke. In this case the values 9-14 will be reserved and 15 will be used to signal unknown audio role.

For Video (when component_type field above is equal to 1) values of component_role are as follows:

0=Primary video,

1=Alternative camera view,

2=Other alternative video component,

3=Sign language inset,

4=Follow subject video,

5=3D video left view,

6=3D video right view,

7=3D video depth information,

8=Part of video array <x,y> of <n,m>,

9=Follow-Subject metadata,

10-14=reserved,

15=unknown

For Closed Caption component (when component_type field above is equal to 2) values of component_role are as follows:

0=Normal,

1=Easy reader,

2-14=reserved,

15=unknown.

When component_type field above is between 3 to 7, inclusive, the component_role may be equal to 15.

component_protected_flag—This 1-bit flag indicates if this component is protected (e.g. encrypted). When this flag is set to a value of 1 this component is protected (e.g. encrypted). When this flag is set to a value of 0 this component is not protected (e.g. encrypted).

component_id—This 8-bit unsigned integer nay specify the component identifier of this component available in this service. The component_id may be unique within the service.

component_name_length—This 8-bit unsigned integer may specify the length (in bytes) of the component_name_bytes( )field which immediately follows this field.

component_name_bytes( )—Short human readable name of the component in “English” language. Each character of which may be encoded per UTF-8.

With respect to FIG. 13A, FIG. 13B, FIG. 14A, FIG. 14B the format column of the descriptor may be interpreted as follows.
TBD: means to be decided as described above.
uimsbf: means Unsigned Integer, Most Significant Bit First,
bslbf: means Bit string, left bit first.

FIGS. 14A-14B illustrate a binary syntax for a channel information descriptor. The Channel Descriptor of FIG. 14A and FIG. 14B provides information about the channel(s) in the service. This includes Major channel number, minor channel number, primary channel language, channel genre, channel description (in multiple languages) and channel icon.

The syntax for the Channel Descriptor may conform to the syntax shown in FIG. 14A or FIG. 14B. In another embodiment instead of all of the channel descriptor only some of the elements in it maybe signaled in the channel descriptor or inside some other descriptor or some other data structure.

Semantic meaning of the syntax elements in the channel descriptor of FIG. 14A and FIG. 14B is as follows.

descriptor_tag—This is 8-bit unsigned integer for identifying this descriptor. Any suitable value between 0-255 which uniquely identifies this descriptor can be signaled. In one embodiment the format of this field may be uimsbf. In another embodiment some other format may be used which allows identifying the descriptor uniquely compared to other descriptors based on this descriptor_tag value.

descriptor_length—This 8-bit unsigned integer may specify the length (in bytes) immediately following this field up to the end of this descriptor.

major_channel_num—This 16-bit unsigned integer may specify the major channel number of the service. In another embodiment the bit width of 8-bit or 12-bit may be used for this field instead of 16-bit.

minor_channel_num—This 16-bit unsigned integer may specify the minor channel number of the service in the case of channel descriptor shown in FIG. 14A. In another embodiment the bit width of 8-bit or 12-bit may be used for this field instead of 16-bit.

In the case of channel descriptor shown in FIG. 14B the bit width is changed to 15-bit. Thus for FIG. 14B this 15-bit unsigned integer may specify the minor channel number of the service. In another embodiment the bit width of 7-bit or 11-bit may be used for this field instead of 15-bit.

service_lang_code—Primary language used in the service. This field may consist of one of the 3 letter code in ISO 639-3 titled “Codes for the representation of names of languages—Part 3: Alpha-3 code for comprehensive coverage of languages available at http://www.iso.org which is incorporated by reference in its entirety here by reference. In other embodiments a pre-defined list of languages may be defined and this field can be an index into the list of those fields. In an alternate embodiment 16 bits may be used for this field since upper bound for the number of languages that can be represented is 26×26×26 i.e. 17576 or 17576−547=17030.

service_lang_genre—Primary genre of the service. The service_lang_genre element may be instantiated to describe the genre category for the service. The <classificationSchemeURI>is http://www.atsc.org/XMLSchemas/mh/2009/1.0/genre-cs/ and the value of service_lang_genre may match a termID value from the classification schema in Annex B of A/153 Part 4 document titled “ATSC-Mobile DTV Standard, Part 4—Announcement” available at http://www.atsc.org which is incorporated in its entirety here by reference.

icon_url_length—This 8-bit unsigned integer may specify the length (in bytes) of the icon_url_bytes( ) field which immediately follows this field.

icon_url_bytes( )—Uniform Resource Locator (URL) for the icon used to represent this service. Each character may be encoded per UTF-8.

service_descriptor_length—This 8-bit unsigned integer may specify the length (in bytes) of the service_descr_bytes( )field which immediately follows this field.

service_descr_bytes( )—Short description of the service. Either in “English” language or in the language identified by the value of service_lang_code field in this descriptor. Each character of which may be encoded per UTF-8.

The values of icon_url_length and service_descriptor_length are constrained as specified by the value of the descriptor_length field which provides information about the length of this entire descriptor.

With respect to FIG. 14B and additional syntax element is as follows:

ext_channel_info_present_flag—This 1-bit Boolean flag that may indicate, when set to ‘1’, that extended channel information fields for this service including the fields service_lang_code, service_genre_code, service_descr_length, service_descr_bytes( ) icon_url_length, icon url bytes( )are present in this descriptor. A value of ‘0’, may indicate that extended channel information fields for this service including the fields service_lang_code, service_genre_code, service_descr_length, service_descr_bytes( ) icon_url_length, icon_url_bytes( )are not present in this descriptor.

Thus when using the channel descriptor shown in FIG. 14B by setting the ext_channel_info_present_flag value to 1 fewer elements compared to FIG. 14A can be signaled in the descriptor and thus it may be easier to transmit by the transmission service provider 1200 and may be easier to parse and decode by the receiver 1240.

In some embodiments it may be a requirement of bitstream conformance that when channel information descriptor (e.g. FIG. 14B) is included in a fast information channel then ext_channel_info_present_flag may be equal to 0. In another embodiment when channel information descriptor (e.g. FIG. 14B) is included for signaling in a location where bit efficiency is required then ext_channel_info_present_flag may be equal to 0.

In yet another embodiment it may be a requirement of a bitstream conformance that ext_channel_info_present_flag may be equal to 1.

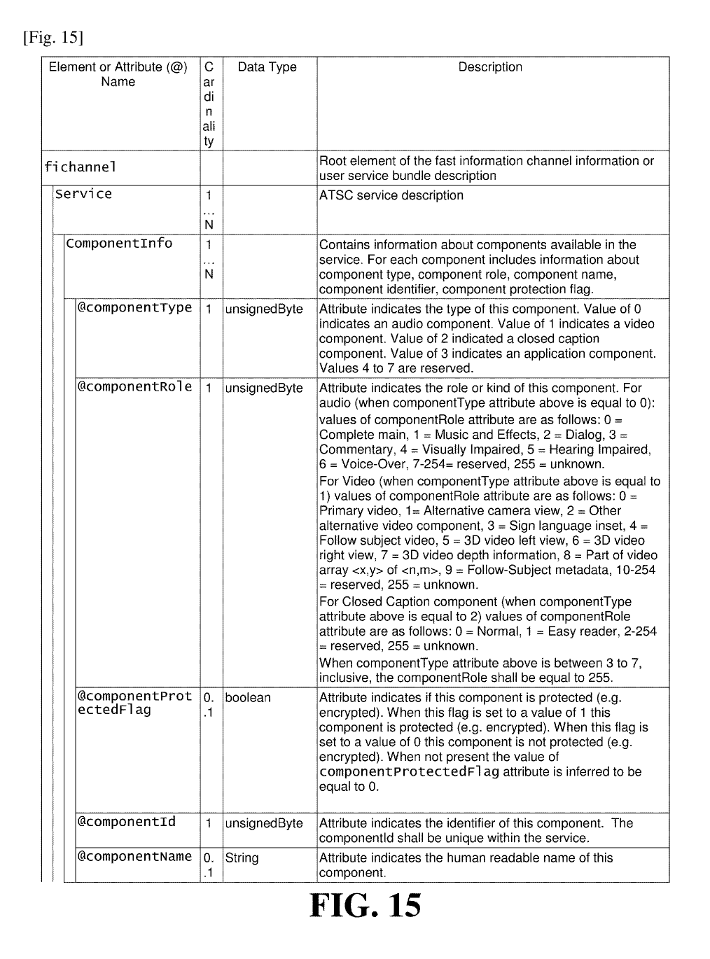

In addition to the binary syntax of FIG. 13A or FIG. 13B for the component information descriptor, a different representation may be used. FIG. 15 illustrates a XML syntax and semantics for a component information descriptor. FIG. 17 illustrates a XML schema for a component information descriptor.

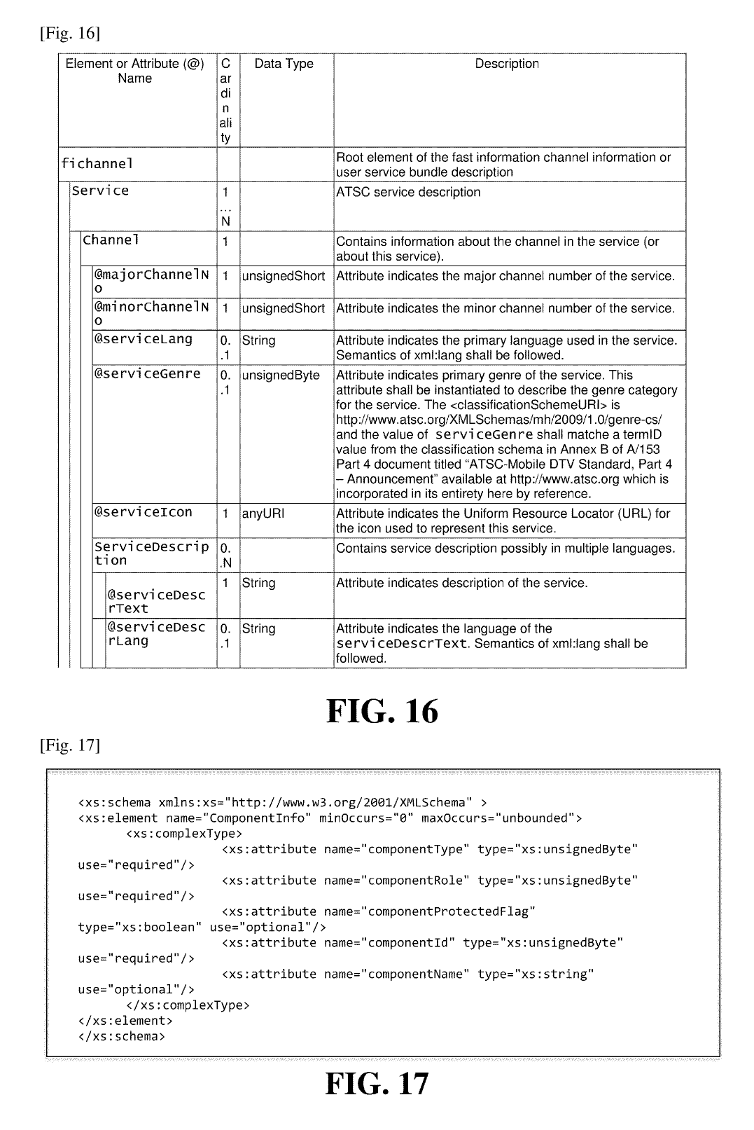

In addition to the binary syntax of FIG. 14A or FIG. 14B for the channel information descriptor, a different representation may be used. FIG. 16 illustrates a XML syntax and semantics for a channel information descriptor.

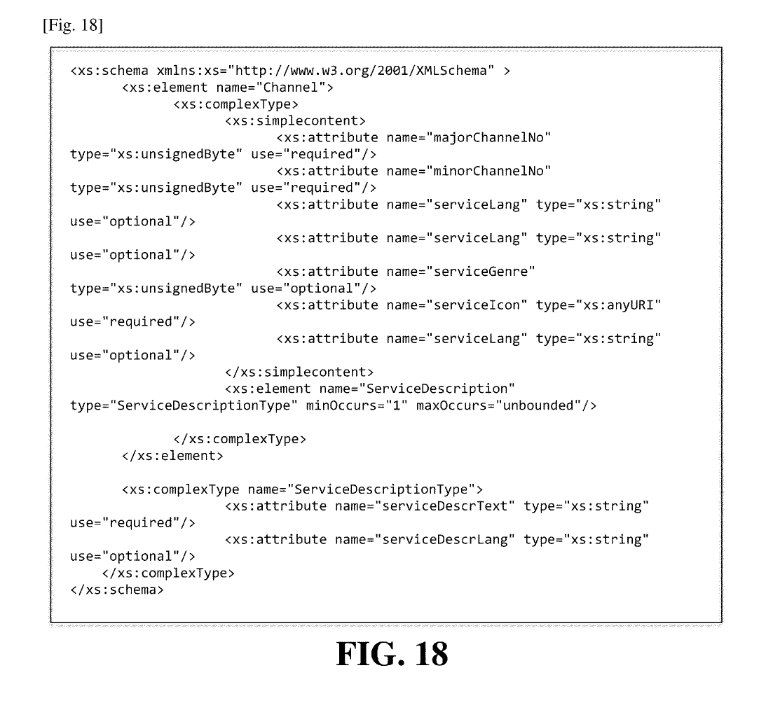

FIG. 18 illustrates a XML schema for a channel information descriptor.

Following Terms are defined.

LLS (Low Level Signaling)—Signaling that provides information common to all services and pointers to service definition information.

SLS (Service Layer Signaling)—Signaling which provides information for discovery and acquisition of ATSC 3.0 services and their content components. They are carried over IP packets.

SLT (Service List Table)—Signaling information which is used to build a basic service listing and provide bootstrap discovery of SLS.

S-TSID (Service-based Transport Session Instance Description)—One of SLS XML fragments which provides the overall session description information for transport session(s) which carry the content components of an ATSC service.

Broadcast Stream—The abstraction for an RF Channel which is defined in terms of a carrier frequency centered within a specified bandwidth.

PLP (Physical Layer Pipe)—A portion of the RF channel which has certain modulation and coding parameters.

reserved—Set aside for future use by a Standard.

Service List Table (SLT) is described next.

An Service List Table supports rapid channel scans and service acquisition by including the following information about each service in the broadcast stream:
(A) Information necessary to allow the presentation of a service list that is meaningful to viewers and that can support initial service selection via channel number or up/down selection.
(B) The information necessary to locate the Service Layer Signaling for each service listed.

Service List Table Bit Stream Syntax and Semantics is described next.

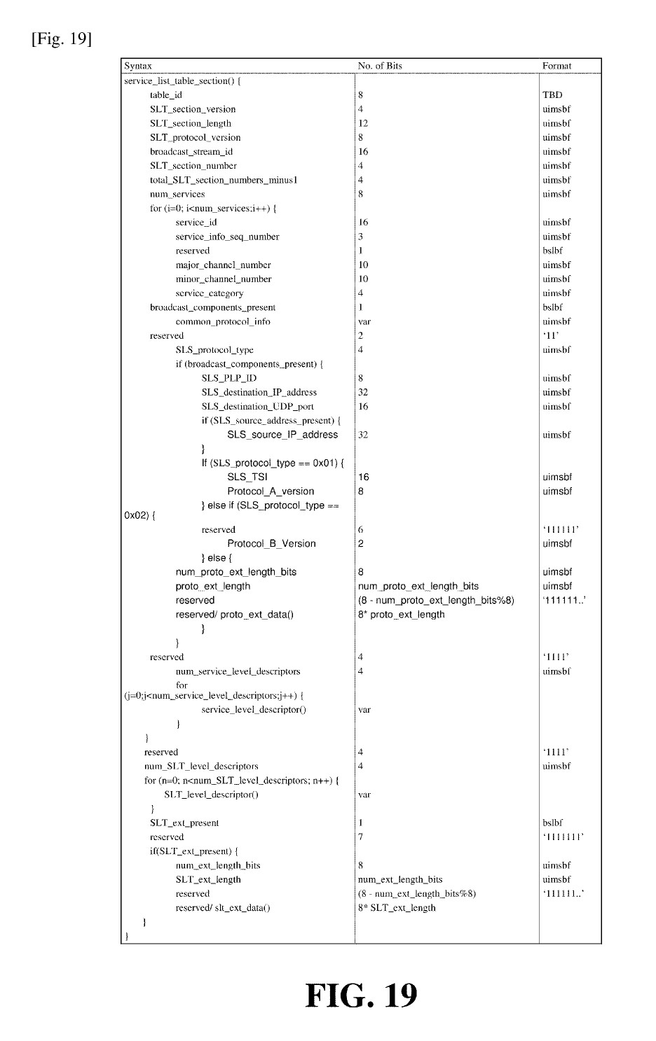

An Service List Table may consist of one or more sections. The bit stream syntax of a Service List Table section may be as shown in FIG. 19.

The semantic definitions of the fields in the FIG. 19 are given below.

table_id—An 8-bit unsigned integer that may be set to the value to be determined (TBD) to indicate that the table is a service_list_table_section( ).

SLT_section version—This 4-bit field may indicate the version number of the SLT section. The SLT section version may be incremented by 1 when a change in the information carried within the service list table section( )occurs. When it reaches maximum value of ‘1111’, upon the next increment it may wrap back to 0.

SLT_section_length—This 12-bit field may specify the number of bytes of this instance of the service_list_table_section ( ) starting immediately following the SLT_section_length field.

SLT_protocol_version—An 8-bit unsigned integer that may indicate the version of the structure of this SLT. The upper four bits of SLT protocol version may indicate the major version and the lower four bits the minor version. For this first release, the value of SLT_protocol_version may be set to 0×10 to indicate version 1.0.

broadcast_stream_id—This 16-bit unsigned integer may identify the overall broadcast stream. The uniqueness of the value may be scoped to a geographic region (e.g. North America).

SLT_section_number—This 4-bit unsigned integer field may indicate the number of the section, starting at zero. An SLT may be comprised of multiple SLT sections.

total_SLT_section_numbers_minus1—This 4-bit unsigned integer field plus 1 may specify the section with the highest value of SLT_section_number of the SLT of which this section is part. For example, a value of ‘0001’ in total_SLT_section_numbers would indicate that there will be three sections in total, labeled as ‘0000’, ‘0001’, and ‘0010’ in SLT section number. The value of ‘1111’ indicates that the highest value of SLT section number of the SLT of which this section is part is unknown.

Alternatively in another embodiment the value of ‘1111’ is reserved.

Signaling the total SLT section numbers facilitates that the signaling will always signal at least one section number the code space of numbers can be optimally used. For example signaling the total SLT section numbers minus 1 instead of total SLT section numbers in this manner allows keeping one of the code values (e.g. value ‘1111’) reserved such that it could be used in the future to provide extensibility. In other case the value ‘1111’ could be provided with a special meaning. For example if the total number of sections are not known before hand then the value ‘1111’ could indicate that the total number of SLT sections is unknown. The signaling in this manner does not waste one of the code values and allows it to be kept reserved or assigned a special meaning.

num_services—An 8-bit unsigned integer that may indicate the number of services to be described in this service list table section( ).

service_id—A 16-bit unsigned integer number that may uniquely identify this service within the scope of this broadcast area.

service_info_seq_number—This 3-bit unsigned integer field may indicate the sequence number of the service information with service ID equal to the service_id field value in this for loop. service_info_seq_number may start at 0 for each service and may be incremented by 1 every time any service information for a service identified by service_id is changed. If the service information for a particular service is not changed compared to the previous service information with a particular value of service_info_seq_number then service_info_seq_number may not be incremented. The service_info_seq_number field wraps back to 0 after reaching the maximum value.

In another embodiment the service_info_seq_number_value may be incremented for a service identified by a service_id, if and only if any service information for that service changes.

This field allows a receiver to know when a service information is changed. A receiver which caches SLT may use the service information for a service with a service_id with the highest value service_info_seq_number in its cache.

In another embodiment 4 bits or some other number of bits may be used to represent service_info_seq_number.

The service list table often is repeated many times during the transmission for allowing easy channel scanning for receivers which may join any time. If the service infor sequence number is not transmitted then everytime a receiver receives a new service list table, it needs to scan it, parse each entry in it, decode each entry and compare the information in it for each service against the previously parsed information to see if something has changed. Instead with the signaling of service_info_seq_number, the receiver can simply keep the previously parsed and decoded entries with information for each service and associate sequence number (service_info_seq_number) with that information. Next time when service list table is received then for a particular service if the sequence number (service_info_seq_number) is the same then the receiver can skip the elements for this service and jump to the elements for the next service. If it can not skip the elements it may parse them but does not need to decode them as the sequence number indicates that the information is same as the previous information for the service that the receiver already knows. In this manner a more efficient and lower complexity parsing and decoding could be done by the receiver using the signaled seequence nuber for the service information (service_info_seq_number).

major_channel_number—A 10-bit unsigned integer number in the range 1 to 999 that may represent the “major” channel number of the service being defined in this iteration of the “for” loop. Each service may be associated with a major and a minor channel number. The major channel number, along with the minor channel number, act as the user's reference number for the virtual channel. The value of major_channel_number may be set such that in no case is a major_channel_number/minor_channel_number pair duplicated within the SLT

minor_channel_number—A 10-bit unsigned integer number in the range 1 to 999 that may represent the “minor” or “sub”-channel number of the service. This field, together with major_channel_number, provides a two-part channel number of the service, where minor_channel_number represents the second or right-hand part of the number.

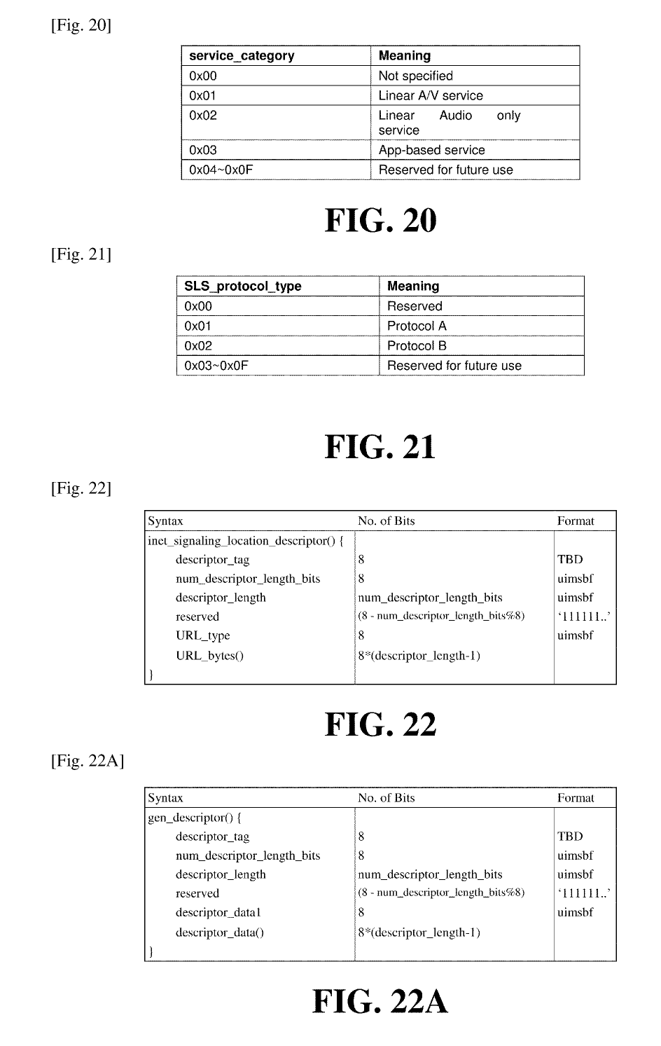

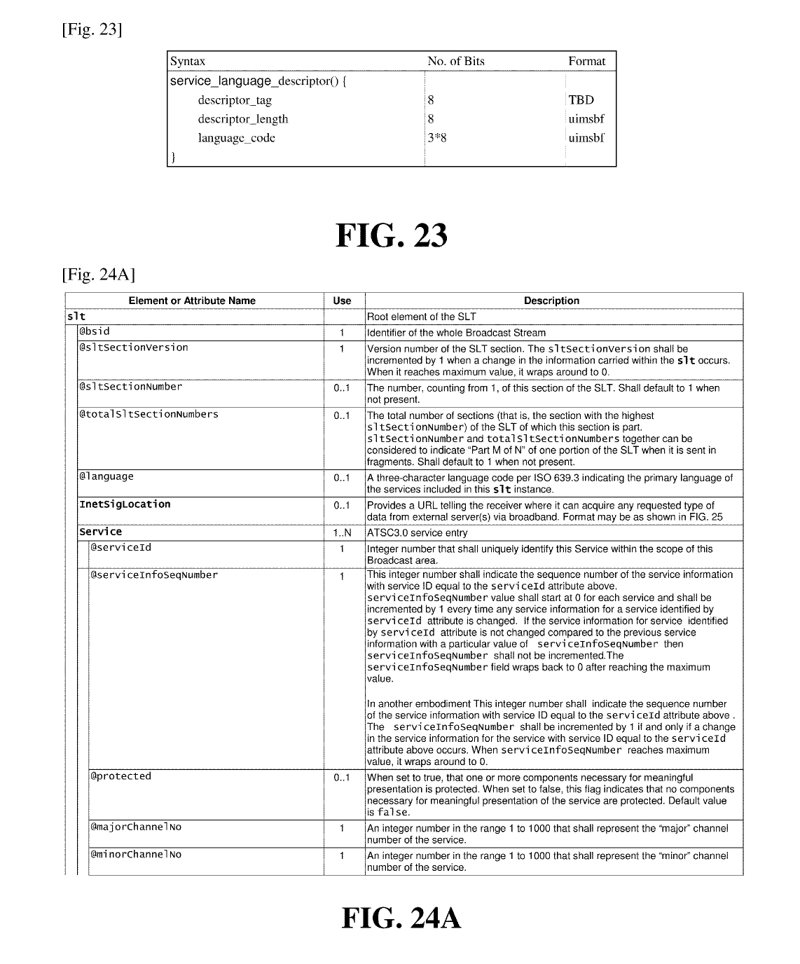

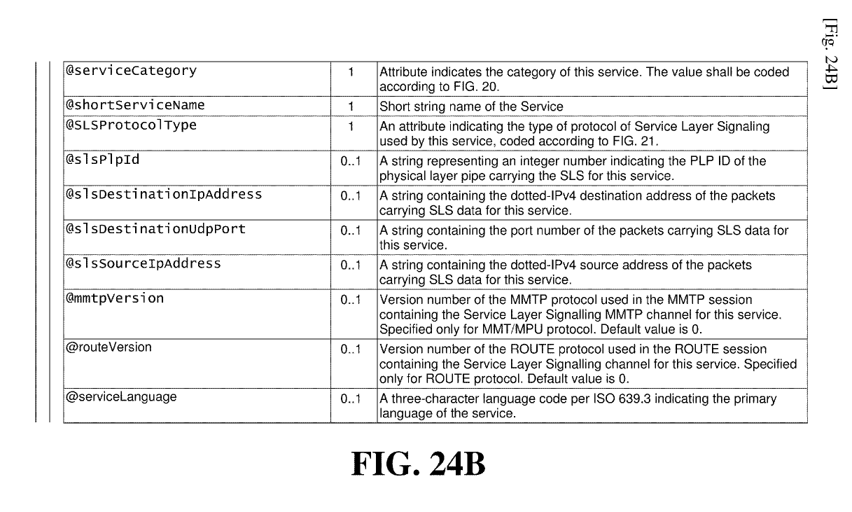

service_category—This 4-bit unsigned integer field may indicate the category of this service, coded as shown in FIG. 20.

broadcast_components_present—A 1-bit Boolean flag that may indicate, when set to ‘1’, that the fields beginning at SLS_PLP_ID and ending after the fields associated with the SLS_protocol_type (as shown in the syntax in FIG. 19) are present. A value of ‘0’ may indicate that these fields are not present in this instance of the service_list_table_section( ).

Common_protocol_info—includes one or more elements which are common for all the protocols. For example this may include a service name, service genre, service address elements etc.

SLS_source_IP_address_present—A 1-bit Boolean flag that may indicate, when set to ‘1’, that the SLS_source_IP_address_field is present. A value of ‘0’, may indicate that no_SLS_source_IP_address field is present in this instance of the service_list_table_section( ).

SLS_protocol_type—A 4-bit unsigned integer that may indicate the type of protocol of Service Layer Signaling channel on top of UDP/IP, coded according to FIG. 21. Receivers are expected to discard any received service_list_table_section( ) for which the SLS_protocol_type is unknown or unsupported.

SLS_PLP_ID—This 8-bit unsigned integer field may represent the identifier of the Physical Layer Pipe that contains the Service Layer Signaling data for this service. It will typically be a more robust pipe than other pipes used by the service.

SLS_destination_IP_address—This field may contain the 32-bit IPv4 destination IP address of the Service Layer Signaling channel for this service.

SLS_destination_UDP_port—This 16-bit unsigned integer field may represent the destination UDP port number of the Service Layer Signaling channel for this service.

SLS_source_IP_address—When present, this field may contain the source IPv4 address associated with the Service Layer Signaling for this service.

SLS_TSI—This 16-bit unsigned integer field may represent the Transport Session

Identifier (TSI) of the Service Layer Signaling LCT channel for this PROTOCOL A-delivered service.

PROTOCOL A_version—This 8-bit unsigned integer field may indicate the version of the PROTOCOL A protocol that will be used to provide SLS for this service. The most significant 4 bits of PROTOCOL A_version may indicate the major version number of the PROTOCOL A protocol, and the least significant 4 bits may indicate the minor version number of the PROTOCOL A protocol. For the PROTOCOL A protocol defined in this standard, the major version number may be 0x1, and the minor version number may be 0x0. There is an expectation that receivers will not offer to the user PROTOCOL A services labeled with a value of major_protocol_version higher than that for which the receiver was built to support. Receivers are not expected to use minor_protocol_version as a basis for not offering a given service to the user. Receivers are expected to use minor_protocol_version to determine whether the transmission includes data elements defined in later versions of the Standard Protocol_B_version—This 2-bit unsigned integer field may indicate the version of the Protocol_Bprotocol that will be used to provide SLS for this service. For the current specification, only the value ‘00’ is defined.

num_proto_ext_length_bits—This 8-bit unsigned integer may specify the length in bits of the proto_ext_length field.

In another embodiment this fixed length element could instead use 4 bits or 6 bits or 16 bits.

This element provides a level of indirection while allowing flexibility of signaling length in bits for the next field (proto_ext_legnth) of upto 2̂255 (2 raised to 255 or 2 to the power of 255).

proto_ext_length—This unsigned integer of length num_proto_ext_length_bits bits may specify the length (in bytes) of data immediately following the reserved field (of length (8-num_proto_ext_length_bits % 8) bits) following this field.

reserved—This field of length (8-num_proto_ext_length_bits % 8) bits may have each bit equal to 1 for this version of this specification.

Where a % b indicates a modulus operator resulting in value equal to remainder of a divided by b.

Reserved/proto_ext_data( )—protocol extension data bytes of length 8*proto_ext_length bits may have any value.

This version of this specification should ignore these bits.

It should be noted that this field may be called “reserved” or it may be called proto_ext_data( ).

If the above syntax elements: num_proto_ext_length_bits, proto_ext_length, reserved and Reserved/proto_ext_data( ) are not signaled then a receiver will not be able to parse past the data in the else section of the loop when a future version of the protocol is used and required elements for such a future protocol are signaled.

Signaling the two elements num_proto_ext_length_bits, proto_ext_length, instead of a single element say length of protocol extension section achieves both extensibility without wasting bits. For example if only 8 bits are allocated for a hypothetical element which provides length of protocol extension section, then the maximum amount of data that can be transmitted in proto_ext_data( ) is only 255 bytes. This may be insufficient amount of data for a future protocol depending upon its needs. If instead say 16 bits are allocated for a hypothetical element which provides the length of protocol extension section, then the maximum amount of data that can be transmitted in proto_ext_data( ) is 65536 bytes which may be sufficient for most protocols but results in wasting 16 bits every time. Instead this syntax allows signaling a variable number of bits as signaled by num_proto_ext_length_bits element, which is fixed in length (e.g. 8 bits). This allows signaling the length in bits of the next field proto_ext_length. Thus any bit length up to 2̂255 (2 raised to 255 or 2 to the power of 255) is allowed for the field proto_ext_length, which provides achieves both extensibility and compression efficiency.

num_service_level_descriptors—Zero or more descriptors providing additional information for the service may be included. This 4-bit unsigned integer field may specify the number of service level descriptors for this service. A value of zero may indicate that no descriptors are present.

service_level_descriptor( )—The format of each descriptor may be an 8-bit type field, followed by an 8-bit length field, followed by a number of bytes indicated in the length field.

num_SLT_level_descriptors—Zero or more descriptors providing additional information for the SLT may be included. This 4-bit field may specify the number of SLT-level descriptors included in this this service list table section( ). A value of zero may indicate that no descriptors are present.

SLT_level_descriptor( )—The format of each descriptor may be an 8-bit type field, followed by an 8-bit length field, followed by a number of bytes indicated in the length field.

SLT_ext_present—This 1-bit Boolean flag may indicate, when set to ‘1’, that the fields num_ext_length_bits, SLT ext length, reserved, reserved/SLT_ext_data( )are present in this instance of the service_list_table_section( ). A value of ‘0’ may indicate that the fields num_ext_length_bits, SLT_ext_length, reserved, reserved/SLT_ext_data( ) are not present in this instance of the service list table section( ).

SLT_ext_present may be equal to 0 in bitstreams conforming to this version of this Specification. The value of 1 for SLT_ext_present is reserved for future use by ATSC. Receivers may ignore all data till the end of this service_list_table_section( ) that follows the value 1 for SLT_ext_flag.

SLT_ex_present provides a presence indicator which allows extensbility of the service list table for future.

num_ext_length_bits—This 8-bit unsigned integer may specify the length in bits of the SLT_ext_length field.

In another embodiment this fixed length element could instead use 4 bits or 6 bits or 16 bits. This element provides a level of indirection while allowing flexibility of signaling length in bits for the next field (slt_ext_legnth) of upto 2̂255 (2 raised to 255 or 2 to the power of 255).

SLT_ext_length—This unsigned integer of length num_ext_length_bits bits may specify the length (in bytes) of data immediately following the reserved field (of length (8-num_ext_length_bits % 8) bits) following this field up to the end of this service_list_table_section.

reserved—This field of length (8-num_ext_length_bits % 8) bits may have each bit equal to 1 for this version of this specification.

Where a % b indicates a modulus operator resulting in value equal to remainder of a divided by b.

Reserved/slt_ext_data( )—SLT extension data bytes of length 8*SLT_ext_length bits may have any value. This version of this specification should ignore these bits.

If the above syntax elements: num_{—} ext_length_bits, slt_ext_length, reserved and Reserved/slt_ext_data( )are not signaled then in future the service list table may not be easily extended for signaling additional elements which may be needed in future.

Signaling the two elements num_ext_length_bits, slt_ext_length, instead of a single element say length of service list table extension data achieves both extensibility and not wasting bits. For example if only 8 bits are allocated for a hypothetical element which provides length of service list table extension data, then the maximum amount of data that can be transmitted in slt_ext_data( ) is only 255 bytes. This may be insufficient amount of data for a future revision of the service list table depending upon its needs. If instead say 16 bits are allocated for a hypothetical element which provides length of service list table extension data, then the maximum amount of data that can be transmitted in slt_ext_data( ) is 65536 bytes which may be sufficient for most extensions but results in wasting 16 bits every time. Instead the design here allows signaling a variable number of bits as signaled by num_ext_length_bits element, which is fixed in length (e.g. 8 bits). This allows signaling the length in bits of the next field slt_ext_length. Thus any bit length up to 2̂255 (2 raised to 255 or 2 to the power of 255) is allowed for the field slt_ext_length, which provides both extensibility and compression efficiency.

It should be noted that this field may be called “reserved” or it may be called slt_ext_data( ).

Service list table descriptors are described below.

Zero or more descriptors providing additional information about a given service or the set of services delivered in any instance of an SLT section may be included in the service list table.

FIG. 22 specifies the bit stream syntax of the inet signaling location descriptor( ). FIG. 22A shows a variant syntax for a generic descriptor (gen_descriptor). FIG. 23 specifies the bit stream syntax of the service_language_descriptor( ).

Internet Signaling Location Descriptor is described below.
The inet_signaling_location_descriptor( )contains a URL telling the receiver where it can acquire any requested type of data from external server(s) via broadband. FIG. 22 shows the structure of the descriptor.
descriptor_tag—This 8-bit unsigned integer may have the value TBD, identifying this descriptor as being the inet_signaling_location_descriptor( ).
num_descriptor_length_bits—This 8-bit unsigned integer may specify the length in bits of the descriptor_length field.
descriptor_length—This unsigned integer of length num_descriptor_length_bits bits may specify the length (in bytes) immediately following the reserved field (of length (8-num_descriptor_length_bits % 8) bits) following this field up to the end of this descriptor.
reserved—This field of length (8-num_descriptor_length_bits % 8) bits may have each bit equal to 1 for this version of this specification.
Where a % b indicates a modulus operator resulting in value equal to remainder of a divided by b.
URL_type—This 8-bit unsigned integer field may indicate the type of URL.
URL_bytes( )—Uniform Resource Location (URL), each character of which may be encoded per UTF-8. In the case of a URL to a Signaling server, this base URL can be extended by one of the query terms.
When resources are available over the broadband network environment, the inet_signaling_location_descriptor( ) can provide the URL of those resources.

Service Language Descriptor is described below.
The service_language_descriptor( ) contains a 3-byte ISO-639-3 language code to associate a primary language with a given service or groups of services. FIG. 23 shows the structure of the Service Language Descriptor.
descriptor_tag—This 8-bit unsigned integer may have the value TBD, identifying this descriptor as being the service_language_descriptor( ).
descriptor_length—This 8-bit unsigned integer may specify the length (in bytes) immediately following this field up to the end of this descriptor.

language_code—The primary language of the service may be encoded as a 3-character language code per ISO 639-3. Each character may be coded into 8 bits according to ISO 8859-1 (ISO Latin-1) and inserted in order into the 24-bit field.
ISO: ISO 639-3:2007, “Codes for the representation of names of languages—Part 3: Alpha-3 code for comprehensive coverage of languages,” available at http://www.iso.org/iso/catalogue_detail?csnumber=39534 is incorporated here by reference.

FIG. 24A and FIG. 24B show an XML format for the service list table. This is analogous to the bitstream syntax for the service list table shown in FIG. 19.

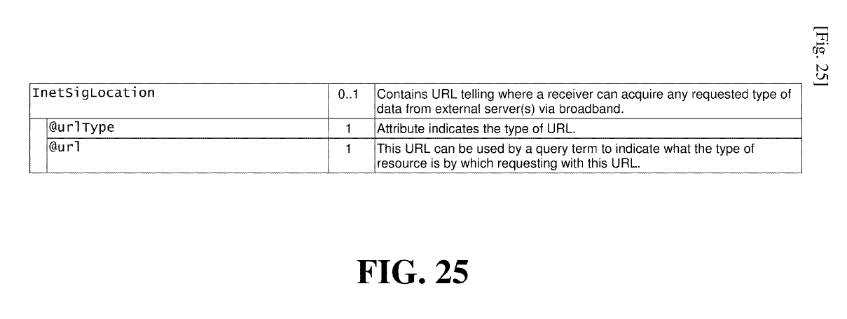

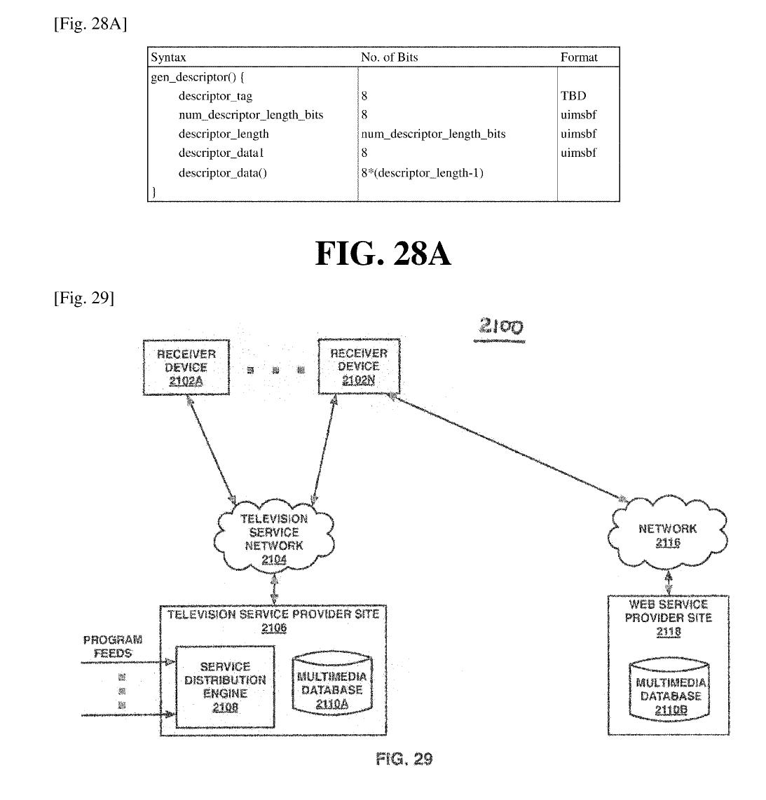

FIG. 25 shows an XML format for the Internet signaling location descriptor. This is analogous to the bitstream syntax for the service list table shown in FIG. 22 and FIG. 28.

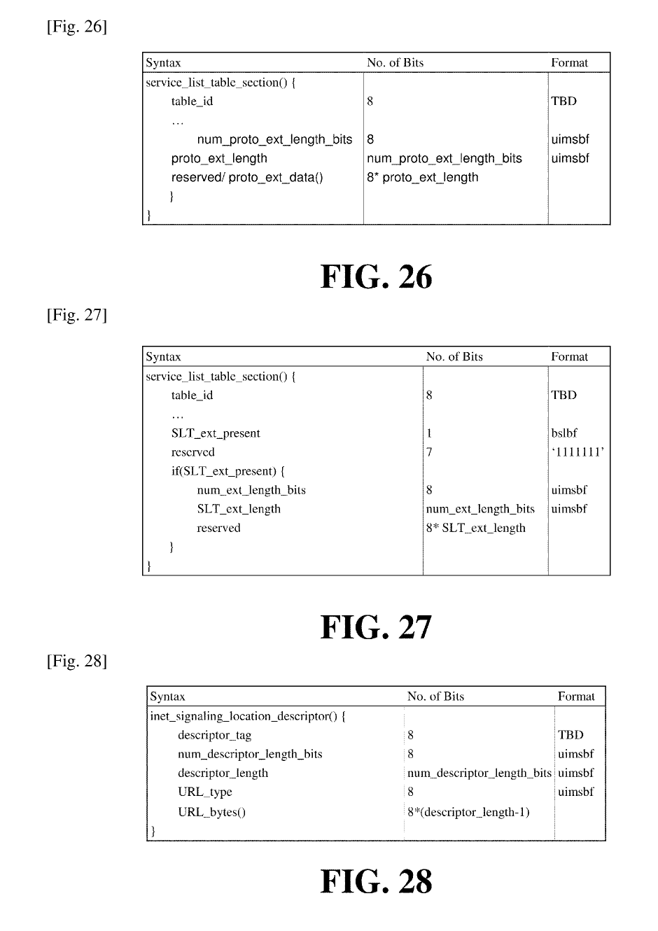

In additional variants, the reserved bits may be omitted from descriptor and the service signaling table extension. These are as shown below in FIG. 26 in relation to protocol extension data (proto_ext_data), in FIG. 27 in relation to service list table extension data (slt_ext data), in FIG. 28 with respect to data within a descriptor (e.g. Internet signaling location descriptor—inet_signaling_location_descriptor) and in FIG. 28A with respect to a generic descriptor (gen_descriptor).

It should be noted that the data elements defined in FIG. 22 and FIG. 28 including the element num_descriptor_lengh_bits and reserved bits following that element may be included in any other binary or another format descriptor.

In additional variants instead of using x number of bits to represent a syntax element y number of bits may be used to represent that syntax element where x is not equal to y. For example instead of 3 bits for a syntax element, 4 bits or 8 bits or 54 bits may be used.

Additional technologies related to application and event signaling are now described.

FIG. 29 is a block diagram illustrating an example of a system that may implement one or more techniques described in this disclosure. System 2100 may be configured to provide content information to a receiver device in accordance with the techniques described herein. In the example illustrated in FIG. 29, system 2100 includes one or more receiver devices 2102A-2102N, television service network 2104, television service provider site 2106, network 2116, and web service provider site 2118. System 2100 may include software modules. Software modules may be stored in a memory and executed by a processor. System 2100 may include one or more processors and a plurality of internal and/or external memory devices. Examples of memory devices include file servers, FTP servers, network attached storage (NAS) devices, local disk drives, or any other type of device or storage medium capable of storing data. Storage media may include Blu-ray discs, DVDs, CD-ROMs, magnetic disks, flash memory, or any other suitable digital storage media. When the techniques described herein are implemented partially in software, a device may store instructions for the software in a suitable, non-transitory computer-readable medium and execute the instructions in hardware using one or more processors.

System 2100 represents an example of a system that may be configured to allow digital media content, such as, for example, television programming, to be distributed to and accessed by a plurality of computing devices, such as receiver devices 2102A-2102N. In the example illustrated in FIG. 29, receiver devices 2102A-2102N may include any device configured to receive a transport stream from television service provider site 2106. For example, receiver devices 2102A-2102N may be equipped for wired and/or wireless communications and may include televisions, including so-called smart televisions, set top boxes, and digital video recorders. Further, receiver devices 2102A-2102N may include desktop, laptop, or tablet computers, gaming consoles, mobile devices, including, for example, “smart” phones, cellular telephones, and personal gaming devices configured to receive a transport stream from television provider site 2106. It should be noted that although example system 2100 is illustrated as having distinct sites, such an illustration is for descriptive purposes and does not limit system 2100 to a particular physical architecture. Functions of system 2100 and sites included therein may be realized using any combination of hardware, firmware and/or software implementations.

Television service network 2104 is an example of a network configured to enable television services to be provided. For example, television service network 2104 may include public over-the-air television networks, public or subscription-based satellite television service provider networks, and public or subscription-based cable television provider networks and/or over the top or Internet service providers. It should be noted that although in some examples television service network 2104 may primarily be used to enable television services to be provided, television service network 2104 may also enable other types of data and services to be provided according to any combination of the telecommunication protocols described herein. Television service network 2104 may comprise any combination of wireless and/or wired communication media. Television service network 2104 may include coaxial cables, fiber optic cables, twisted pair cables, wireless transmitters and receivers, routers, switches, repeaters, base stations, or any other equipment that may be useful to facilitate communications between various devices and sites. Television service network 2104 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, Hybrid Broadcast and Broadband (HbbTV) standard, W3C standards, and Universal Plug and Play (UPnP) standards.

Referring again to FIG. 29, television service provider site 2106 may be configured to distribute television service via television service network 2104. For example, television service provider site 2106 may include a public broadcast station, a cable television provider, or a satellite television provider. In some examples, television service provider site 2106 may include a broadcast service provider or broadcaster. In the example illustrated in FIG. 29, television service provider site 2106 includes service distribution engine 2108 and multimedia database 2110A. Service distribution engine 2108 may be configured to receive a plurality of program feeds and distribute the feeds to receiver devices 2102A-2102N through television service network 2104. For example, service distribution engine 2108 may include a broadcast station configured to transmit television broadcasts according to one or more of the transmission standards described above (e.g., an ATSC standard). Multimedia database 2110A may include storage devices configured to store multimedia content and/or content information, including content information associated with program feeds. In some examples, television service provider site 2106 may be configured to access stored multimedia content and distribute multimedia content to one or more of receiver devices 2102A-2102N through television service network 2104. For example, multimedia content (e.g., music, movies, and TV shows) stored in multimedia database 2110A may be provided to a user via television service network 2104 on an on demand basis.

Network 2116 may comprise any combination of wireless and/or wired communication media. Network 2116 may include coaxial cables, fiber optic cables, twisted pair cables, Ethernet cables, wireless transmitters and receivers, routers, switches, repeaters, base stations, or any other equipment that may be useful to facilitate communications between various devices and sites. Network 2116 may be distinguished based on levels of access. For example, Network 2116 may enable access to the World Wide Web. Or Network 2116 may enable a user to access a subset of devices, e.g., computing devices located within a user's home. Thus the network may be wide area network or local area network or a combination of it and may also be generally referred to as Internet or broadband network. In some instances, local area network may be referred to as a personal network or a home network.

Network 2116 may be packet based networks and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and IEEE standards, such as, for example, one or more of the IEEE 802 standards (e.g., Wi-Fi).

Referring again to FIG. 29, web service provider site 2118 may be configured to provide hypertext based content or applications or other metadata associated with applications or audio/video/closed caption/media content, and the like, to one or more of receiver devices 2102A-2102N through network 2116. Web service provider site 2118 may include one or more web servers. Hypertext content may be defined according to programming languages, such as, for example, Hypertext Markup Language (HTML), Dynamic HTML, Extensible Markup Language (XML), and data formats such as JavaScript Object Notation (JSON). An example of a webpage content distribution site includes the United States Patent and Trademark Office website. Further, web service provider site 2118 may be configured to provide content information, including content information associated with program feeds, to receiver devices 2102A-2102N. Hypertext content and content information may be utilized for applications. It should be noted that hypertext based content and the like may include audio and video content. For example, in the example illustrated in FIG. 29, web service provider site 2118 may be configured to access a multimedia database 2110B and distribute multimedia content and content information to one or more of receiver devices 2102A-2102N through network 2116. In one example, web service provider site 2118 may be configured to provide multimedia content using the Internet protocol suite. For example, web service provider site 2118 may be configured to provide multimedia content to a receiver device according to Real Time Streaming Protocol (RTSP). It should be noted that the techniques described herein may be applicable in the case where a receiver device receives multimedia content and content information associated therewith from a web service provider site.

Referring to FIG. 29 the web service provider site may provide support for application and events. An application may be a collection of documents constituting a self-contained enhanced or interactive service. Documents of an application are, for example: HTML, XHTML, Java, JavaScript, CSS, XML, multimedia files, etc. An interactive application may be capable of carrying out tasks based on input from a broadcaster or viewer. An event may be communication of some information from a first entity to a second entity in an asynchronous manner. In some cases an event may be communicated from one entity to another entity without an explicit request from the first entity. An event reception may (though not always) trigger an action.

A model to execute interactive adjunct data services may include, for example, a direct execution model and a triggered declarative object (TDO) model. In the direct execution model, a declarative object (DO) can be automatically launched as soon as the channel is selected by user on a receiver device 2200, e.g. selecting a channel on a television. The channel may be virtual channel. A virtual channel is said to be “selected” on a receiving device when it has been selected for presentation to a viewer. This is analogous to being “tuned to” an analog TV channel. A DO can communicate over the Internet with a server to get detailed instructions for providing interactive features—creating displays in specific locations on the screen, conducting polls, launching other specialized DOs, etc., all synchronized with the audio-video program. In one embodiment the backend server may be web service provider site 2118.

In the TDO model, signals can be delivered in the broadcast stream or via the

Internet in order to initiate TDO events, such as launching a TDO, terminating a TDO, or prompting some task by a TDO. These events can be initiated at specific times, typically synchronized with the audio-video program. When a TDO is launched, it can provide the interactive features it is programmed to provide.

The term Declarative Object (DO) can consist of a collection constituting an interactive application. An application as define previously may be a collection of documents constituting a self-contained enhanced or interactive service. Documents of an application are, for example: HTML, XHTML, Java, JavaScript, CSS, XML, multimedia files, etc. An interactive application may be capable of carrying out tasks based on input from a broadcaster or viewer.

The term “Triggered Declarative Object” (TDO) can be used to designate a Declarative Object that has been launched by a Trigger in a Triggered interactive adjunct data service, or a DO that has been launched by a Trigger, and so on iteratively.

A basic concept behind the TDO model is that the files that make up a TDO, and the data files to be used by a TDO to take some action, all need some amount of time to be delivered to a receiver, given their size. While the user experience of the interactive elements can be authored prior to the broadcast of the content, certain behaviors must be carefully timed to coincide with events in the program itself, for example the occurrence of a commercial advertising segment.

The TDO model separates the delivery of declarative objects and associated data, scripts, text and graphics from the signaling of the specific timing of the playout of interactive events.

The element that establishes the timing of interactive events is the Trigger.

The information about the TDOs used in a segment and the associated TDO events that are initiated by Triggers is provided by a data structure called the “TDO Parameters Table” (TPT).

A TPT may contain information about TDOs of segments and the Events targeted to them. TDO information may correspond to an application identifier (appID), an application type, application name(s), application version, location of files which are part of the application, information that defines application boundary, and/or information that defines application origin. Event information within a TPT may contain an event identifier (eventID), action to be applied when the event is activated, target device type for the application, and/or a data field related to the event. A data field related to event may contain an identifier (dataID), data to be used for the event. Additionally, a TPT may also contain information about trigger location, version, required receiver capabilities, how long the information within the TPT is valid, when a receiver may need to check and download a new TPT.

Actions control an application's lifecycle. Actions may indicate to which state an application may transition.

In an example, event(s) may correspond to application lifecycle control action(s).

In an example, application lifecycle control action(s) may correspond to event(s).

An Application Information Table (AIT) may provide information on for e.g. the required activation state of applications carried by it, application type, application profile, application priority, application version, application identifier (appID) etc. Data in the AIT may allow the broadcaster to request that the receiver change the activation state of an application. Note—An AIT may contain some data elements which are functionally equivalent to some data elements in TPT.

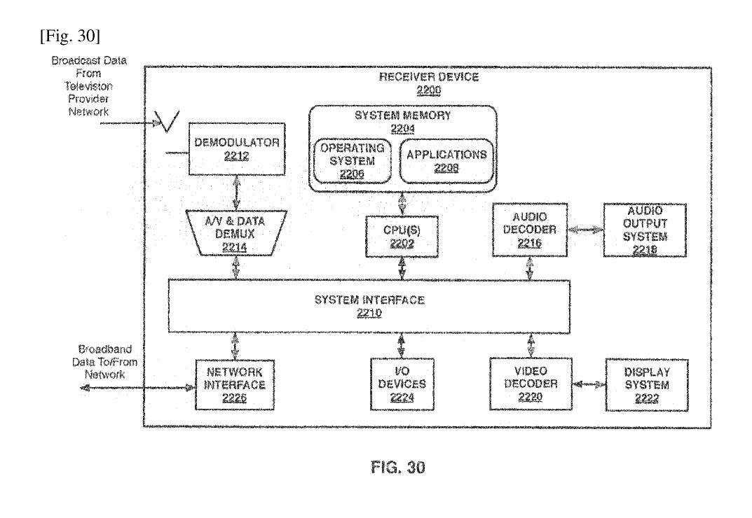

FIG. 30 is a block diagram illustrating an example of a receiver device that may implement one or more techniques of this disclosure. Receiver device 2200 is an example of a computing device that may be configured to receive data from a communications network and allow a user to access multimedia content. In the example illustrated in FIG. 30, receiver device 2200 is configured to receive data via a television network, such as, for example, television service network 2104 described above. Further, in the example illustrated in FIG. 30, receiver device 2200 is configured to send and receive data via a local area network and/or a wide area network. Receiver device 2200 may be configured to send data to and receive data from a receiver device via a local area network or directly. It should be noted that in other examples, receiver device 2200 may be configured to simply receive data through a television network 2106 and send data to and/or receive data from (directly or indirectly) a receiver device. The techniques described herein may be utilized by devices configured to communicate using any and all combinations of communications networks.

As illustrated in FIG. 30, receiver device 2200 includes central processing unit(s) 2202, system memory 2204, system interface 2210, demodulator 2212, A/V & data demux 2214, audio decoder 2216, audio output system 2218, video decoder 2220, display system 2222, I/O devices 2224, and network interface 2226. As illustrated in FIG. 30, system memory 2204 includes operating system 2206 and applications 2208. Each of central processing unit(s) 2202, system memory 2204, system interface 2210, demodulator 2212, A/V & data demux 2214, audio decoder 2216, audio output system 2218, video decoder 2220, display system 2222, I/O devices 2224, and network interface 2226 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although example receiver device 2200 is illustrated as having distinct functional blocks, such an illustration is for descriptive purposes and does not limit receiver device 2200 to a particular hardware architecture. Functions of receiver device 2200 may be realized using any combination of hardware, firmware and/or software implementations.

CPU(s) 2202 may be configured to implement functionality and/or process instructions for execution in receiver device 2200. CPU(s) 2202 may be capable of retrieving and processing instructions, code, and/or data structures for implementing one or more of the techniques described herein. Instructions may be stored on a computer readable medium, such as system memory 2204 and/or storage devices 2220. CPU(s) 2202 may include single and/or multi-core central processing units.

System memory 2204 may be described as a non-transitory or tangible computer-readable storage medium. In some examples, system memory 2204 may provide temporary and/or long-term storage. In some examples, system memory 2204 or portions thereof may be described as non-volatile memory and in other examples portions of system memory 2204 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories. System memory 2204 may be configured to store information that may be used by receiver device 2200 during operation. System memory 2204 may be used to store program instructions for execution by CPU(s) 2202 and may be used by programs running on receiver device 2200 to temporarily store information during program execution. Further, in the example where receiver device 2200 is included as part of a digital video recorder, system memory 2204 may be configured to store numerous video files.

Applications 2208 may include applications implemented within or executed by receiver device 2200 and may be implemented or contained within, operable by, executed by, and/or be operatively/communicatively coupled to components of receiver device 2200. Applications 2208 may include instructions that may cause CPU(s) 2202 of receiver device 2200 to perform particular functions. Applications 2208 may include algorithms which are expressed in computer programming statements, such as, for-loops, while-loops, if-statements, do-loops, etc. Applications 2208 may be developed using a specified programming language. Examples of programming languages include, Java™, Java™, C, C++, Objective C, Swift, Perl, Python, PhP, UNIX Shell, Visual Basic, and Visual Basic Script. In the example where receiver devices 2200 includes a smart television, applications may be developed by a television manufacturer or a broadcaster. As illustrated in FIG. 30, applications 2208 may execute in conjunction with operating system 2206. That is, operating system 2206 may be configured to facilitate the interaction of applications 2208 with CPUs(s) 2202, and other hardware components of receiver device 2200. Operating system 2206 may be an operating system designed to be installed on set-top boxes, digital video recorders, televisions, and the like. It should be noted that techniques described herein may be utilized by devices configured to operate using any and all combinations of software architectures. In one example, operating system 2206 and/or applications 2208 may be configured to establish a subscription with a receiver device and generate content information messages in accordance with the techniques described in detail below.

System interface 2210 may be configured to enable communications between components of computing device 2200. In one example, system interface 2210 comprises structures that enable data to be transferred from one peer device to another peer device or to a storage medium. For example, system interface 2210 may include a chipset supporting Accelerated Graphics Port (“AGP”) based protocols, Peripheral Component Interconnect (PCI) bus based protocols, such as, for example, the PCI Express™ (“PCIe”) bus specification, which is maintained by the Peripheral Component Interconnect Special Interest Group, or any other form of structure that may be used to interconnect peer devices (e.g., proprietary bus protocols).

As described above, receiver device 2200 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 30, demodulator 2212 and A/V & data demux 2214 may be configured to extract video, audio, and data from a transport stream. A transport stream may be defined according to, for example, DVB standards, ATSC standards, ISDB standards, DTMB standards, DMB standards, and DOCSIS standards. It should be noted that although demodulator 2212 and A/V & data demux 2214 are illustrated as distinct functional blocks, the functions performed by demodulator 2212 and A/V & data demux 2214 may be highly integrated and realized using any combination of hardware, firmware and/or software implementations. Further, it should be noted that for the sake of brevity a complete description of digital RF (radio frequency) communications (e.g., analog tuning details, error correction schemes, etc.) is not provided herein. The techniques described herein are generally applicable to digital RF communications techniques used for transmitting digital media content and associated content information.

In one example, demodulator 2212 may be configured to receive signals from an over-the-air signal and/or a coaxial cable and perform demodulation. Data may be modulated according a modulation scheme, for example, quadrature amplitude modulation (QAM), vestigial sideband modulation (VSB), or orthogonal frequency division modulation (OFDM). The result of demodulation may be a transport stream. A transport stream may be defined according to a telecommunications standard, including those described above. An Internet Protocol (IP) based transport stream may include a single media stream or a plurality of media streams, where a media stream includes video, audio and/or data streams. Some streams may be formatted according to ISO base media file formats (ISOBMFF). A Motion Picture Experts Group (MPEG) based transport stream may include a single program stream or a plurality of program streams, where a program stream includes video, audio and/or data elementary streams. In one example, a media stream or a program stream may correspond to a television program (e.g., a TV “channel”) or a multimedia stream (e.g., an on demand unicast). A/V & data demux 2214 may be configured to receive transport streams and/or program streams and extract video packets, audio packets, and data packets. That is, AV demux 2214 may apply demultiplexing techniques to separate video elementary streams, audio elementary streams, and data elementary streams for further processing by receiver device 2200.

Referring again to FIG. 30, packets may be processed by CPU(s) 2202, audio decoder 2216, and video decoder 2220. Audio decoder 2216 may be configured to receive and process audio packets. For example, audio decoder 2216 may include a combination of hardware and software configured to implement aspects of an audio codec. That is, audio decoder 2216 may be configured to receive audio packets and provide audio data to audio output system 2218 for rendering. Audio data may be coded using multi-channel formats such as those developed by Dolby and Digital Theater Systems. Audio data may be coded using an audio compression format. Examples of audio compression formats include MPEG formats, AAC formats, DTS-HD formats, and AC-3 formats. Audio system 2218 may be configured to render audio data. For example, audio system 2218 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 2220 may be configured to receive and process video packets. For example, video decoder 2220 may include a combination of hardware and software used to implement aspects of a video codec. In one example, video decoder 2220 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 AVC), and High-Efficiency Video Coding (HEVC). Display system 2222 may be configured to retrieve and process video data for display. For example, display system 2222 may receive pixel data from video decoder 2222 and output data for visual presentation. Further, display system 2222 may be configured to output graphics in conjunction with video data, e.g., graphical user interfaces. Display system may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O devices 2224 may be configured to receive input and provide output during operation of receiver device 2200. That is, I/O device 2224 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 2224 may be operatively coupled to computing device 2200 using a standardized communication protocol, such as for example, Universal Serial Bus protocol (USB), Bluetooth, ZigBee or a proprietary communications protocol, such as, for example, a proprietary infrared communications protocol.

Network interface 2226 may be configured to enable receiver device 2200 to send and receive data via a local area network and/or a wide area network. Further, network interface may be configured to enable receiver device 2200 to communicate with a receiver device. Network interface 2226 may include a network interface card, such as an Ethernet card, an optical transceiver, a radio frequency transceiver, or any other type of device configured to send and receive information. Network interface 2226 may be configured to perform physical signaling, addressing, and channel access control according to the physical and Media Access Control (MAC) layers utilized in a network.

As described above, A/V & data demux 2214 may be configured to extract data packets from a transport stream. Data packets may include content information. In another example, network interface 2226 and in turn system interface 2210 may extract the data packets. In this example the data packets may originate from a network, such as, Network 2116. As used herein, the term content information may refer generally to any information associated with services received via a network. Further, the term content information may refer more specifically to information associated with specific multimedia content. Data structures for content information may be defined according to a telecommunications standard. For example, ATSC standards describe Program and System Information Protocol (PSIP) tables which include content information. Types of PSIP tables include Event Information Tables (EIT), Extended Text Tables (ETT) and Data Event Tables (DET). In ATSC standards, DETs and EITs may provide event descriptions, start times, and durations. In ATSC standards, ETTs may include text describing virtual channels and events. Further, in a similar manner to ATSC, DVB standards include Service Description Tables, describing services in a network and providing the service provider name, and EITs including event names descriptions, start times, and durations. Receiver device 2200 may be configured to use these tables to display content information to a user (e.g., present an EPG).

In addition to or as an alternative to extracting tables from a transport stream to retrieve content information, as described above, receiver device 2200 may be configured to retrieve content information using alternative techniques. For example, ATSC 2.0 defines Non-Real-Time Content (NRTC) delivery techniques. NRTC techniques may enable a receiver device to receive content information via a file delivery protocol (e.g., File Delivery over Unidirectional Transport (FLUTE) and/or via the Internet (e.g., using HTTP). Content information transmitted to a receiver device according to NRTC may be formatted according to several data formats. One example format includes the data format defined in Open Mobile Alliance (OMA) BCAST Service Guide Version 1.0.1. In a similar manner, DVB standards define Electronic Service Guide (ESG) techniques which may be used for transmitting content information. A service guide may provide information about current and future service and/or content. Receiver device 2200 may be configured to receive content information according to NRTC techniques and/or ESG techniques. That is, receiver device 2200 may be configured to receive a service guide. In should be noted that the techniques described herein may be generally applicable regardless of how a receiver device receives content information. As described above, receiver device 200 may be configured to send data to and receive data from a receiver device via a local area network or directly.

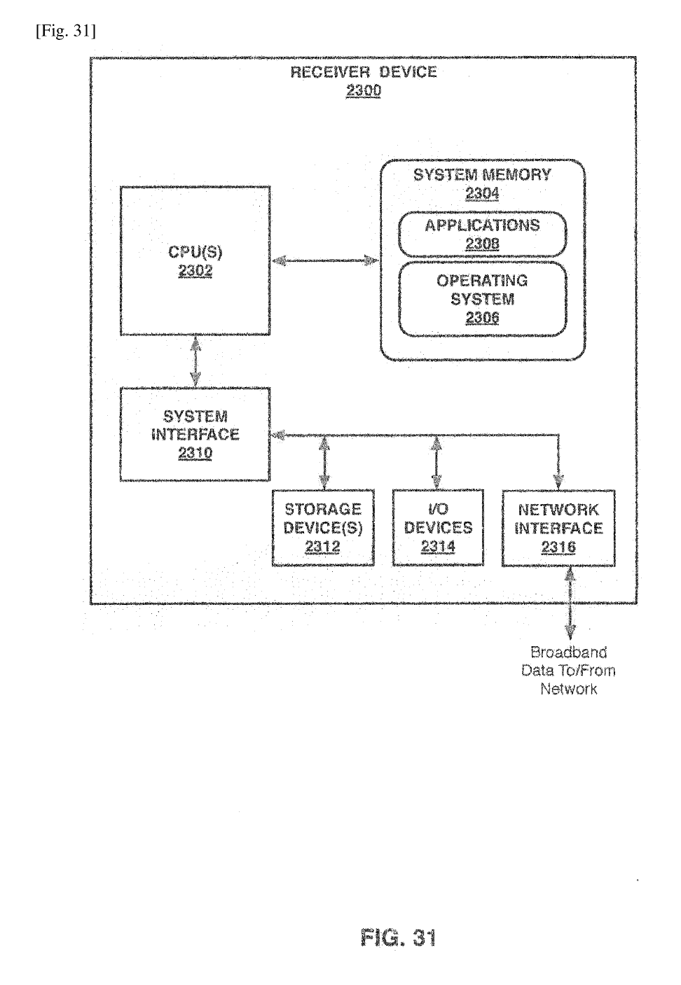

FIG. 31 is a block diagram illustrating an example of a receiver device that may implement one or more techniques of this disclosure. Receiver device 2300 may include one or more processors and a plurality of internal and/or external storage devices. Receiver device 2300 is an example a device configured communicate with a receiver device. For example, receiver device 2300 may be configured to receive content information from a receiver device. Receiver device 2300 may include one or more applications running thereon that may utilize information included in a content information communication message. Receiver device 2300 may be equipped for wired and/or wireless communications and may include devices, such as, for example, desktop or laptop computers, mobile devices, smartphones, cellular telephones, personal data assistants (PDA), tablet devices, and personal gaming devices.

As illustrated in FIG. 31, receiver device 2300 includes central processor unit(s) 2302, system memory 2304, system interface 2310, storage device(s) 2312, I/O device(s) 2314, and network interface 2316. As illustrated in FIG. 31, system memory 2304 includes operating system 2306 and applications 2308. It should be noted that although example receiver device 2300 is illustrated as having distinct functional blocks, such an illustration is for descriptive purposes and does not limit receiver device 2300 to a particular hardware or software architecture. Functions of receiver device 2300 may be realized using any combination of hardware, firmware and/or software implementations. One of the difference between receiver of FIG. 30 and FIG. 31 is that the FIG. 31 receiver may primarily get all its data from the broadband network.

Each of central processor unit(s) 2302, system memory 2304, and system interface 2310, may be similar to central processor unit(s) 2202, system memory 2204, and system interface 2210 described above. Storage device(s) 2312 represent memory of receiver device 2300 that may be configured to store larger amounts of data than system memory 2304. For example, storage device(s) 2312 may be configured to store a user's multimedia collection. Similar to system memory 2304, storage device(s) 2312 may also include one or more non-transitory or tangible computer-readable storage media. Storage device(s) 2312 may be internal or external memory and in some examples may include non-volatile storage elements. Storage device(s) 2312 may include memory cards (e.g., a Secure Digital (SD) memory card, including Standard-Capacity (SDSC), High-Capacity (SDHC), and eXtended-Capacity (SDXC) formats), external hard disk drives, and/or an external solid state drive.

I/O device(s) 2314 may be configured to receive input and provide output for receiver device 2300. Input may be generated from an input device, such as, for example, touch-sensitive screen, track pad, track point, mouse, a keyboard, a microphone, video camera, or any other type of device configured to receive input. Output may be provided to output devices, such as, for example, speakers or a display device. In some examples, I/O device(s) 2314 may be external to receiver device 2300 and may be operatively coupled to receiver device 2300 using a standardized communication protocol, such as for example, Universal Serial Bus (USB) protocol.

Network interface 2316 may be configured to enable receiver device 2300 to communicate with external computing devices, such as receiver device 2200 and other devices or servers. Further, in the example where receiver device 2300 includes a smartphone, network interface 2316 may be configured to enable receiver device 2300 to communicate with a cellular network. Network interface 2316 may include a network interface card, such as an Ethernet card, an optical transceiver, a radio frequency transceiver, or any other type of device that can send and receive information. Network interface 2316 may be configured to operate according to one or more communication protocols such as, for example, a Global System Mobile Communications (GSM) standard, a code division multiple access (CDMA) standard, a 3rd Generation Partnership Project (3GPP) standard, an Internet Protocol (IP) standard, a Wireless Application Protocol (WAP) standard, Bluetooth, ZigBee, and/or an IEEE standard, such as, one or more of the 802.11 standards, as well as various combinations thereof.

As illustrated in FIG. 31, system memory 2304 includes operating system 2306 and applications 2308 stored thereon. Operating system 2306 may be configured to facilitate the interaction of applications 2308 with central processing unit(s) 2302, and other hardware components of receiver device 2300. Operating system 2306 may be an operating system designed to be installed on laptops and desktops. For example, operating system 2306 may be a Windows® operating system, Linux, or Mac OS. Operating system 2306 may be an operating system designed to be installed smartphones, tablets, and/or gaming devices. For example, operating system 2306 may be an Android, iOS, WebOS, Windows Mobile®, or a Windows Phone® operating system. It should be noted that the techniques described herein are not limited to a particular operating system.

Applications 2306 may be any applications implemented within or executed by receiver device 2300 and may be implemented or contained within, operable by, executed by, and/or be operatively/communicatively coupled to components of receiver device 2300. Applications 2306 may include instructions that may cause central processing unit(s) 2302 of receiver device 2300 to perform particular functions. Applications 2306 may include algorithms which are expressed in computer programming statements, such as, for loops, while-loops, if-statements, do-loops, etc. Further, applications 2306 may include second screen applications.

ATSC A/105: 2014 : “ATSC Candidate Standard: Interactive Services Standard”, April 2014 is included herein by reference and is referred to in below as A105.

Hybrid Broadcast and Broadband TV (HbbTV) 2.0 standard available at https://www.hbbtv.org/pages/about_hbbtv/specification-2.php is included herein by reference and is referred to in below as HbbTV 2.0 or HbbTV.

Various application tables may communicate information regarding application. These may include application information related tables such as application information table (AIT) of HbbTV 2.0 or such. OR application tables from ATSC A105 or such standards. Other type of tables may include application signaling table (AST), activation message table (AMT), TDO Parameters Table (TPT) of ATSC A105, etc. These are just examples and any table or data structure that carries application information may be referred to as event table in this disclosure.

Various event tables may provide information about events. These may include tables such as TDO Parameters Table (TPT) of ATSC A105, event message table (EMT), event stream table (EST) etc. These are just examples and any table or data structure that carries event and/ or action information may be referred to as event table in this disclosure.

Although application tables and event tables are specified separately. In some case they may be combined. Also other type of tables may be define. For example a service list table may provide service level information. In some case a signaling table may be defined. The techniques described in this disclosure are applicable to any such tables which needs to be communicated dynamically from one entity to another entity. Dynamic communication refers to being able to send a new or updated version of table or information therein from one entity to another in real-time.

Method for dynamic notification of application tables, event tables and any other type of table is described next.

Various application information related tables and event related tables including dynamic events could be delivered by broadband in addition to broadcast. Since new application information and/ or event information may need to be communicated dynamically at any time, use of notification is supported for broadband delivery of application tables and event tables in addition to polling.

Following types of dynamic notification of application and event tables is supported over broadband.

Notification about availability of an updated application/ event table for service;

Notification about availability of an updated application/ event table for service along with inclusion of application/ event table data in the notification.

Following describes the steps taken for dynamic notification of application and event tables over a broadband connection.

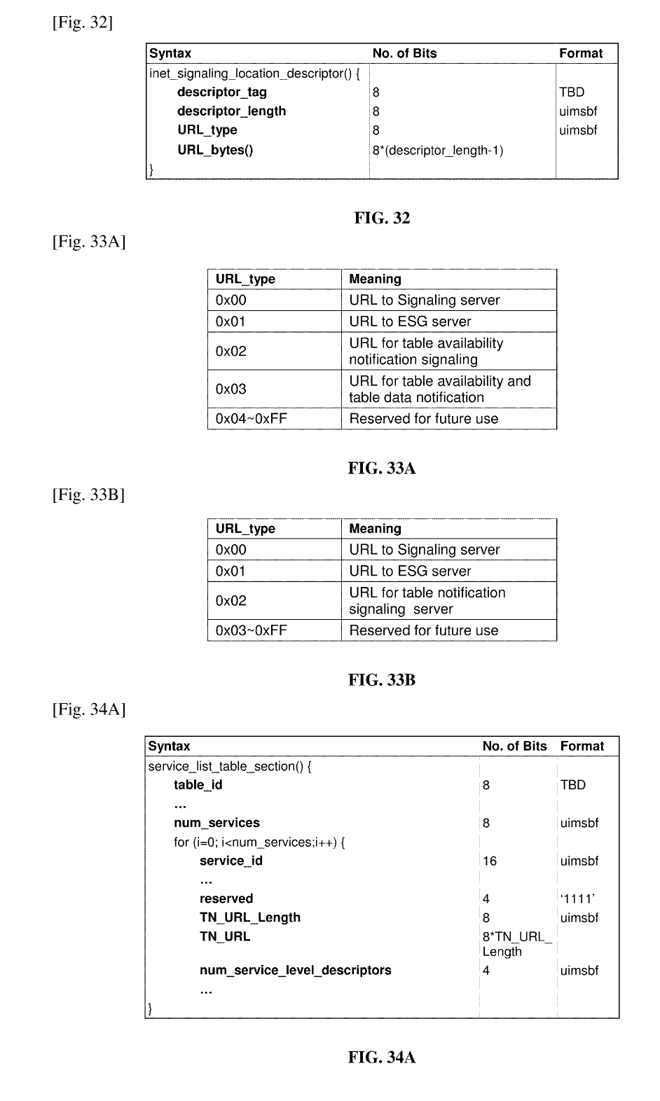

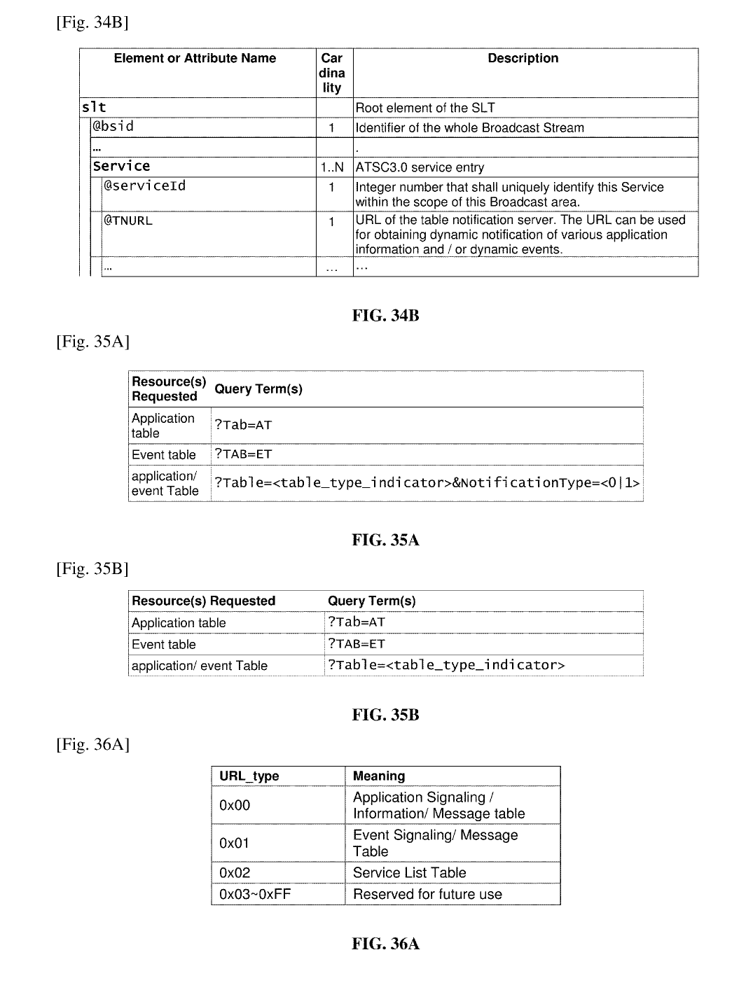

In a first step, broadband server URL for receiving table notifications is signaled in broadcast stream. This could be signaled in service list table (SLT). The signaling may be as per one or more of the embodiments described below.
In one embodiment (Option1) a URL type is included in inet_signaling_location_descripton) as shown in FIG. 32 for indicating table notification URL. With respect to FIG. 32
descriptor_tag—This 8-bit unsigned integer may have the value TBD, identifying this descriptor as being the inet_signaling_location_descriptor( ).
descriptor_length—This 8-bit unsigned integer may specify the length (in bytes) immediately following this field up to the end of this descriptor.
URL_type—This 8-bit unsigned integer field may indicate the type of URL, coded according to FIG. 33A or FIG. 33B
URL_bytes( )—Uniform Resource Location (URL), each character of which may be encoded per UTF-8. In the case of a URL to a Signaling server and/ or to table notification server, this base URL can be extended by one of the query terms as shown in FIG. 35A or FIG. 35B, in order to indicate the resource(s) desired. In the case of a URL to an ESG server, this URL may be used as specified in the ESG broadband delivery specifications.

In a second embodiment (option 2) signaling the URL for table notification server may be done in service level signaling.

The table notification server URL can be signaled in service list table and/or in service level signaling.

Signaling table notification server URL in service list table could be done as shown in FIG. 34A. Signaling table notification server URL in XML format service list table could be done as shown in FIG. 34B. Similarly the TNURL attribute or TN URL element may be included in some other signaling table, such as service level signaling (SLS) or User service description (USD).

In a third embodiment (option 3), URL query terms are defined as shown in FIG.

35A and FIG. 35B for connecting to notification server to obtain dynamic notification updates for application information/ dynamic events over broadband. The table_type_indicator (part of the query term of URL) for descriptor at service list table level is shown in FIG. 36A. The table_type_indicator (part of the query term of URL) for descriptor at service level is shown in FIG. 36B. With respect to FIG. 35A and 35B:
NotifiicationType=0 indicates that only notification about availability of table (e.g. application table or event table or service list table) is requested without the actual table data.
NotifiicationType=1 indicates that notification about availability of table (e.g. application table or event table or service list table) is requested along with the inclusion of the actual table data in the notification.

In a second step a WebSocket connection is established by the client with the table notification URL server as per IETF RFC 6455 for receiving table availability notification (and optionally table data notification) messages.

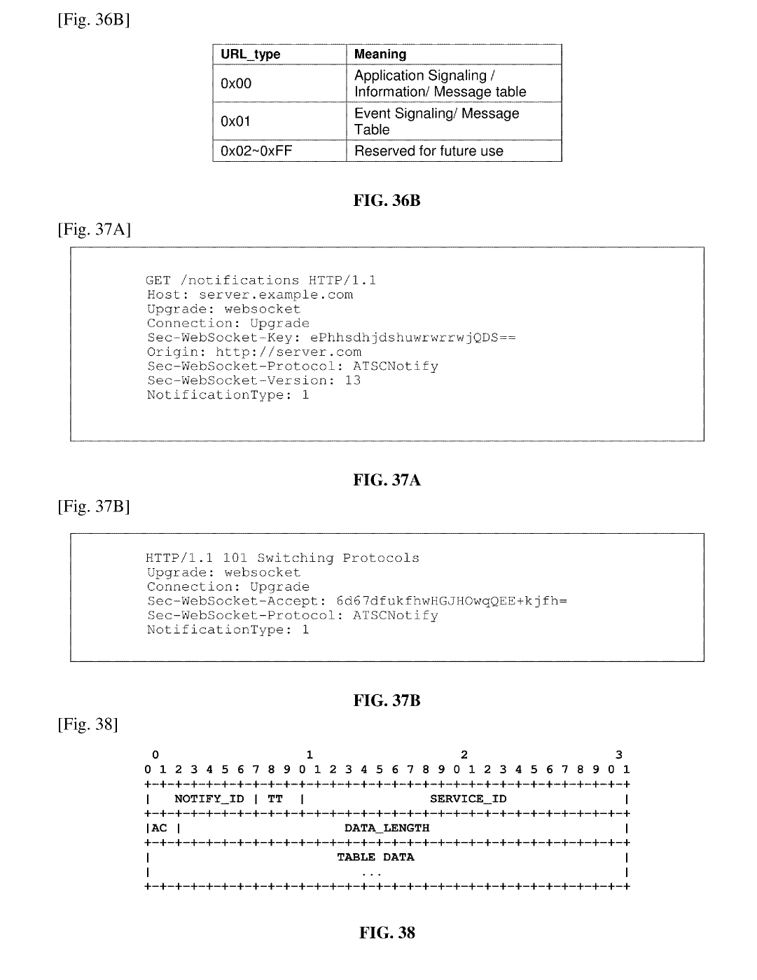

A WebSocket subprotocol ‘ATSCNotify’ as defined below may be used for this.
The opening handshake for this between client and the server is as shown in FIG. 37A and 37B. The HTTP upgrade request from client to server is as shown in FIG. 37A.
The successful response from server to client is as shown in FIG. 37B.

Details about NotificationType header field are described next.

A HTTP header field NotificationType is defined. NotificationType header field can be used in request header and response header. When used in request header NotificationType header field indicates if only table availability notification is requested (value of 0 for NotificationType header) or table availability notification along with table data is requested (value of 0 for NotificationType header). When used in response header NotificationType header field indicates if only table availability notification is sent in the notification response (value of 0 for NotificationType header) or table availability notification along with table data is sent in the notification response (value of 0 for NotificationType header).

If the server supports sending table availability notification along with table data in the notification message and if the request from the client includes NotificationType: 1 header then the server may respond with NotificationType: 1 header in the response and may send notification messages using ATSCNotify subprotocol described below with non-zero TABLE_DATA length.

If the server supports sending table availability notification along with table data in the notification message and if the request from the client includes NotificationType: 0 header then the server may respond with NotificationType: 0 header in the response and may send notification messages using ATSCNotify subprotocol described below with zero TABLE_DATA length and not including table data in the notification message.

If the server does not support sending table data along with the table availability notification in the notification message and if the request from the client includes NotificationType: 1 header then the server may respond with NotificationType: 0 header in the response and may send notification messages using ATSCNotfiy subprotocol described below with zero TABLE_DATA length and not including table data in the notification message.

If the server does not support sending table data along with the table availability notification in the notification message and if the request from the client includes NotificationType: 0 header then the server may respond with NotificationType: 0 header in the response and may send notification messages using ATSCNotify subprotocol described below with zero TABLE_DATA length and not including table data in the notification message.

Details about ATSCNotify subprotocol are defined next.

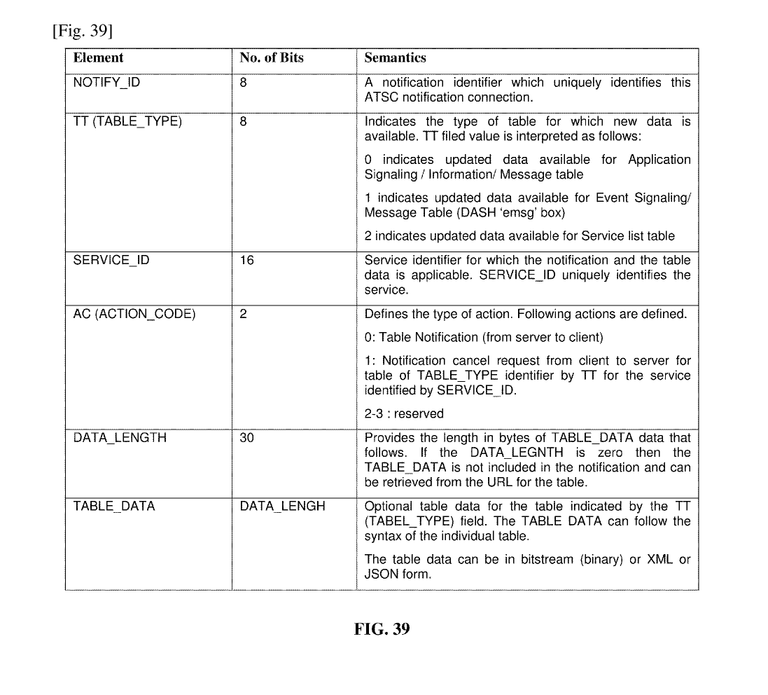

The ATSCNotify subprotocol framing structure is shown in FIG. 38. Also FIG. 39 describes the elements in the ATSC notify framing structure along with their semantics. ATSCNotify subprotocol may use the ‘binary’ format with Opcode %x2 for base framing (or %x0 for continuation frame) for the messages. In another embodiment instead of ‘binary’ format, ‘text’ format with Opcode %x1 for base framing (or %x0 for continuation frame) may be used by ATSCNotify subprotocol for the messages. In this case various fields shown in FIG. 38 will instead be represented by XML or JSON or another text format. In this case an explicit length field (e.g. DATA_LENGTH in FIG. 38) will not be needed as XML/JSON delimiters will implicitly indicate length of a field.

In some embodiment part or all of the ATSCNotify frame can be transmitted inside the WebSocket ‘Extension data’ field.

With respect to FIG. 38 and FIG. 39 an additional field can be included in the ATSCNotify framing structure as follows. In one embodiment this field can be included after or before the AC field and the length of DATA_LENGTH field (or some other field) may be reduced by 8 bits to accommodate this TABLE_ID field.

| Element | No. of Bits | Semantics |
|---|---|---|
| TABLE_ID | 8 | Table Identifier for which the notification is applicable. |
| | | In general this element can map to the table_id field |
| | | in service list table/signaling. |

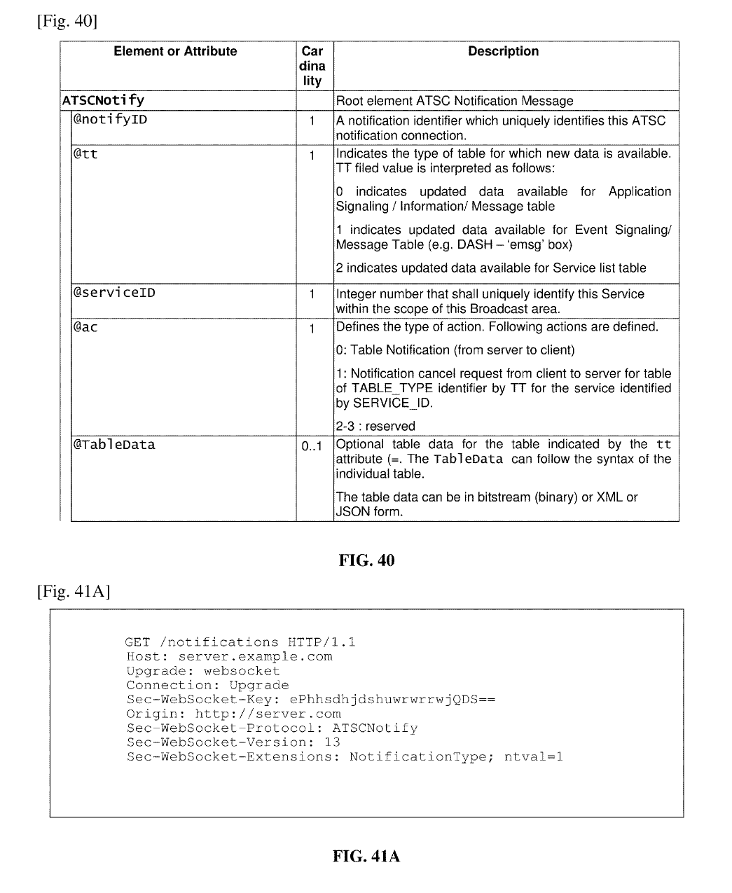

Alternatively XML format may be used to signal ATSCNotify message. Elements and attributes included in ATSCNotify XML message may be as shown in FIG. 40.

When the application information data/ table changes and/ or when a new dynamic event needs to be notified, the server may notify it to the client within xx seconds over the established WebSocket connection using ATSCNotify subprotocol with AC (ACTION_CODE) value of 0.

Canceling receiving ATSC application/event notifications for a service:

The client receiving notifications can cancel receiving notifications for a particular table type identified by TT for particular service identified by SERVICE_ID by sending AC (ACTION_CODE) value of 1 in the ATSCNotify message to the server.

Upon receiving such a message the server will stop sending notifications to the client on the notification stream identified by the NOTIFY_ID field in the client request for the type of tables identified by the TT field in the client request for the service identified by the SERVICE_ID field in the client request.

In another embodiment more actions codes could be defined.

For example AC value of 2 can indicate a request from the client to the server to (temporarily) pause sending notifications.

For example AC value of 3 can indicate a request from the client to the server to resume sending notifications. This should be sent when previously the client had requested pausing sending the notifications by sending AC value of 2.

In another embodiment the AC field of the ATSC notify subprotocol frame may be assigned 3 bits and the DATA_LEGNTH field may be assigned 29 fields.

The WebSocket connection can be closed from either server or client at any time.

Another embodiment is now described for some of the above steps. In particular in this embodiment the first step may be same as the above embodiment. Thus in a first step, broadband server URL for receiving table notifications is signaled in broadcast stream. This could be signaled in service list table (SLT) as describe previously. The signaling may be as per one or more of the embodiments described previously. In this embodiment the steps from step two onwards may be done somewhat differently as defined below.

The differences of this embodiment compared to the previous embodiment include the following additional items and/ or modifications:
(1) Instead of defining a new NotificationType HTTP header, an extension is defined in Sec-WebSocket-Extensions header with an extension-param parameter.
(2) ATSCNotify subprotocol is augmented to support a PAUSE and RESUME actions via action codes. This can help, for example, in the following scenarios:
(a) WebSocket connection can be kept open but notification reception for a table can be paused and subsequently resumed.
(b) If same underlying websocket connection is used for receiving notification for multiple different table types then cancel allows pausing some of them while keeping others.
(3) Ability to request current table information from the client and responding to the request information by the server is added to ATSCNotify subprotocol.
(4) Ability is provided to specify URL for obtaining a table data information to supplement sending it inband in the frame.
(5) Additional fields are defined in the ATSCNotify subprotocol framing structure including Table version and table data format (from list of defined formats).

Various steps from step two onwards for this embodiment are described now.

In a second step a WebSocket connection is established by the client with the table notification URL server as per IETF RFC 6455 for receiving table availability notification (and optionally table data notification) messages.

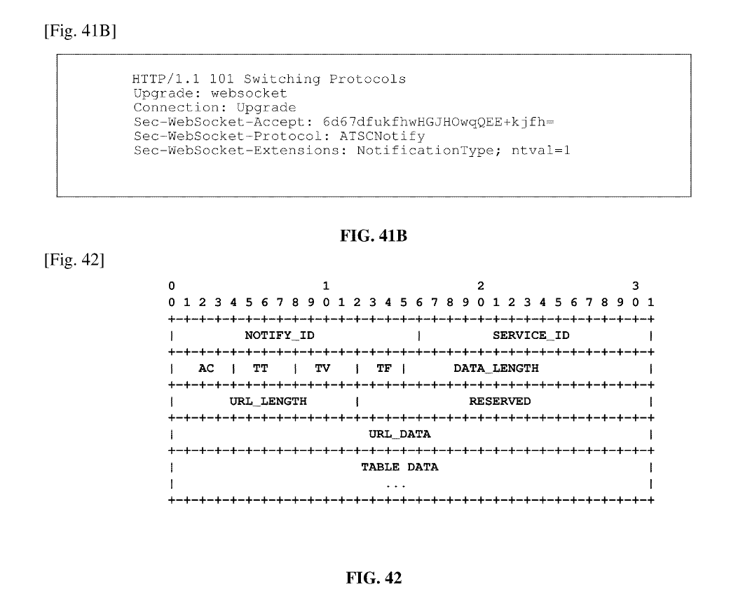

A WebSocket subprotocol ‘ATSCNotify’ as defined below may be used for this.
The opening handshake for this between client and the server is shown in FIGS. 41A and 41B.
The HTTP upgrade request from client to server is shown in FIG. 41A.
The successful response from server to client is shown in FIG. 41B.

Details about NotificationType extension for Sec-WebSocket-Extension header field are described next.

A Sec-WebSocket-Extensions header field extension termed NotificationType is defined. An extension-para is defined for the NotificationType extension with valid values of 0 and 1, i.e. ntval=(0|1). NotificationType extension can be used in Sec-WebSocket-Exentions request header and Sec-WebSocket-Exentions response header. When used in Sec-WebSocket-Exentions request header NotificationType extension indicates if only table availability notification is requested (value of 0 for ntval extension-param) or table availability notification along with table data is requested (value of 1 for ntval extension-param). When used in Sec-WebSocket-Exentions response header NotificationType extension indicates if only table availability notification is sent in the notification response (value of 0 for ntval extension-param) or table availability notification along with table data is sent in the notification response (value of 1 for ntval extension-param).

If the server supports sending table availability notification along with table data in the notification message and if the request from the client includes:
Sec-WebSocket-Extensions: NotificationType; ntval=1
header then the server may respond with:
Sec-WebSocket-Extensions: NotificationType; ntval=1
header in the response and may send notification messages using ATSCNotify subprotocol described below with non-zero TABLE_DATA length.

If the server supports sending table availability notification along with table data in the notification message and if the request from the client includes:
Sec-WebSocket-Extensions: NotificationType; ntval=0
header then the server may respond with:
Sec-WebSocket-Extensions: NotificationType; ntval=0
header in the response and may send notification messages using ATSCNotify subprotocol described below with zero TABLE_DATA length and not including table data in the notification message.

If the server does not support sending table data along with the table availability notification in the notification message and if the request from the client includes:
Sec-WebSocket-Extensions: NotificationType; ntval=1
header then the server may respond with:
Sec-WebSocket-Extensions: NotificationType; ntval=0
header in the response and may send notification messages using ATSCNotfiy subprotocol described below with zero TABLE_DATA length and not including table data in the notification message.

If the server does not support sending table data along with the table availability notification in the notification message and if the request from the client includes:

Sec-WebSocket-Extensions: NotificationType; ntval=0
header then the server may respond with:
Sec-WebSocket-Extensions: NotificationType, ntval=0
header in the response and may send notification messages using ATSCNotify subprotocol described below with zero TABLE_{——}DATA length and not including table data in the notification message.

In yet another embodiment instead of defining an extension NotificationType with parameter ntval with two valid values (i.e. ntval=0 or ntval=1), two separate extensions e.g. NotificationType0 and NotificationType1 could be defined. In this case the server and client behavior defined above when header has value:
Sec-WebSocket-Extensions: NotificationType; ntval=0
will be the same as:
Sec-WebSocket-Extensions: NotificationType0
In this case the server and client behavior defined above when header has value:
Sec-WebSocket-Extensions: NotificationType; ntval=1
will be the same as
Sec-WebSocket-Extensions: NotificationType1.

Details about ATSCNotify subprotocol used in this embodiment are defined next.

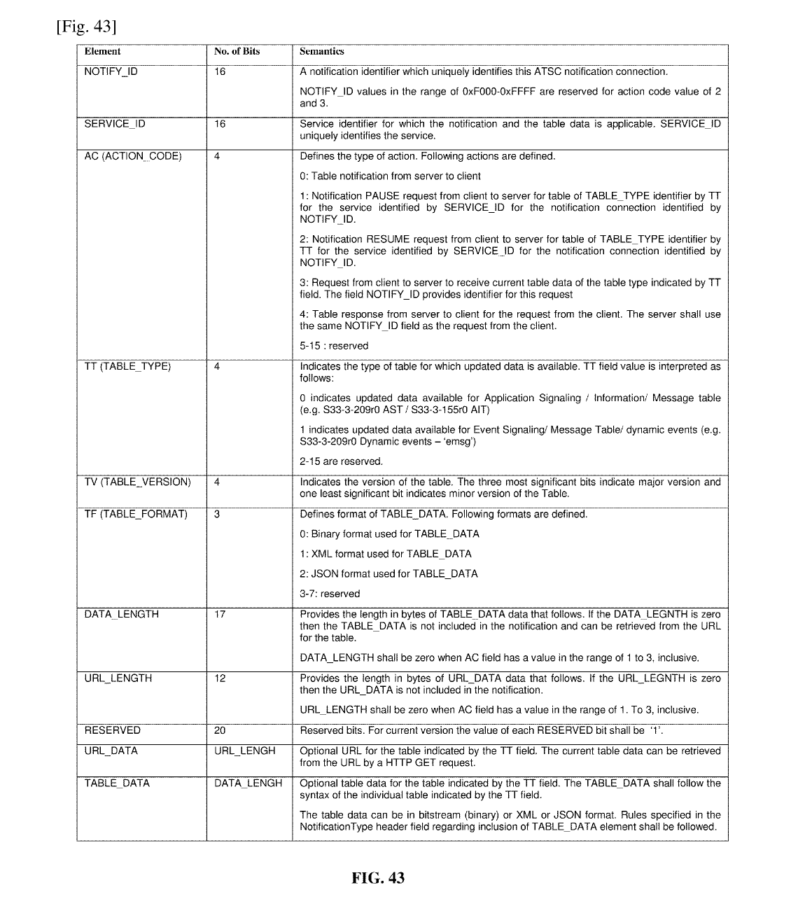

The ATSCNotify subprotocol framing structure is shown in FIG. 42. Also FIG. 43 describes the elements in the ATSC notify framing structure along with their semantics. ATSCNotify protocol may use the ‘binary’ format with Opcode %x2 for base framing (or %x0 for continuation frame) for the messages.

In another embodiment instead of ‘binary’ format, ‘text’ format with Opcode %x 1 for base framing (or %x0 for continuation frame) may be used by ATSCNotify subprotocol for the messages. In this case various fields shown in FIG. 42 will instead be represented by XML or JSON or another text format. In this case an explicit length field (e.g. DATA_LENGTH, URL_LENGTH in FIG. 42) will not be needed as XML/JSON delimiters will implicitly indicate length of a field.

In some embodiment part or all of the ATSCNotify frame can be transmitted inside the WebSocket ‘Extension data’ field.

With respect to FIG. 42 and FIG. 43 an additional field can be included in the ATSCNotify framing structure as follows. In one embodiment this field can be included after or before the AC field and the length of DATA_LENGTH field (or some other field) may be reduced by 8 bits to accommodate this TABLE_ID field.

| Element | No. of Bits | Semantics |
|---|---|---|
| TABLE_ID | 8 | Table Identifier for which the notification is applicable. |
| | | In general this element can map to the table_id field in |
| | | service list table/signaling. |

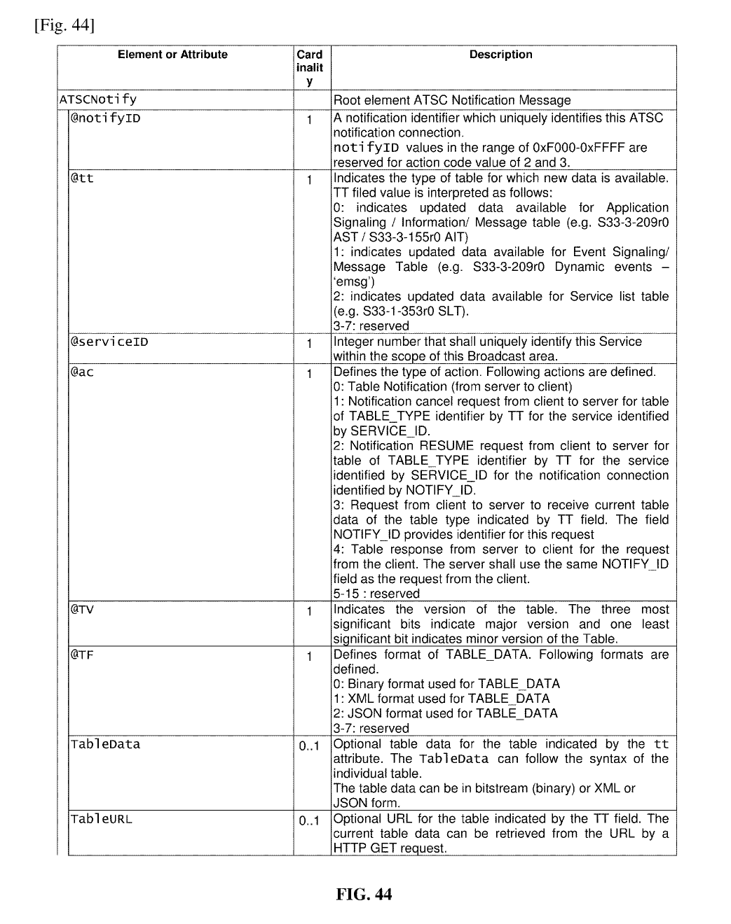

Alternatively XML format may be used to signal ATSCNotify message. Elements and attributes included in ATSCNotify XML message may be as shown in FIG. 44.

With respect to FIG. 44 in some embodiments it is a requirement that either TableData or TableURL or both elements may be present.

When the application information data/ table changes and/or when a new dynamic event needs to be notified, the server may notify it to the client within xx seconds over the established WebSocket connection using ATSCNotify subprotocol with AC (ACTION_CODE) value of 0.

Pausing/resuming receiving ATSC application/ event notifications for a service:

The client receiving notifications can pause receiving notifications for a particular table type identified by TT for particular service identified by SERVICE_ID by sending AC (ACTION_CODE) value of 1 in the ATSCNotify message to the server.

Upon receiving such a PAUSE message the server will pause sending notifications to the client on the notification stream identified by the NOTIFY_ID field in the client request for the type of tables identified by the TT field in the client request for the service identified by the SERVICE_ID field in the client request.

The client previously receiving notifications which it has paused can resume receiving notifications for a particular table type identified by TT for particular service identified by SERVICE_ID by sending AC (ACTION_CODE) value of 2 in the ATSCNotify message to the server.

Upon receiving such a RESUME message the server will resume sending notifications to the client on the notification stream identified by the NOTIFY_ID field in the client request for the type of tables identified by the TT field in the client request for the service identified by the SERVICE_ID field in the client request if those notification were previously paused.

Request/Response support for application/event table retrieval for a service:

The client can send request to receive current table by sending AC (ACTION_CODE) value of 3 for a particular table type identified by TT for particular service identified by SERVICE_ID in the ATSCNotify message to the server. In this case the client will randomly assign a NOTIFY_ID value in the range of 0xF000 to 0xFFFF to identify the request.

Upon receiving such a request message the server will send the current table to the client for the type of tables identified by the TT field in the client request for the service identified by the SERVICE ID field in the client request with NOTIFY_ID field set to the value included in the client request.

A few additional embodiments for ATSCNotify subprotocol, framing, elements, and XML format are described next.

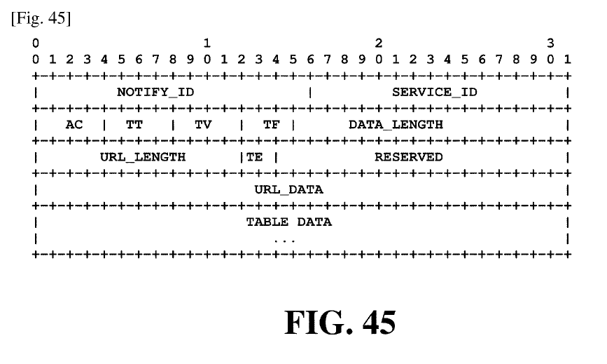

In this embodiment the ATSCNotify subprotocol framing structure is shown in FIG. 45. One difference between FIG. 45 and FIG. 42 is that the encoding used for the TABLE_DATA is indicated by an element TE (TABLE_ENCODING). Typically the TABLE_DATA may be large in size so it is beneficial to compress this data using a compression algorithm before it is included in the message. For example the TABLE_DATA may be in XML or JSON or binary format as indicated by the TF (TABLE_FORMAT) and it may then be compressed by gzip algorithm as per RFC 1952 which is available at https://www.ietf.org/rfc/rfc1952.txt and is incorporated herein by reference. Thus in this example case the TE field will be assigned a value of 1 to indicate gzip encoding as per RFC 1952. In some embodiments the table encoding may instead be called content-encoding or table content encoding. In an alternative embodiment TE (TABLE_ENCODING) value of 2 may be defined to denote DEFLATE algorithm encoding applied to TABLE_DATA. In one embodiment the DEFLATE algorithm may be the “zlib” format defined in RFC 1950 in combination with the “deflate” compression mechanism described in RFC 1951. RFC 1950 is available at https://www.ietf.org/rfc/rfc1950.txt and is incorporated herein by reference. RFC 1951 is available at https://www.ietf.org/rfc/rfc1951.txt and is incorporated herein by reference.

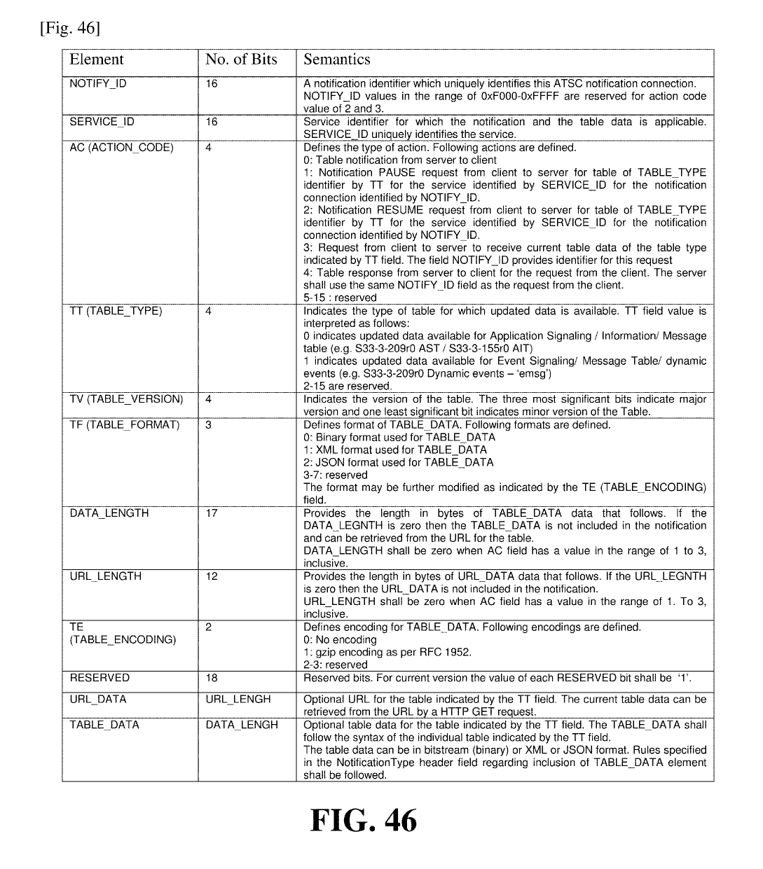

Also FIG. 46 describes the elements in the ATSC notify framing structure along with their semantics. ATSCNotify protocol may use the ‘binary’ format with Opcode %x2 for base framing (or %x0 for continuation frame) for the messages.

In another embodiment instead of ‘binary’ format, ‘text’ format with Opcode %x1 for base framing (or %x0 for continuation frame) may be used by ATSCNotify subprotocol for the messages. In this case various fields shown in FIG. 45 will instead be represented by XML or JSON or another text format. In this case an explicit length field (e.g. DATA_LENGTH, URL_LENGTH in FIG. 45) will not be needed as XML/JSON delimiters will implicitly indicate length of a field.

In some embodiment part or all of the ATSCNotify frame can be transmitted inside the WebSocket ‘Extension data field.

With respect to FIG. 45 and FIG. 46 an additional field can be further included in the ATSCNotify framing structure as follows. In one embodiment this field can be included after or before the AC field and the length of DATA_LENGTH field (or some other field) may be reduced by 8 bits to accommodate this TABLE_ID field.

| Element | No. of Bits | Semantics |
|---|---|---|
| TABLE_ID | 8 | Table Identifier for which the notification is |
| | | applicable. |
| | | In general this element can map to the table_id |
| | | field in service list table/signaling. |

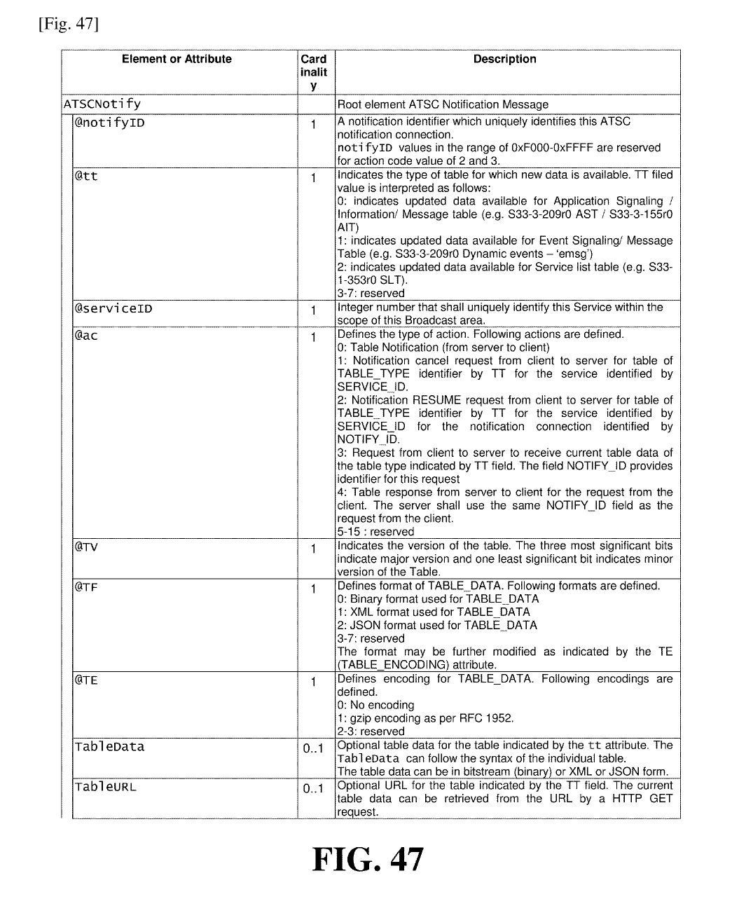

Alternatively XML format may be used to signal ATSCNotify message. Elements and attributes included in ATSCNotify XML message may be as shown in FIG. 47.

With respect to FIG. 47 in some embodiments it is a requirement that either TableData or TableURL or both elements may be present.

Yet another embodiment for ATSCNotify subprotocol, framing, elements, and XML format is described next.

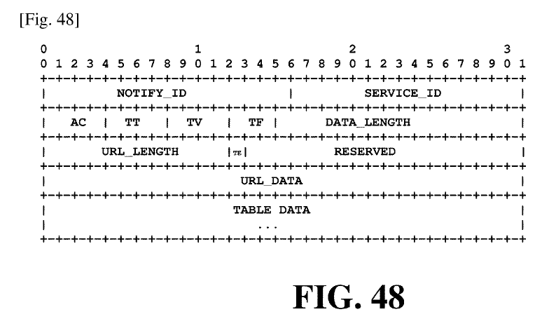

In this embodiment The ATSCNotify subprotocol framing structure is shown in FIG. 48. One difference between FIG. 48 and FIG. 42 is that the encoding used for the TABLE_DATA is indicated by an element TE (TABLE_ENCODING). Typically the TABLE_DATA may be large in size so it is beneficial to compress this data using a compression algorithm before it is included in the message. For example the TABLE_DATA may be in XML or JSON or binary format as indicated by the TF (TABLE_FORMAT) and it may then be compressed by gzip algorithm as per RFC 1952 which is available at https://www.ietf.org/rfc/rfc1952.txt and is incorporated herein by reference. Thus in this example case, the TE field will be assigned a value of 1 to indicate gzip encoding as per RFC 1952. One difference between FIG. 48 and FIG. 45 is that in FIG. 45 the field TE (TABLE_ENCODING) is 2 bit wide where as it is 1 bit wide in FIG. 48. This extra bit can be used to keep an extra RESERVED bit which may be beneficial for signaling other syntax elements in future. In an alternative embodiment TE (TABLE_ENCODING) value of 2 may be defined to denote DEFLATE algorithm encoding applied to TABLE_DATA. In one embodiment the DEFLATE algorithm may be the “zlib” format defined in RFC 1950 in combination with the “deflate” compression mechanism described in RFC 1951. RFC 1950 is available at https://www.ietf.org/rfc/rfc1950.txt and is incorporated herein by reference. RFC 1951 is available at https://www.ietf.org/rfc/rfc1951.txt and is incorporated herein by reference. In some embodiments the table encoding may instead be called content-encoding or table content encoding.

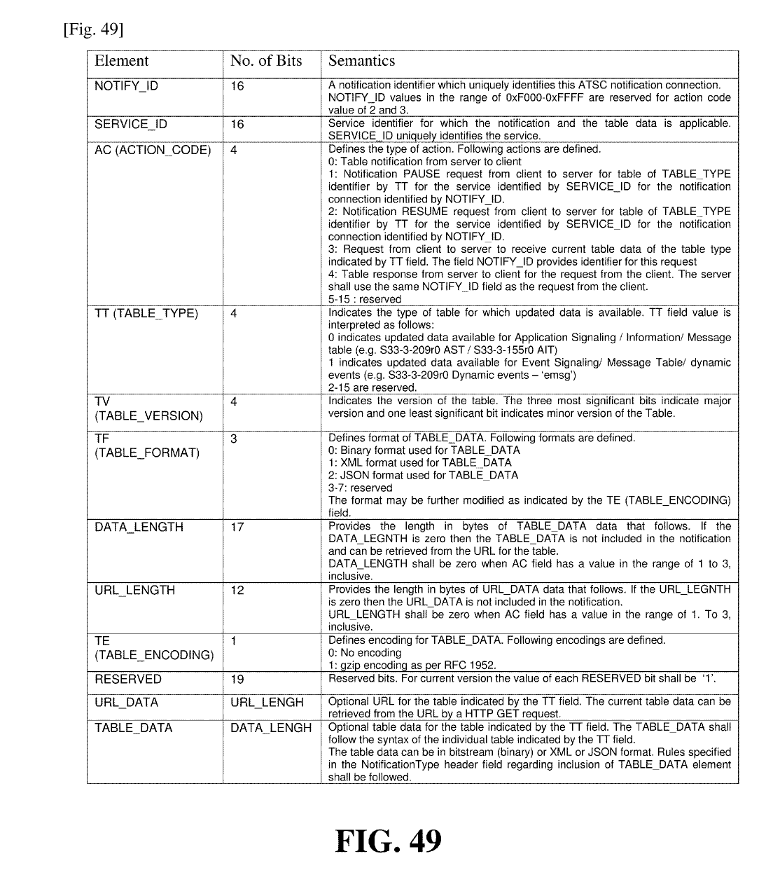

Also FIG. 49 describes the elements in the ATSC notify framing structure along with their semantics. ATSCNotify protocol may use the ‘binary’ format with Opcode %x2 for base framing (or %x0 for continuation frame) for the messages.

In another embodiment instead of ‘binary’ format, ‘text’ format with Opcode %x1 for base framing (or %x0 for continuation frame) may be used by ATSCNotify sub-protocol for the messages. In this case various fields shown in FIG. 48 will instead be represented by XML or JSON or another text format. In this case an explicit length field (e.g. DATA_LENGTH, URL_LENGTH in FIG. 48) will not be needed as XML/JSON delimiters will implicitly indicate length of a field.

In some embodiment part or all of the ATSCNotify frame can be transmitted inside the WebSocket ‘Extension data’ field.

With respect to FIG. 48 and FIG. 49 an additional field can be further included in the ATSCNotify framing structure as follows. In one embodiment this field can be included after or before the AC field and the length of DATA_LENGTH field (or some other field) may be reduced by 8 bits to accommodate this TABLE_ID field.

| Element | No. of Bits | Semantics |
|---|---|---|
| TABLE_ID | 8 | Table Identifier for which the notification is applicable. |
| | | In general this element can map to the table_id field in |
| | | service list table/signaling. |

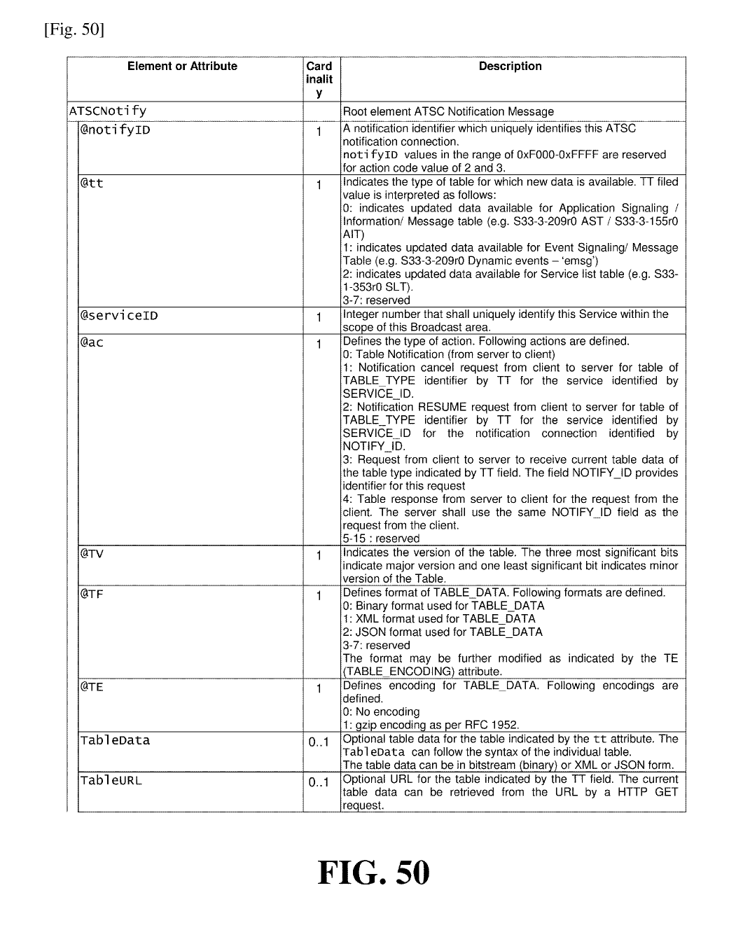

Alternatively XML format may be used to signal ATSCNotify message. Elements and attributes included in ATSCNotify XML message may be as shown in FIG. 50.

With respect to FIG. 50 in some embodiments it is a requirement that either TableData or TableURL or both elements may be present.

In another embodiment various fields (e.g. NOTIFY_ID, SERVICE_ID, AC, TT,

TV, TF, TE, DATA_LENGTH, URL_LENGTH, RESERVED, URL_DATA, TABLE_DATA) fields may have different bi-field width than that shown in FIG. 42/FIG. 43. In some embodiments the RESERVED data field may not be transmitted and thus not included in the frame in FIG. 42.

The WebSocket connection can be closed from either server or client at any time.

In another embodiment the word NOTIFY may be changed to some other word e.g. FRAGMENT or SEGMENT. For example NOTIFY_ID may be instead called FRAGMENT_ID or SEGMENT_ID or MESSAGE_ID or some other suitable name. In this case the semantics of meaning of it may be changed for example as follows:

| Element | No. of Bits | Semantics |
|---|---|---|
| MESSAGE_ID | 16 | A message identifier which uniquely identifies this |
| | | ATSC message. |
| | | MESSAGE_ID values in the range of 0xF000-0xFFFF |
| | | are reserved for action code value of 2 and 3. |

Also in another embodiment the ATSCNotfy subprotocol may instead be called ATSCMsg subprotocol or ATSCTable subprotocol or ATSCSignaling subprotocol or some other name.

Although two different embodiments are described above with various steps in each embodiment, in general any combination of various steps from different embodiments may be done. Also some of the steps may be done out of order. Also some steps may be done in parallel and some steps may be done sequentially. In general all such variations are intended to be covered by this description.

Various events could be delivered by broadband in addition to broadcast. Since new event information may need to be communicated dynamically at any time, use of notification is provided for broadband delivery of dynamic events.

The following types of dynamic notification of events can be provided over broadband.
1. Notification about availability of an event information for a service
2. Notification about availability of an event information for a service along with the inclusion of signaling object data in the notification

Description is provided of a protocol which can provide dynamic event notification.

Following steps may be taken in the protocol for dynamic event notification.

Broadband server URL from where dynamic event notifications can be received is signaled in the broadcast stream in the Service List Table.

A WebSocket connection is established by the client with an event notification URL server as per IETF RFC 6455 for receiving event notification (and optionally signaling object data) messages. Signaling object data may include data such as but not limited to application signaling table, media presentation description, application event information, etc. Signaling object data may instead be called metadata object data and signaling object types may be called metadata object types.

A WebSocket subprotocol EventNotify as defined below may be used for this. The opening handshake for this between the client and the server is as shown below. The HTTP upgrade request from client to server is as follows:
GET /notifications HTTP/1.1
Host: serverexample.com
Upgrade: websocket
Connection: Upgrade
Sec-WebSocket-Key: ePhhsdhjdshuwrwrrwjQDS==
Origin: http://server.com
Sec-WebSocket-Protocol: EventNotify
Sec-WebSocket-Version: 13
NotificationType: 1

The successful response from server to client is as follows:
HTTP/1.1 101 Switching Protocols
Upgrade: websocket
Connection: Upgrade
Sec-WebSocket-Accept: 6d67dfukfhwHGJHOwqQEE+kjfh=
Sec-WebSocket-Protocol: EventNotify
NotificationType: 1

A NotificationType extension for Sec-WebSocket-Extension header field is defined next as follows:

A Sec-WebSocket-Extensions header field extension termed NotificationType is defined. An extension-para is defined for the NotificationType extension with valid values of 0 and 1, i.e. ntval=(0|1). NotificationType extension can be used in Sec-WebSocket-Extension request header and Sec-WebSocket-Extension response header. When used in Sec-WebSocket-Extension request header NotificationType extension indicates if only event information availability notification is requested (value of 0 for ntval extension-param) or event information availability notification along with signaling object data is requested (value of 1 for ntval extension-param). When used in Sec-WebSocket-Extensions response header NotificationType extension indicates if only event information availability notification is sent in the notification response (value of 0 for ntval extension-param) or event information availability notification along with signaling object data is sent in the notification response (value of 1 for ntval extension-param).

If the server supports sending event information availability notification along with signaling object data in the notification message and if the request from the client includes a Sec-WebSocket-Extensions: NotificationType; ntval=1 header then the server may respond with a Sec-WebSocket-Extensions: NotificationType; ntval=1 header in the response and may send event notification messages using the EventNotify subprotocol described below with non-zero OBJECT_DATA length.

If the server supports sending event information availability notification along with signaling object data in the notification message and if the request from the client includes Sec-WebSocket-Extensions: NotificationType; ntval=0 header then the server may respond with Sec-WebSocket-Extensions: NotificationType; ntval=0 header in the response and may send event notification messages using EventNotify subprotocol described below with zero OBJECT_DATA length and not including signaling object data in the notification message.

If the server does not support sending signaling object data along with the event information availability notification in the event notification message and if the request from the client includes Sec-WebSocket-Extensions: NotificationType; ntval=1 header then the server may respond with Sec-WebSocket-Extensions: NotificationType; ntval=0 header in the response and may send event notification messages using EventNotify subprotocol described below with zero OBJECT_DATA length and not including signaling object data in the notification message.

If the server does not support sending signaling object data along with the event information availability notification in the notification message and if the request from the client includes Sec-WebSocket-Extensions: NotificationType; ntval=0 header then the server may respond with Sec-WebSocket-Extensions: NotificationType; ntval=0 header in the response and may send event notification messages using EventNotify subprotocol described below with zero OBJECT_DATA length and not including signaling object data in the notification message.

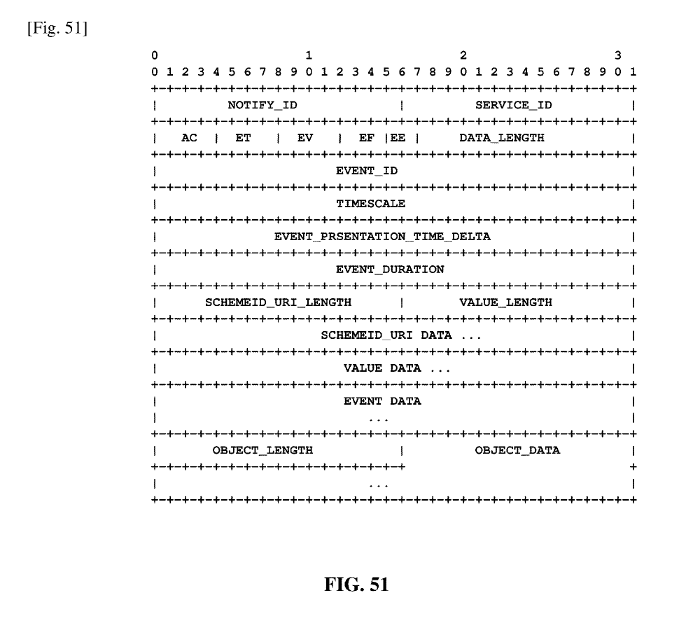

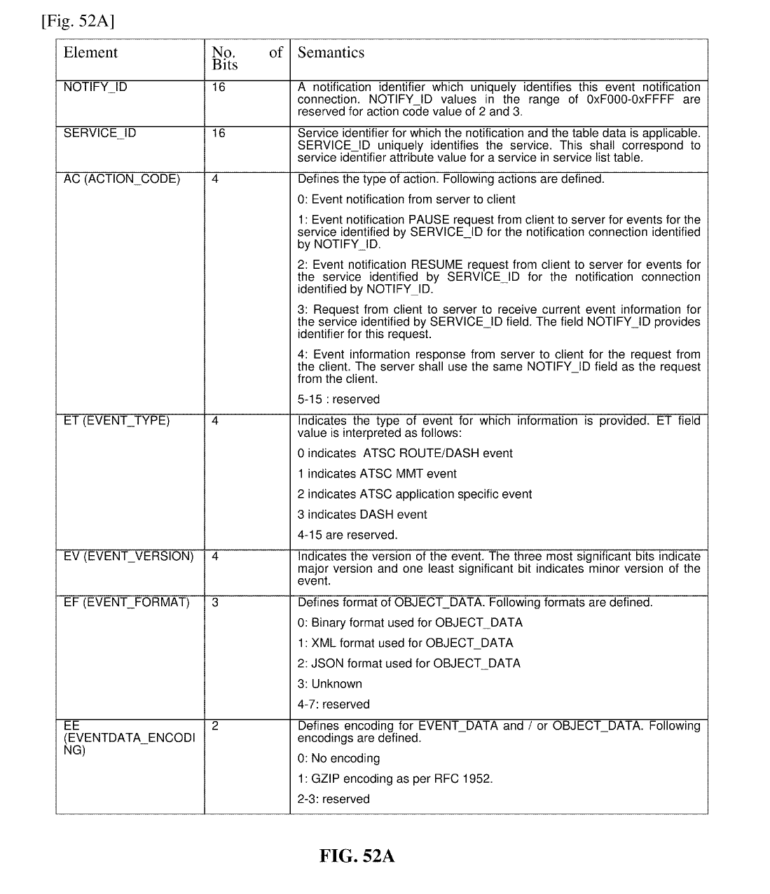

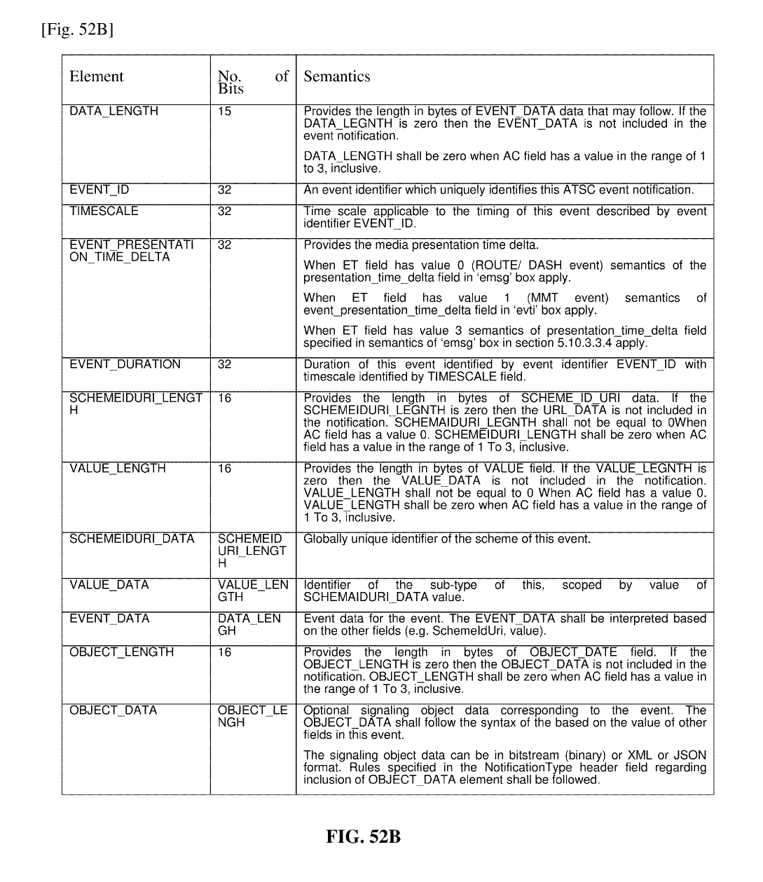

The EventNotify subprotocol framing structure is shown in FIG. 51. FIG. 52A and FIG. 52B describes the elements in the EventNotify framing structure along with their semantics. EventNotify protocol may use the WebSocket ‘binary’ format with Opcode %x2 for base framing (or %x0 for continuation frame) for the messages.

With respect to FIG. 51 , FIG. 52 A and FIG. 52B.

When a new dynamic event needs to be notified, the server may notify it to the client within 10 seconds over the established WebSocket connection using EventNotify sub-protocol with AC (ACTION_CODE) value of 0. The value of 10 seconds is illustrative and some other value could instead be used.

Pausing/resuming receiving ATSC event notifications for a service:

The client receiving notifications can pause receiving notifications for particular service identified by SERVICE_ID by sending AC (ACTION_CODE) value of 1 in the EventNotify message to the server.

Upon receiving such a PAUSE message the server will pause sending events to the client on the notification stream identified by the NOTIFY_ID field in the client request for the event type identified by the ET field in the client request for the service identified by the SERVICE_ID field in the client request.

The client previously receiving events can resume receiving notifications for a particular event type identified by ET for particular service identified by SERVICE_ID by sending AC (ACTION_CODE) value of 2 in the EventNotify message to the server.

Upon receiving such a RESUME message the server will resume sending events to the client on the notification stream identified by the NOTIFY_ID field in the client request for the type of events identified by the ET field in the client request for the service identified by the SERVICE_ID field in the client request if the events were previously paused.

Request/Response support for event retrieval for a service:

The client can send request to receive current event by sending AC (ACTION_CODE) value of 3 for a particular event type identified by ET for particular service identified by SERVICE_ID in the EventNotify message to the server. In this case the client will randomly assign a NOTIFY_ID value in the range of 0xF000 to 0xFFFF to identify the request.

Upon receiving such a request message the server will send the current event to the client for the type of event identified by the ET field in the client request for the service identified by the SERVICE_ID field in the client request with NOTIFY_ID field set to the value included in the client request.

The WebSocket connection can be closed from either server or client at any time.

In a variant example instead of binary framing text framing may be used for EventNotify sub-protocol.

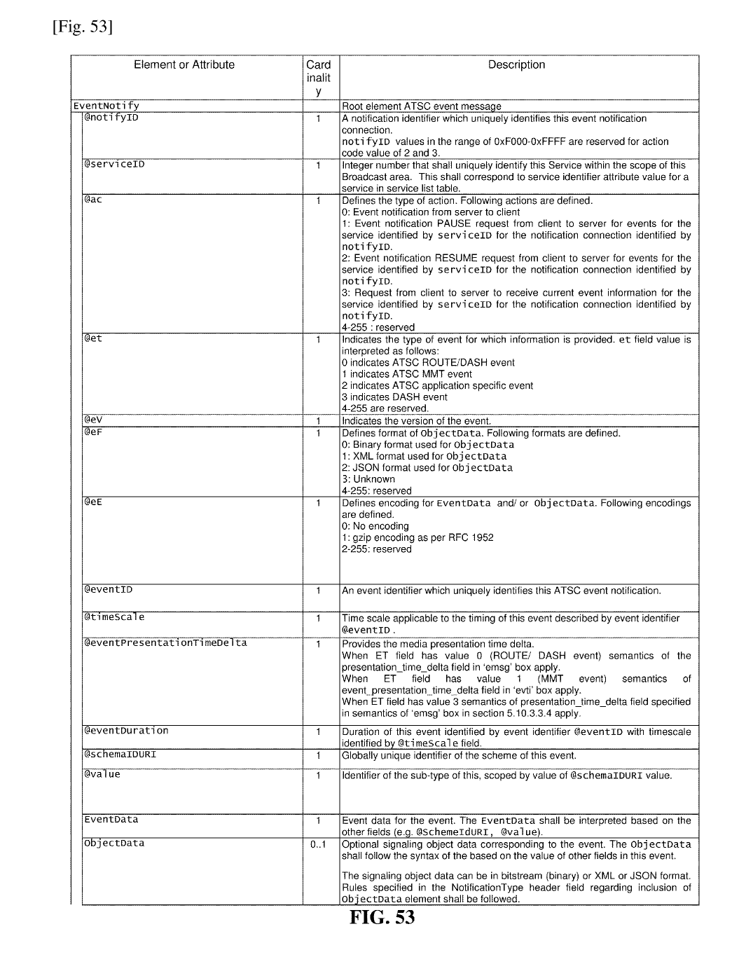

The EventNotify subprotocol elements shown in FIG. 53 may be used in this case. FIG. 53 describes the elements in the EventNotify sub-protocol message along with their semantics. EventNotify protocol may use the WebSocket ‘text’ format with Opcode %x 1 for base framing (or %x0 for continuation frame) for the messages. The frame content must be UTF-8 encoded as specified by the WebSocket Protocol IETF RFC 6455.

The XML format of data fields included in EventNotify message for the variant X may be as shown in FIG. 53.

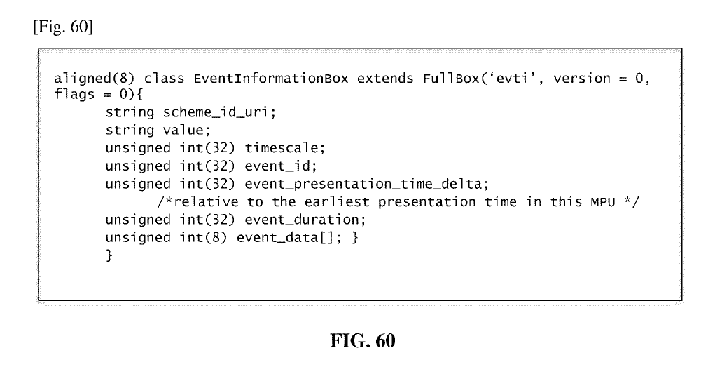

In yet another variant example an element EventInformation may instead be included in the EventNotify structure (e.g. FIG. 53) as follows:

| Element or Attribute | Cardinality | Description |
|---|---|---|
| EventInformation | 0..1 | Event information for the event. |
| | | When @et is 0 or 2 or 3 the EventInformation |
| | | content will be same as content of |
| | | ‘EventStream’ element box as specified in ISO/ |
| | | IEC 23009-1. |
| | | When @et is 1 the EventInformation content will |
| | | be same as content of ‘evti’ box. More details |
| | | about ‘evti’ box are shown in FIG. 60 and are |
| | | described below. |

MPEG Media Transport Protocol (MMTP) is described in ISO/IEC: ISO/IEC 23008-1, “Information technology-High efficiency coding and media delivery in heterogeneous environments-Part 1: MPEG media transport (MMT),” which is incorporated by reference herein in its entirety. MMTP defines a Media Processing Unit (MPU) as “a media data item that may be processed by an MMT entity and consumed by the presentation engine independently from other MPUs.” A logical grouping of MPUs may form an MMT asset, where MMTP defines an asset as “any multimedia data to be used for building a multimedia presentation. An asset is a logical grouping of MPUs that share the same asset identifier for carrying encoded media data.” One or more assets may form a MMT package, where a MMT package is a logical collection of multimedia content.

Events in an MMT based service may be carried in evti boxes in MPUs. FIG. 60 indicates an exemplary structure of an evti box. Thus an MMT event information may map to an evti box. Such an evti box may appear at the beginning of an ISO-BMFF file, after the ftyp box, but before the moov box, or it may appear immediately before any moof box. The MMT event descriptor may be signaled at the asset level. The MMT event descriptor may be signaled in the MMT Package table (MPT). MPT is defined in ISO/IEC 23008-1.

With respect to FIG. 53.

When a new dynamic event needs to be notified, the server may notify it to the client within 10 seconds over the established WebSocket connection using EventNotify sub-protocol with @ac value of 0. The value of 10 seconds is illustrative and some other value could instead be used.

Pausing/resuming receiving ATSC event notifications for a service:

The client receiving notifications can pause receiving notifications for particular service identified by @ serviceID by sending @ac value of 1 in the EventNotify message to the server.

Upon receiving such a PAUSE message the server will pause sending events to the client on the notification stream identified by the @notifyID field in the client request for the event type identified by the ET field in the client request for the service identified by the @serviceID field in the client request.

The client previously receiving events can resume receiving notifications for a particular event type identified by ET for particular service identified by @serviceID by sending @ac value of 2 in the EventNotify message to the server.

Upon receiving such a RESUME message the server will resume sending events to the client on the notification stream identified by the @notifyID field in the client request for the type of events identified by the ET field in the client request for the service identified by the @serviceID field in the client request if the events were previously paused.

Request/Response support for event retrieval for a service:

The client can send request to receive current event by sending @ac value of 3 for a particular event type identified by ET for particular service identified by @serviceID in the EventNotify message to the server. In this case the client will randomly assign a @notifyID value in the range of 0xF000 to 0xFFFF to identify the request.

Upon receiving such a request message the server will send the current event to the client for the type of event identified by the ET field in the client request for the service identified by the @serviceID field in the client request with @notifyID field set to the value included in the client request.

The WebSocket connection can be closed from either server or client at any time.

In a variant example some of the fields are omitted from the EventNotify sub-protocol.

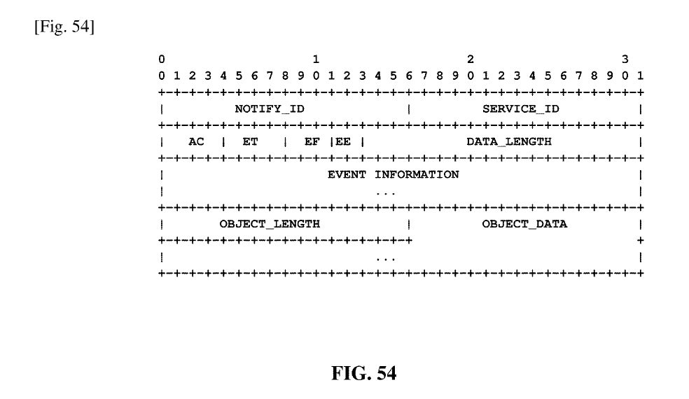

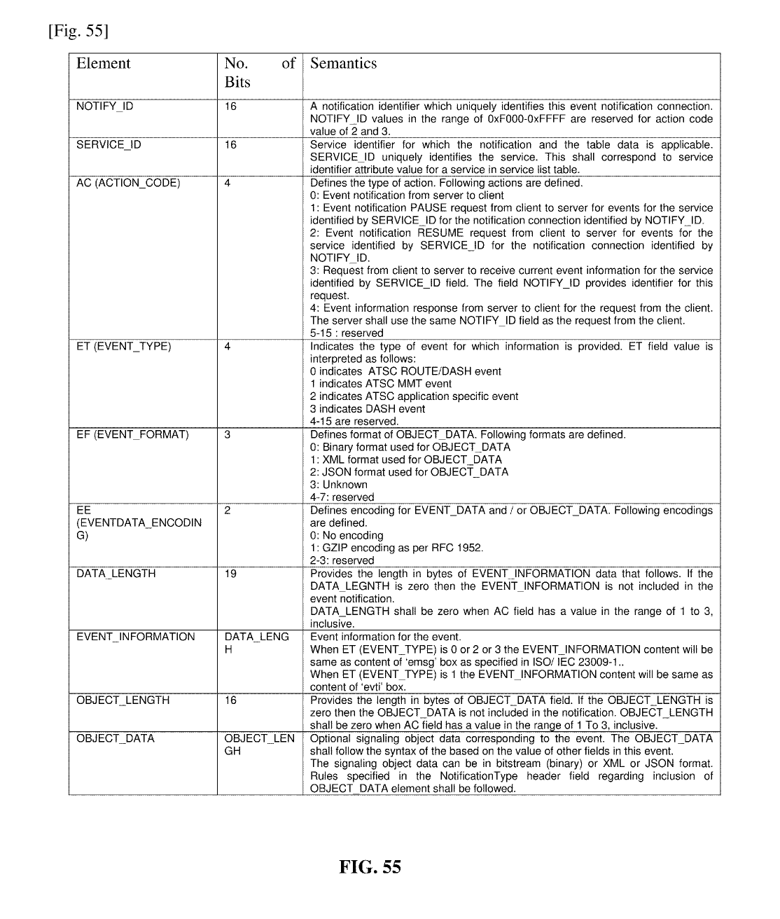

The EventNotify subprotocol framing structure for the variant A is shown in FIG. 54. FIG. 55 describes the elements in the EventNotify framing structure in this case along with their semantics. EventNotify protocol may use the WebSocket ‘binary’ format with Opcode %x2 for base framing (or %x0 for continuation frame) for the messages.

With respect to FIG. 54 and FIG. 55:

When a new dynamic event needs to be notified, the server may notify it to the client within 10 seconds over the established WebSocket connection using EventNotify sub-protocol with AC (ACTION_CODE) value of 0. The value of 10 seconds is illustrative and some other value could instead be used.

Pausing/resuming receiving ATSC event notifications for a service:

The client receiving notifications can pause receiving notifications for particular service identified by SERVICE_ID by sending AC (ACTION_CODE) value of 1 in the EventNotify message to the server.

Upon receiving such a PAUSE message the server will pause sending events to the client on the notification stream identified by the NOTIFY_ID field in the client request for the event type identified by the ET field in the client request for the service identified by the SERVICE_ID field in the client request.

The client previously receiving events can resume receiving notifications for a particular event type identified by ET for particular service identified by SERVICE_ID by sending AC (ACTION_CODE) value of 2 in the EventNotify message to the server.

Upon receiving such a RESUME message the server will resume sending events to the client on the notification stream identified by the NOTIFY_ID field in the client request for the type of events identified by the ET field in the client request for the service identified by the SERVICE_ID field in the client request if the events were previously paused.

Request/Response support for event retrieval for a service:

The client can send request to receive current event by sending AC (ACTION_CODE) value of 3 for a particular event type identified by ET for particular service identified by SERVICE_ID in the EventNotify message to the server. In this case the client will randomly assign a NOTIFY_ID value in the range of 0xF000 to 0xFFFF to identify the request.

Upon receiving such a request message the server will send the current event to the client for the type of event identified by the ET field in the client request for the service identified by the SERVICE ID field in the client request with NOTIFY ID field set to the value included in the client request.

The WebSocket connection can be closed from either server or client at any time.

In a variant example instead of binary framing text framing may be used for EventNotify sub-protocol.

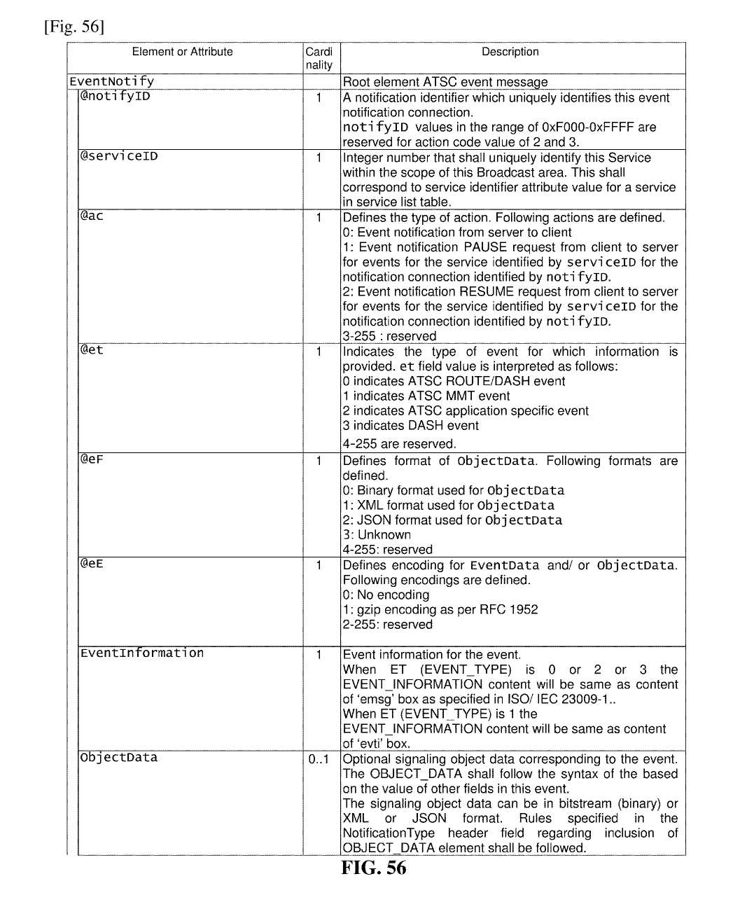

The EventNotify subprotocol elements shown in FIG. 56 may be used in this case.

FIG. 56 describes the elements in the EventNotify sub-protocol message along with their semantics. EventNotify protocol may use the WebSocket ‘text’ format with Opcode %x 1 for base framing (or %x0 for continuation frame) for the messages. The frame content must be UTF-8 encoded as specified by the WebSocket Protocol IETF RFC 6455.

The XML format of data fields included in EventNotify message for the variant X may be as shown in FIG. 56.

With respect to FIG. 56:

When a new dynamic event needs to be notified, the server may notify it to the client within 10 seconds over the established WebSocket connection using EventNotify sub-protocol with @ac value of 0. The value of 10 seconds is illustrative and some other value could instead be used.

Pausing/resuming receiving ATSC event notifications for a service:

The client receiving notifications can pause receiving notifications for particular service identified by @serviceID by sending @ac value of 1 in the EventNotify message to the server.

Upon receiving such a PAUSE message the server will pause sending events to the client on the notification stream identified by the @notifyID field in the client request for the event type identified by the ET field in the client request for the service identified by the @serviceID field in the client request.

The client previously receiving events can resume receiving notifications for a particular event type identified by ET for particular service identified by @serviceID by sending @ac value of 2 in the EventNotify message to the server.

Upon receiving such a RESUME message the server will resume sending events to the client on the notification stream identified by the @notifyID field in the client request for the type of events identified by the ET field in the client request for the service identified by the @serviceID field in the client request if the events were previously paused.

Request/Response support for event retrieval for a service:

The client can send request to receive current event by sending @ac value of 3 for a particular event type identified by ET for particular service identified by @serviceID in the EventNotify message to the server. In this case the client will randomly assign a @notifyID value in the range of 0xF000 to 0xFFFF to identify the request.

Upon receiving such a request message the server will send the current event to the client for the type of event identified by the ET field in the client request for the service identified by the @service ID field in the client request with @notifyID field set to the value included in the client request.

The WebSocket connection can be closed from either server or client at any time.

In a further variant example some more of the fields are omitted from the EventNotify sub-protocol. A WebSocket connection can be used to identify a service with the events being signalled for that service. Thus the notify ID (e.g. NOTIFY_ID or @notifyId) and service ID (SERVICE_ID or @serviceID) fields could be omitted from the EventNotify sub-protocol.

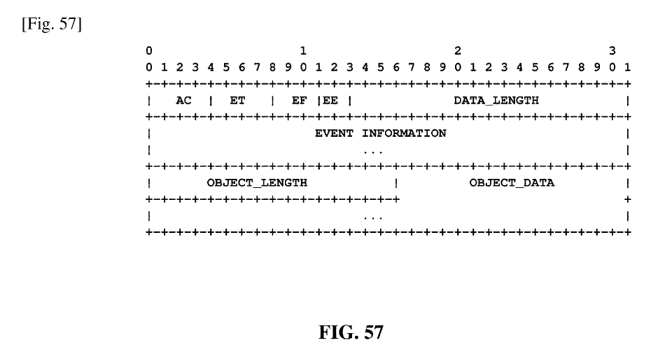

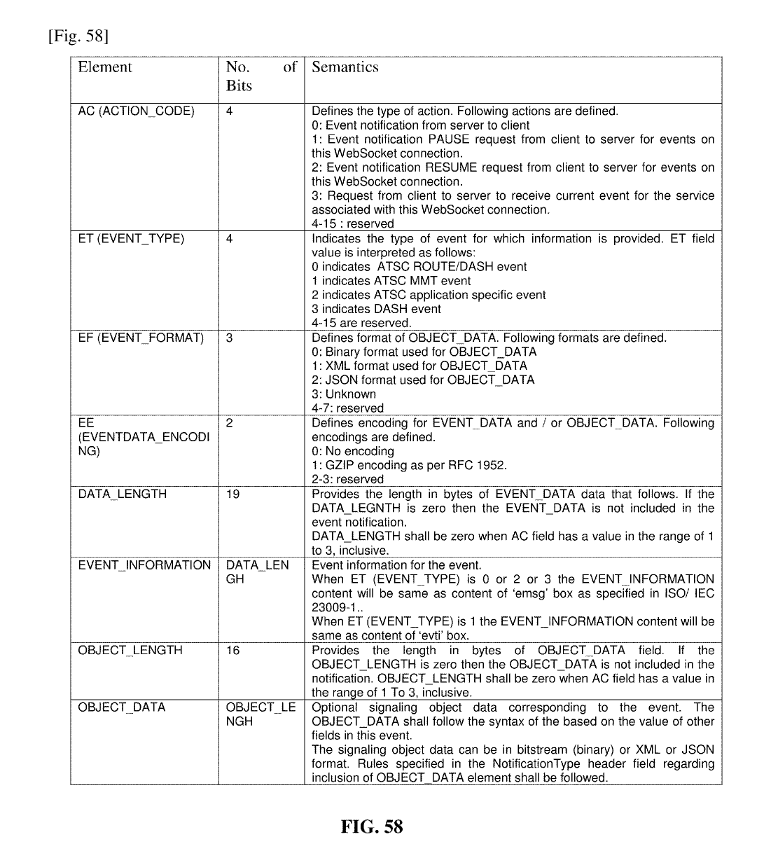

The EventNotify subprotocol framing structure the variant is shown in FIG. 57. FIG. 58 describes for this variant the elements in the EventNotify framing structure along with their semantics. EventNotify protocol may use the WebSocket ‘binary’ format with Opcode %x2 for base framing (or %x0 for continuation frame) for the messages.

With respect to FIG. 57, and FIG. 58:

When a new dynamic event needs to be notified, the server may notify it to the client within 10 seconds over the established WebSocket connection using EventNotify sub-protocol with AC (ACTION_CODE) value of 0. The value of 10 seconds is illustrative and some other value could instead be used.

Pausing/resuming receiving ATSC event notifications for a service:

The client receiving notifications can pause receiving notifications for events sent on this WebSocket connection by sending AC (ACTION_CODE) value of 1 in the EventNotify message to the server.

Upon receiving such a PAUSE message the server will pause sending events to the client on this WebSocket connection.

The client previously receiving events can resume receiving notifications on this WebSocket connection by sending AC (ACTION_CODE) value of 2 in the EventNotify message to the server.

Upon receiving such a RESUME message the server will resume sending events to the client on this WebSocket connection for the service corresponding to this connection if the events were previously paused.

Request/Response support for event retrieval for a service:

The client can send request to receive current event for the service associated with this WebSocket connection by sending AC (ACTION_CODE) value of 3 in the EventNotify message to the server.

Upon receiving such a request message the server will send the current event for the service associated with this WebSocket connection to the client with AC (ACTION_CODE) value of 0 in the EventNotify message to the server.

The WebSocket connection can be closed from either server or client at any time.

In a variant example instead of binary framing text framing may be used for EventNotify sub-protocol.

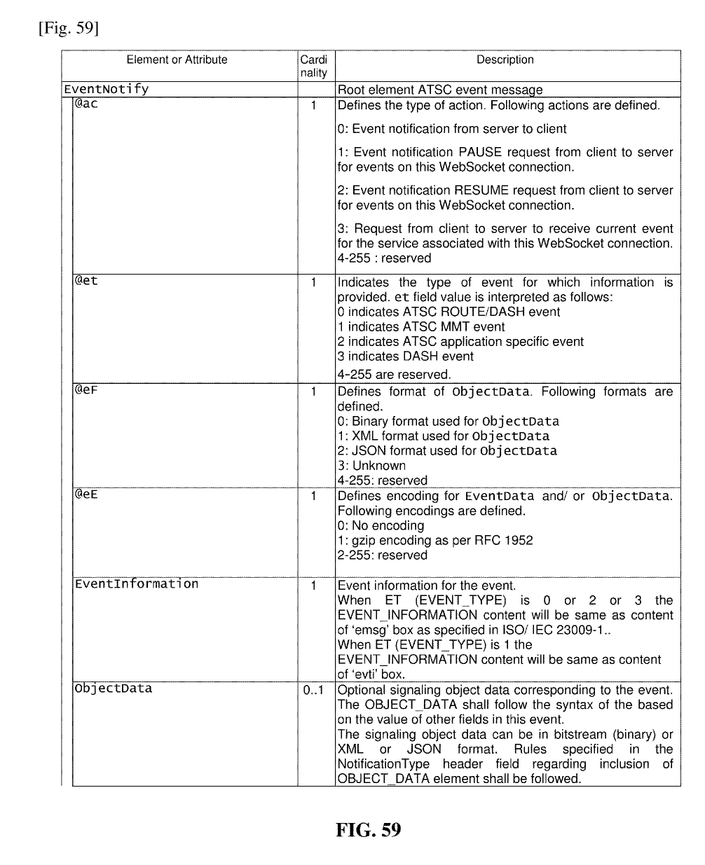

The EventNotify subprotocol elements shown in FIG. 59 may be used in this case. FIG. 59 describes the elements in the EventNotify sub-protocol message along with their semantics. EventNotify protocol may use the WebSocket ‘text’ format with Opcode %x 1 for base framing (or %x0 for continuation frame) for the messages. The frame content must be UTF-8 encoded as specified by the WebSocket Protocol IETF RFC 6455.

The XML format of data fields included in EventNotify message for the variant X may be as shown in FIG. 59.

When a new dynamic event needs to be notified, the server may notify it to the client within 10 seconds over the established WebSocket connection using EventNotify sub-protocol with @ac value of 0. The value of 10 seconds is illustrative and some other value could instead be used.

Pausing/resuming receiving ATSC event notifications for a service:

The client receiving notifications can pause receiving notifications for events sent on this WebSocket connection by sending @ac value of 1 in the EventNotify message to the server. A WebSocket connection may correspond to events for a particular service.

Upon receiving such a PAUSE message the server will pause sending events to the client on this WebSocket connection.

The client previously receiving events can resume receiving notifications on this

WebSocket connection by sending @ac value of 2 in the EventNotify message to the server.

Upon receiving such a RESUME message the server will resume sending events to the client on this WebSocket connection for the service corresponding to this connection if the events were previously paused.

Request/Response support for event retrieval for a service:

The client can send request to receive current event for the service associated with this WebSocket connection by sending @ac value of 3 in the EventNotify message to the server.

Upon receiving such a request message the server will send the current event for the service associated with this WebSocket connection to the client with @ac value of 0 in the EventNotify message to the server.

The WebSocket connection can be closed from either server or client at any time.

With respect to FIG. 51-59, in other example variant some of the fields may be omitted. Also some of the fields may be sent at a different location compared to those shown in these figures.

Although FIG. 13 through FIG. 59 show particular embodiments of syntax, semantics and schema, additional variants are possible. These include the following variations:

Different data types may be used for an element compared to those shown above. For example instead of unsignedByte data type unsignedShort data type may be used. In another example instead of unsigned Byte data type a String data type may be used.

Instead of signaling a syntax as an attribute it may be signaled as an element. Instead of signaling a syntax as an element it may be signaled as an attribute.

The bit width of various fields may be changed for example instead of 4 bits for an element or a field in the bitstream syntax 5 bits or 8 bits or 2 bits or 38 bits may be used. The actual values listed here are just examples.

In some embodiments instead of a range of code values from x to y, a range of code values from x+p or x-p to y+d or y-d may be kept reserved. For example instead of range of code values from 2-255 being kept reserved, the range of code values from 3-255 may be kept reserved.

Instead of XML format and XML schema JavaScript Object Notation (JSON) format and JSON schema may be used. Alternatively the proposed syntax elements may be signaled using a Comma Separated Values (CSV), Backus-Naur Form (BNF), Augmented Backus-Naur Form (ABNF), or Extended Backus-Naur Form (EBNF).

Cardinality of an element and/or attribute may be changed. For example For example cardinality may be changed from “1” to “1 . . . N” or cardinality may be changed from “1” to “0 . . . N” or cardinality may be changed from “1” to “0 . . . 1” or cardinality may be changed from “0 . . . 1” to “0 . . . N” or cardinality may be changed from “0 . . . N” to “0 . . . 1”.

An element and/or attribute may be made required when it is shown above as optional. An element and/or attribute may be made optional when it is shown above as required.

Some child elements may instead be signaled as parent elements or they may be signaled as child elements of another child elements.

All the above variants are intended to be within the scope of the present invention.

Moreover, each functional block or various features of the base station device and the terminal device (the video decoder and the video encoder) used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semi-conductor technology, the integrated circuit by this technology is also able to be used.

It is to be understood that the claims are not limited to the precise configuration and components illustrated above. Various modifications, changes and variations may be made in the arrangement, operation and details of the systems, methods, and apparatus described herein without departing from the scope of the claims.

1. A terminal device, the device comprising:
a receiver configured to receive content service guide and by channels and/or an interactive channel, wherein
the channels include at least one of a Multimedia Broadcast Multicast Service (MBMS) by 3rd Generation Project Partnership (3GPP), a Broadcast Multicast Service (BCMCS) by 3rd Generation Project Partnership 2 (3GPP2), a DVB-Handheld (DVB-H) by Digital Video Broadcasting (DVB) and an Internet Protocol (IP) based broadcasting communication network, and
the service guide includes notification about availability of at least one of application table, event table and service list table.
